(19) United States
(12) Patent Application Publication
(10) Pub. No.: US 2007/0273815 A1
(43) Pub. Date: Nov. 29, 2007

(54) Cellulose acylate film, production method of cellulose acylate film, optically-compensatory film, polarizing plate and liquid crystal display device

(75) Inventor: Takahiro Moto, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/802,722

(22) Filed: May 24, 2007

(30) Foreign Application Priority Data
May 24, 2006 (JP) 2006-144547

(51) Int. Cl. C09K 19/00; G02F 1/1335

(52) U.S. Cl. 349/117; 428/1.31

(57) ABSTRACT

A cellulose acylate film has Re₍₅₉₀₎ and Rth₍₅₉₀₎ satisfying formulae (I) and (II); and a beam transmittance of 88% or more at a wavelength of 590 nm, wherein the number of foreign matters that have a long axis of 50 to 200 μm is 20 pieces/m² or less:

0≦Re₍₅₉₀₎≦10: Formula (I)

−25≦Rth₍₅₉₀₎≦25: Formula (II)

wherein Re₍₅₉₀₎ represents an in-plane retardation value (unit: nm) at a wavelength of 590 nm at 25° C. under 60% RH and Rth₍₅₉₀₎ represents a retardation value (unit: nm) in a thickness direction at a wavelength of 590 nm at 25° C. under 60% RH.

### BACKGROUND OF THE INVENTION

1. Field of the Invention

The present invention relates to a cellulose acylate film useful for liquid crystal display devices and the like and a production method thereof. The present invention also relates to an optically-compensatory film, a polarizing plate and a liquid crystal display, each using the cellulose acylate film.

2. Description of the Related Art

A liquid crystal display device is being widely used as a monitor of personal computers or potable appliances or a television because of its various advantages such as low voltage/low power consumption and capability of downsizing and thinning. Various modes according to the aligned state of liquid crystals in the liquid crystal cell have been proposed for the liquid crystal display device, but a conventionally predominating mode is a TN mode which creates an aligned state of liquid crystals being twisted at about 90° toward the upper substrate from the lower substrate of the liquid cell.

The liquid crystal display device generally comprises a liquid crystal cell, a phase difference film and a polarizing plate. The phase difference film is used for canceling the image coloration or enlarging the viewing angle, and a stretched birefringent film or a film obtained by coating a liquid crystal on a transparent film is used therefor. For example, Japanese Patent 2587398 discloses a technique where an optically-compensatory sheet obtained by coating, aligning and fixing a discotic liquid crystal on a triacetyl cellulose film is applied to a TN-mode liquid crystal cell to enlarge the viewing angle.

However, the requirement with respect to the viewing angle dependency of a liquid crystal display device for televisions having a large screen and envisaging viewing from various angles is severe and this requirement cannot be satisfied by the above-described technique. Therefore, various studies are being made on a liquid crystal display device different from the TN mode, such as IPS (in-plane switching) mode, OCB (optically compensatory bend) mode and VA (vertically aligned) mode.

The phase difference plate or optically-compensatory film for improving the viewing angle property or the like has various characteristics according to the display mode of various liquid crystal display devices, and the protective film of polarizing plate or the support of phase difference plate or optically-compensatory film is also required to satisfy various corresponding performances. As a result, not only diversified requirements such as high optical anisotropy or high optical isotropy of the protective film of polarizing plate or the support of phase difference plate or optically-compensatory film but also severely required performances are confronted. Also, the requirement for an inexpensive liquid crystal display device is increasing and enhancement of productivity (increase of yield, reduction in cost) of each component is strongly demanded.

In the protective film of the polarizing plate, a cellulose acylate film ensuring high optical isotropy, high moisture permeability and high adhesive property to polyvinyl alcohol (PVA) employed as a polarizer has been heretofore used.

Against conventional common knowledge, an inexpensive thin phase difference plate or polarizing plate with phase difference film, produced by imparting a positive high retardation to a cellulose acylate film, has been recently disclosed. For example, European Unexamined Patent Publication 0911656A2 discloses a cellulose acetate film having a positive high retardation value against conventional common principle and usable also for applications requiring optical anisotropy. In this patent document, in order to realize a positive high retardation value with a cellulose triacetate, the stretching is performed by adding an aromatic compound having at least two aromatic rings, particularly, a compound having a 1,3,5-triazine ring.

On the other hand, it is required to more enhance the optical isotropy of a cellulose acetate film and thereby decrease the retardation not only in the front but also in the thickness direction so that the same optical properties as viewed from the front can be ensured even when obliquely viewed. As for the material capable of decreasing the retardation other than cellulose acetate film, a polycarbonate-based film or a cyclic olefin-based is disclosed (see, JP-A-2001-318233 (the term “JP-A” as used herein means an “unexamined published Japanese patent application”) and JP-A-2002-328233), but such a film has high hydrophobicity and is disadvantageous, for example, in that the lamination property to PVA used as the polarizer is poor.

To solve this problem, JP-A-2005-120352 proposes an optically isotropic and optically transparent film using a cellulose acylate film excellent in lamination suitability to PVA, which is improved by more decreasing the optical anisotropy and made optically isotropic with Re of the front being nearly zero and at the same time, the change in retardation due to angle change being small, that is, Rth being also nearly zero.

### SUMMARY OF THE INVENTION

However, in the production method of a cellulose acylate film disclosed in JP-A-2005-120352, when a solution stored for a time after dissolution is used, the produced film comes to contain foreign matters. On this point, improvement is demanded. Furthermore, streaky unevenness (also called casting unevenness) is sometimes formed at the casting and improvement is demanded.

The present invention has been made under these circumstances, and an object of the present invention is to provide a cellulose acylate film having a small or negative retardation value in the plane as well as in the thickness direction and ensuring that a film reduced in foreign matters, streaky unevenness, scratches and the like and excellent in the planarity can be produced with good yield at a low cost.

Another object of the present invention is to provide an optically-compensatory film, a polarizing plate and a liquid crystal display device, which are inexpensive and excellent in the optical properties, by using the inexpensive cellulose acylate film having excellent optical properties.

As a result of intensive studies, the present inventors have found that the decrease of foreign matters generated in the cellulose acylate film can be achieved by improving the dissolved state of the cellulose acylate solution. The cellulose acylate is a cellulose of which OH group is acyl-substituted, but the OH group partially remains as it is or a large number of fine crystal sites are present. The cellulose acylate solution for casting has a high concentration and a high viscosity and can be hardly formed into a molecular dispersion state, and foreign matters are readily generated in the film produced by casting and film-forming this solution. In the present invention, the cellulose acylate solution is passed through a step from the heated state to the cooled state and a step from the cooled state to the heated state, whereby the dissolved state of the cellulose acylate solution is improved and the number of foreign matters generated in the film can be reduced. Also, the number of occurrences of streaky unevenness can be improved by decreasing the adhesion of a non-dissoluble matter to the Giesser.

On the other hand, the surface roughness (surface concavities and convexities) of the film can be improved by controlling the drying speed of the film in the highly volatile matter state after casting and controlling the drying conditions in the tenter zone. The scratches of the film can be decreased by controlling the surface roughness of a pass roll.

The film foreign matter, streaky unevenness and film scratch are more easily detected as the beam transmittance of the entire film is higher or the retardation in the front as well as from the oblique direction is smaller, but it has been found that when the cellulose acylate film of the present invention is used for the optically-compensatory film or polarizing plate and incorporated into a liquid crystal panel or a liquid crystal display device, those defects become no problem in many cases. As a result, an optically-compensatory film, a polarizing plate and a liquid crystal display device, which are inexpensive and excellent without defects, can be successfully provided using the cellulose film of the present invention.

The above-described objects can be achieved by the following constructions.

(1) A cellulose acylate film having:

Re₍₅₉₀₎ and Rth₍₅₉₀₎ satisfying formulae (I) and (II); and

a beam transmittance of 88% or more at a wavelength of 590 nm,

wherein the number of foreign matters that have a long axis of 50 to 200 μm is 20 pieces/m² or less:

0≦Re₍₅₉₀₎≦10 Formula (I):

−25≦Rth₍₅₉₀₎≦25 Formula (II):

wherein Re₍₅₉₀₎ represents an in-plane retardation value (unit: nm) at a wavelength of 590 nm at 25° C. under 60% RH; and

Rth₍₅₉₀₎ represents a retardation value (unit: nm) in a thickness direction at a wavelength of 590 nm at 25° C. under 60% RH.

(2) A cellulose acylate film having:

Re₍₅₉₀₎ and Rth₍₅₉₀₎ satisfying formulae (I) and (II); and

a beam transmittance of 88% or more at a wavelength of 590 nm,

wherein the number of casting unevennesses that have a width of 10 to 100 μm is 10 pieces/m or less in a width direction:

0≦Re₍₅₉₀₎≦10 Formula (I):

−25≦Rth₍₅₉₀₎≦25 Formula (II):

wherein Re₍₅₉₀₎ represents an in-plane retardation value (unit: nm) at a wavelength of 590 nm at 25° C. under 60% RH; and

Rth₍₅₉₀₎ represents a retardation value (unit: nm) in a thickness direction at a wavelength of 590 nm at 25° C. under 60% RH.

(3) The cellulose acylate film as described in (1),

wherein the number of casting unevennesses that have a width of 10 to 100 μm is 10 pieces/m or less in a width direction.

(4) A cellulose acylate film having:

Re₍₅₉₀₎ and Rth₍₅₉₀₎ satisfying formulae (I) and (II); and

a beam transmittance of 88% or more at a wavelength of 590 nm,

wherein Ry, which represents a maximum height of surface concavities and convexities, is 3.0 μm or less; and

Sm, which represents an average distance between surface concavities and convexities, is from 1 μm to 1 mm:

0≦Re₍₅₉₀₎≦10 Formula (I):

−25≦Rth₍₅₉₀₎≦25 Formula (II):

wherein Re₍₅₉₀₎ represents an in-plane retardation value (unit: nm) at a wavelength of 590 nm at 25° C. under 60% RH; and

Rth₍₅₉₀₎ represents a retardation value (unit: nm) in a thickness direction at a wavelength of 590 nm at 25° C. under 60% RH.

(5) A cellulose acylate film as described in (1),

wherein Ry, which represents a maximum height of surface concavities and convexities, is 3.0 μm or less; and

Sm, which represents an average distance between surface concavities and convexities, is from 1 μm to 1 mm.

(6) A cellulose acylate film having:

Re₍₅₉₀₎ and Rth₍₅₉₀₎ satisfying formulae (I) and (II); and

a beam transmittance of 88% or more at a wavelength of 590 nm,

wherein the number of film scratches that have a width of 10 to 100 μm is from 0 to 10 pieces/m in a casting direction:

0≦Re₍₅₉₀₎≦10 Formula (I):

−25≦Rth₍₅₉₀₎≦25 Formula (II):

wherein Re₍₅₉₀₎ represents an in-plane retardation value (unit: nm) at a wavelength of 590 nm at 25° C. under 60% RH; and

Rth₍₅₉₀₎ represents a retardation value (unit: nm) in a thickness direction at a wavelength of 590 nm at 25° C. under 60% RH.

(7) The cellulose acylate film as described in (1),

wherein the number of film scratches that have a width of 10 to 100 μm is from 0 to 10 pieces/m in a casting direction.

(8) A production method of a cellulose acylate film, which is a method for producing a cellulose acylate film by a solution casting method comprising:

(I) a process of preparing a cellulose acylate solution;

(II) a process of casting the cellulose acylate solution to form a cast film (The cast film is also referred to as a “web” and includes both a film containing solvent and a film not containing solvent.);

(III) a process of drying the cast film before separation;

(IV) a process of separating the cast film;

(V) a process of tenter-drying the cast film; and

(VI) a process of cutting off an edge portion of the cast film and reeling the cast film,

wherein (I) the process of preparing the cellulose acylate solution comprises:

(i) a process of mixing and dissolving a cellulose acylate in an organic solvent at 25 to 95° C.;

(ii) a process of cooling the solution prepared at the process (i) down to −55 to 20° C.; and

(iii) a process of heating the solution prepared at the process (ii) up to 40 to 115° C.

(9) The production method of the cellulose acylate film as described in (8),

wherein (III) the process of drying the cast film before separation is performed such that, while the residual solvent amount of the cast film is from 220 to 100 mass % based on the solid content, an average decrease rate of the residual solvent amount is from 1 to 18 mass %/sec.

(10) The production method of a cellulose acylate film as described in (8),

wherein (V) the process of tenter-drying the cast film is performed such that, while the cast film is tenter-stretched, the cast film is dried by drying air at a temperature of from 40 to 150° C. and an average decrease rate of the residual solvent amount is from 0.01 to 3 mass %/sec.

(11) The production method of a cellulose acylate film as described in (8),

wherein a pass roll contacting the film at the reeling has a surface roughness of 0.5 μm or less.

(12) A cellulose acylate film, which is produced by the production method as described in (8).

(13) The cellulose acylate film as described in (1), which is produced by a solution casting method comprising:

(I) a process of preparing a cellulose acylate solution;

(II) a process of casting the cellulose acylate solution to form a cast film;

(III) a process of drying the cast film before separation;

(IV) a process of separating the cast film;

(V) a process of tenter-drying the cast film; and

(VI) a process of cutting off an edge portion of the cast film and reeling the cast film,

wherein (I) the process of preparing the cellulose acylate solution comprises:

(i) a process of mixing and dissolving a cellulose acylate in an organic solvent at 25 to 95° C.;

(ii) a process of cooling the solution prepared at the process (i) down to −55 to 20° C.; and

(iii) a process of heating the solution prepared at the process (ii) up to 40 to 115° C.

(14) The cellulose acylate film as described in (1), which has an acyl substitution degree (X+Y) satisfying formula (10):

2.6<X+Y≦3.0 Formula (10):

wherein X represents an acetyl substitution degree and Y represents an acyl substitution degree except for acetyl.

(15) The cellulose acylate film as described in (1), which has a thickness of from 30 to 120 μm.

(16) An optically-compensatory film comprising:

the cellulose acylate film as described in (1); and

an optically anisotropic layer having Re₍₅₉₀₎ of from 0 to 200 nm and |Rth₍₅₉₀₎| of from 0 to 400 nm.

(17) A polarizing plate comprising:

a polarizer-protective film on a liquid crystal cell side of the polarizing plate,

wherein the polarizer-protective film is the cellulose acylate film as described in (15).

(18) A polarizing plate comprising:

a polarizer; and

a pair of polarizer-protective films sandwiching the polarizer,

wherein at lease one of the polarizer-protective films is the cellulose acylate film as described in (15).

(19) A liquid crystal display device comprising:

the cellulose acylate film as described in (15).

### DETAILED DESCRIPTION OF THE INVENTION

The present invention is described in detail below.

### <Optical Properties of Cellulose Acylate Film>

### [Retardation of Cellulose Acylate Film]

In the cellulose acylate film of the present invention, the in-plane retardation value Re₍₅₉₀₎ at a wavelength of 590 nm under the conditions of 25° C. and 60% RH satisfies the following formula (1). In this formula, the unit of Re is nm.

0≦Re₍₅₉₀₎≦10 Formula (I):

The Re₍₅₉₀₎ value is preferably from 0 to 7 nm, more preferably from 0 to 5 nm, still more preferably from 0 to 2 nm.

Also, the retardation value Rth₍₅₉₀₎ in a thickness direction at a wavelength of 590 nm under the conditions of 25° C. and 60% RH satisfies the following formula (II). In this formula, the unit of Rth is nm.

−25≦Rth₍₅₉₀₎≦25 Formula (II):

The Rth₍₅₉₀₎ value is preferably from −20 to 20 nm, more preferably from −15 to 15 nm, still more preferably from −10 to 10 nm.

The cellulose acylate film of the present invention having a small retardation in the thickness direction has a characteristic feature that unnecessary birefringence is not caused in the film thickness direction, and the latitude in the optical design of a liquid crystal display device can be remarkably enhanced by using the cellulose acylate film of the present invention. Particularly, when a cellulose acylate film small in both the in-plane retardation and the retardation in a thickness direction is used as a support of a polarizing plate protective film or an optically-compensatory film, the birefringence of other members or the optical compensation layer in the optically-compensatory film can be utilized without hindering their optically compensating ability.

The in-plane retardation Re and the retardation Rth in a thickness direction of the cellulose acylate film of the present invention both are preferably subject to small change due to humidity and preferably satisfy the following formulae (III) and (IV):

|Re_{10%}−Re_{80%}|≦25 Formula (III):

|Rth_{10%}−Rth_{80%}|≦35 Formula (IV):

[wherein in formula (III), Re_{10%} and Re_{80%} are the in-plane retardation at a wavelength of 590 nm under the conditions of 25° C. and 10% RH and under the conditions of 25° C. and 80% RH, respectively, and in formula (IV), Rth_{10%} and Rth_{80%} are the retardation in a thickness direction at a wavelength of 590 nm under the conditions of 25° C. and 10% RH and under the conditions of 25° C. and 80% RH, respectively].

|Re_{10%}−Re_{80%}| is preferably from 0 to 20 nm, more preferably from 0 to 15 nm.

|Rth_{10%}−Rth_{80%}| is preferably from 0 to 25 nm, more preferably from 0 to 15 nm.

In the cellulose acylate film of the present invention, |Re₍₄₀₀₎−Re₍₇₀₀₎| and |Rth₍₄₀₀₎−Rth₍₇₀₀₎|, that is, respective differences of Re and Rth between the wavelengths of 400 nm and 700 nm, are preferably small and are preferably |Re₍₄₀₀₎−Re₍₇₀₀₎|≦10 and |Rth₍₄₀₀₎−Rth₍₇₀₀₎|≦35, more preferably |Re₍₄₀₀₎−Re₍₇₀₀₎|≦5 and |Rth₍₄₀₀₎−Rth₍₇₀₀₎|≦25, still more preferably |Re₍₄₀₀₎−Re₍₇₀₀₎|≦3 and |Rth₍₄₀₀₎−Rth₍₇₀₀₎|≦15.

Each retardation is measured under the conditions of 25° C. and 60% RH.

In the present specification, Re(λ) and Rth(λ) indicate the in-plane retardation and the retardation in a thickness direction, respectively, at a wavelength of λ. Re(λ) is measured using light at a wavelength of λ nm made incident in the film normal direction in KOBRA 21ADH (manufactured by Oji Scientific Instruments). As for Rth(λ), the Re(λ) is measured at 11 points using light at a wavelength of λ nm made incident from directions inclined with respect the film normal direction in steps of 10° from −50° to +50° by using the in-plane slow axis (judged by KOBRA 21ADH) as the inclination axis (rotation axis), and calculation is performed by KOBRA 21 ADH based on the retardation values measured, the assumed values of average refractive index and the film thickness values input. Here, as for the assumed value of average refractive index, those described in Polymer Handbook (John Wiley & Sons, Inc.) and catalogues of various optical films can be used. The average refractive index of which value is unknown can be measured by an Abbe refractometer. The values of average refractive index of main optical films are as follows: cellulose acylate (1.48), cycloolefin polymer (1.52), polycarbonate (1.59), polymethyl methacrylate (1.49) and polystyrene (1.59). When such an assumed value of average refractive index and the film thickness are input, KOBRA 21ADH calculates nx, ny and nz and from these calculated nx, ny and nz, further calculates Nz=(nx−nz)/(nx−ny).

### [Fluctuation of Retardation]

The fluctuation of the retardation value is a difference between the maximum value and the minimum value out of the values sampled every 100 m in the longitudinal direction at 5 points in the width direction (center, edge parts (positions in 5% of the entire width from both edges) and 2 midpoints between the center and respective edge parts) and is preferably 10 nm or less, more preferably 5 nm or less, still more preferably 1 nm or less.

### [Film Transparency]

The cellulose acylate film of the present invention has high transparency and is preferred as a film for optical usage. The beam transmittance at a wavelength of 590 nm is preferably 88% or more, more preferably 90% or more.

### [Film Foreign Matter]

In one embodiment of the cellulose acylate film of the present invention, the number of foreign matters having a long axis of 50 to 200 μm per m² is from 0 to 20 pieces/m². The foreign matter is a thing that can be recognized by using a loupe, an optical microscope, a polarizing microscope or the like as a region where any one of transmitted light, reflected light and polarized light differs from the peripheral normal region. The foreign matter includes a thing which comes from outside in the process such as dusts, an undissolved material in raw materials for casting solution (for example, a cellulose acylate having low substitution degree or an unreacted cellulose, which are produced when enough reaction can not occur because fine crystals are formed at the synthesis of cellulose acylate), an impurity (which are contained in additive agents such as a plasticizer), a skinning in casting solution, and a solidified component such as a reactant. As a film for optical usage, a smaller number of foreign matters is preferred, and the number of foreign matters is preferably 10 pieces/m² or less, more preferably 5 pieces/m² or less, still more preferably 3 pieces/m² or less.

### [Film Casting Unevenness]

In one embodiment of the cellulose acylate film of the present invention, the number of film casting unevennesses having a width of 10 to 100 μm per m in the width direction is from 0 to 10 pieces/m. The film casting unevenness is a thing that can be recognized by using a loupe, an optical microscope, a polarizing microscope or the like as a region where any one of transmitted light, reflected light and polarized light differs from the peripheral normal region and where the thickness, retardation Re or Rth, in-plane slow axis direction, degree of surface treatment or the like changes intermittently in the axis direction. As a film for optical uses, a smaller number of film casting unevennesses is preferred, but the cellulose acylate film of the present invention has high beam transmittance and small retardation in the front as well as in the oblique direction and therefore, the film casting unevenness is easy to recognize. The number of film casting unevennesses is preferably 10 pieces/m or less, more preferably 5 pieces/m or less, still more preferably 3 pieces/m or less.

### [Film Scratch]

In one embodiment of the cellulose acylate film of the present invention, the number of film scratches having a width of 10 to 100 μm per m in the casting direction is from 0 to 10 pieces/m. The film scratch is a thing that can be recognized by using a loupe, an optical microscope, a polarizing microscope or the like as a concavity or convexity, which has a length of 3 mm or more and a height of 0.1 μm or more and where any one of transmitted light, reflected light and polarized light intermittently differs from the peripheral normal region. As a film for optical usage, a smaller number of scratches are preferred, but the cellulose acylate film of the present invention has high beam transmittance and small retardation in the front as well as in the oblique direction and therefore, the film scratch is easy to recognize. The number of film scratches is preferably 10 pieces/m or less, more preferably 5 pieces/m or less, still more preferably 3 pieces/m or less.

### [Film Planarity]

In one embodiment of the cellulose acylate film of the present invention, as regards the film surface, the maximum height (Ry) of surface concavities and convexities according to JIS B0601-1994 is 3.0 μm or less. The Ry is preferably from 0.5 to 2.5 μm, more preferably from 0.5 to 2.0 μm. The shape of concave or convex on the film surface can be evaluated by an atom force microscope (AFM).

Also, the average distance (Sm) between surface concavities and convexities according to JIS B0601-1994 is preferably from 1 μm to 1 mm, more preferably from 10 μm to 1 mm, still more preferably from 100 μm to 1 mm.

### [Raw Material of Cellulose Acylate Film]

As for the raw material of the cellulose acylate film of the present invention, the following cellulose acylate described be used, and various compounds and other components such as additive, which are described below, can be appropriately used.

### (Cellulose Acylate)

The glucose unit forming the cellulose has three hydroxyl groups capable of bonding. For example, in a cellulose triacetate, when three hydroxyl groups of the glucose unit all are bonded to the acetyl group, the substitution degree by the acetyl group is 3.0. As the substitution degree of cellulose acylate is higher, the retardation in a thickness direction can be advantageously made smaller. The cellulose acylate has a property of the intrinsic birefringence being changed from positive to negative when the substitution degree becomes large. When the cellulose acylate has a high substitution degree and a negative intrinsic birefringence, the retardation in a thickness direction can be decreased by stretching.

The substitution degree by such an acyl group can be measured according to ASTM-D817-96.

As for the acyl substitution degree of the cellulose acylate, assuming that the acetyl substitution degree by acetic acid is X and the acyl substitution degree by an acyl group except for acetic acid, such as propionic acid or butyric acid, is Y, a cellulose acylate satisfying the following formula (10) is preferred.

2.6<X+Y≦3.0 Formula (10):

X+Y is preferably more than 2.6 and 3.0 or less for reducing the Rth, more preferably from 2.70 to 3.00, still more preferably from 2.85 to 2.98, yet still more preferably from 2.91 to 2.98.

In the cellulose acylate for use in the present invention, the raw material cellulose of the cellulose acylate may be derived from either cotton linter or wood pulp. Furthermore, a mixture of cotton linter-derived cellulose and wood pulp-derived cellulose, or a cellulose comprising kenaf or the like other than cotton linter or wool pulp may also be used.

Examples of the cellulose acylate for use in the present invention include an aliphatic carboxylic acid or inorganic acid, such as triacetyl cellulose (TAC), diacetyl cellulose (DAC), cellulose acetate propionate (CAP), cellulose acetate butyrate (CAB), cellulose acetate phthalate, cellulose acetate trimellitate and cellulose nitrate; a carboxylic acid having an aromatic ring; a polyvalent carboxylic acid such as dicarboxylic acid and tricarboxylic acid; and cellulose esters such as partial ester of polyvalent carboxylic acid.

The cellulose acylate for use in the present invention has water-absorbing property and preferably contains moisture at a moisture content of 0.4 to 4.4%. The moisture content in this range is preferred in view of controlling the amount of solid content in the cellulose acylate solution.

The polymerization degree of the cellulose acylate for use in the present invention is, in terms of the viscosity average polymerization degree, preferably from 200 to 800, more preferably from 250 to 650. The viscosity average polymerization degree can be measured according to the intrinsic viscosity method proposed by Uda et al. (see, Kazuo Uda and Hideo Saito, Fiber, Vol. 18, No. 1, pp. 105-120 (1962)). The measuring method of the viscosity average polymerization degree is described also in JP-A-9-95538.

When the molecular weight of the cellulose acylate is high, the modulus of the film can be made somewhat large, but if the molecular weight is excessively increased, the viscosity of the cellulose acylate solution becomes too high, as a result, shading or the like is readily generated to decrease the productivity. The molecular weight of the cellulose acylate is, in terms of the number average molecular weight (Mn), preferably from 50,000 to 200,000, more preferably from 100,000 to 200,000. In the cellulose acylate for use in the present invention, the Mw/Mn ratio is preferably from 1.6 to 4.5. more preferably from 2.4 to 3.6.

The average molecular weight and molecular weight distribution of the cellulose acylate can be measured using high-performance liquid chromatography. After measuring the number average molecular weight (Mn) and the weight average molecular weight (Mw) by high-performance liquid chromatography, the ratio therebetween can be calculated.

The measurement conditions are as follows.

### Solvent: Methylene chloride

### Column:

Shodex K806, K805 and K803G (manufactured by Showa Denko K.K., three columns are connected and used)

Column temperature: 25° C.
Sample concentration: 0.1 mass %

### Detector: RI Model 504 (manufactured by GL Science Inc.)

### Pump: L6000 (manufactured by Hitachi Ltd.)

Flow rate: 1.0 ml/min
Calibration curve:

A calibration curve using 13 standard polystyrene samples, STK Standard Polystyrene (produced by Tosoh Corp.), with Mw being changed from 1,000,000 to 500 is used; 13 samples are preferably used nearly at regular intervals.

### <Retardation Decreasing Agent>

The retardation decreasing agent for use in the present invention is a compound for decreasing the retardation in a thickness direction, and specific examples thereof include, but are not limited to, the compounds represented by the following formulae (1) and (2).

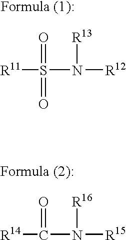

In formula (1), R¹¹ represents an alkyl group or an aryl group, and R¹² and R¹³ each independently represents a hydrogen atom, an alkyl group or an aryl group. The total number of carbon atoms in R¹¹, R¹² and R¹³ is preferably 10 or more. In R¹¹, R¹² and R¹³, the alkyl group and the aryl group each may have a substituent.

The substituent of the alkyl or aryl group is preferably a fluorine atom, an alkyl group, an aryl group, an alkoxy group, a sulfone group or a sulfonamide group, more preferably an alkyl group, an aryl group, an alkoxy group, a sulfone group or a sulfone amide group. The alkyl group may be linear, branched or cyclic and is preferably an alkyl group having a carbon number of 1 to 25, more preferably from 6 to 25, still more preferably from 6 to 20 (e.g., methyl, ethyl, propyl, isopropyl, butyl, isobutyl, tert-butyl, amyl, isoamyl, tert-amyl, hexyl, cyclohexyl, heptyl, octyl, bicyclooctyl, nonyl, adamantyl, decyl, tert-octyl, undecyl, dodecyl, tridecyl, tetradecyl, pentadecyl, hexadecyl, heptadecyl, octadecyl, nonadecyl, didecyl). The aryl group is preferably an aryl group having a carbon number of 6 to 30, more preferably from 6 to 24 (e.g., phenyl, biphenyl, terphenyl, naphthyl, binaphthyl, triphenylphenyl).

Preferred examples of the compound represented by formula (1) are set forth below, but the present invention is not limited to these specific examples.

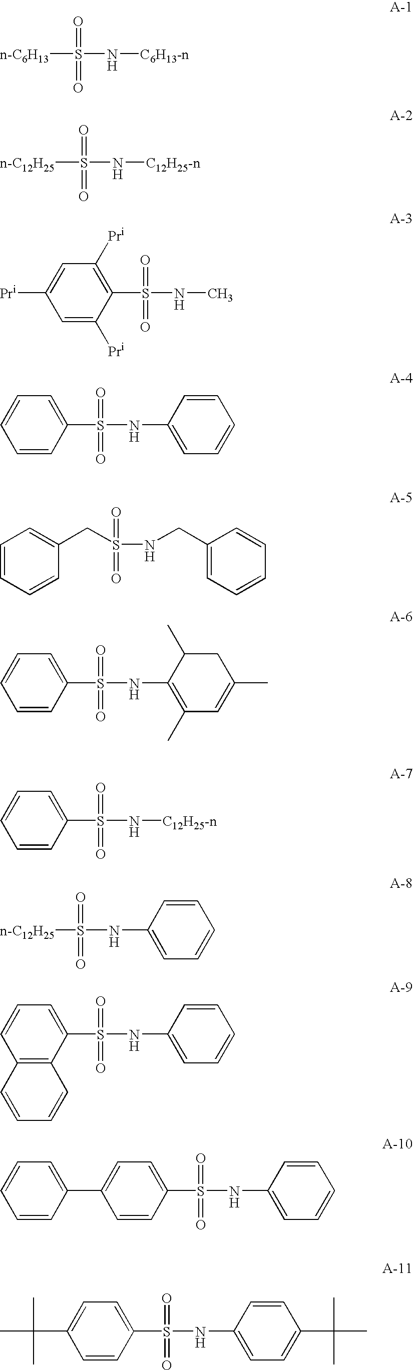

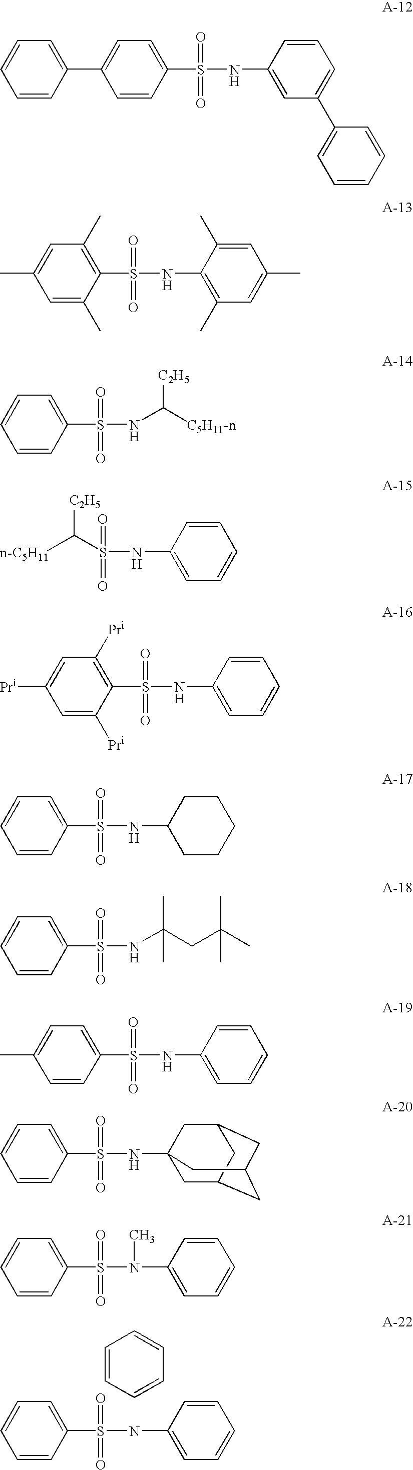

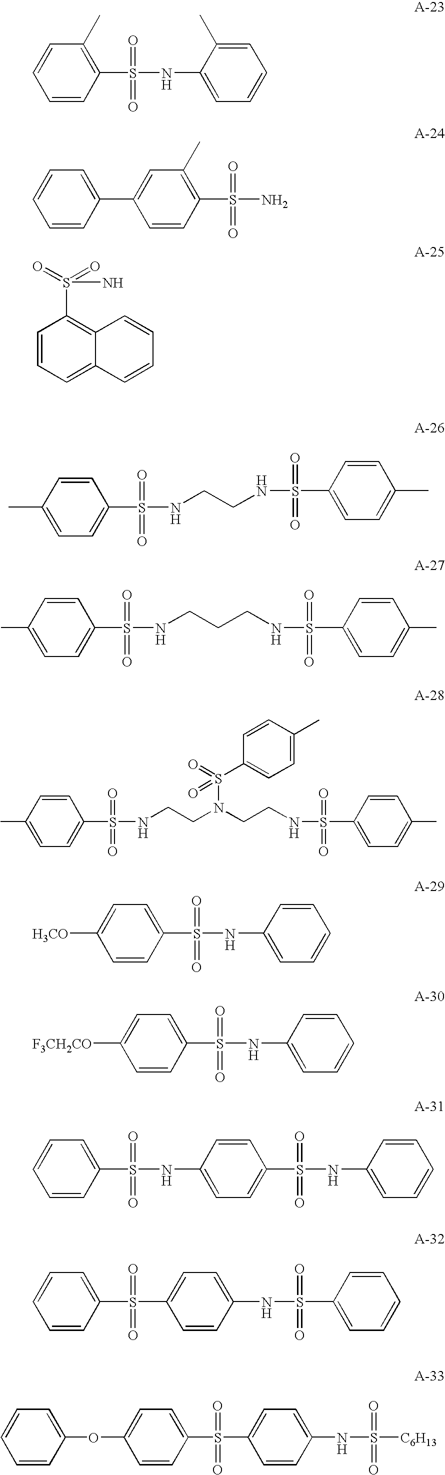

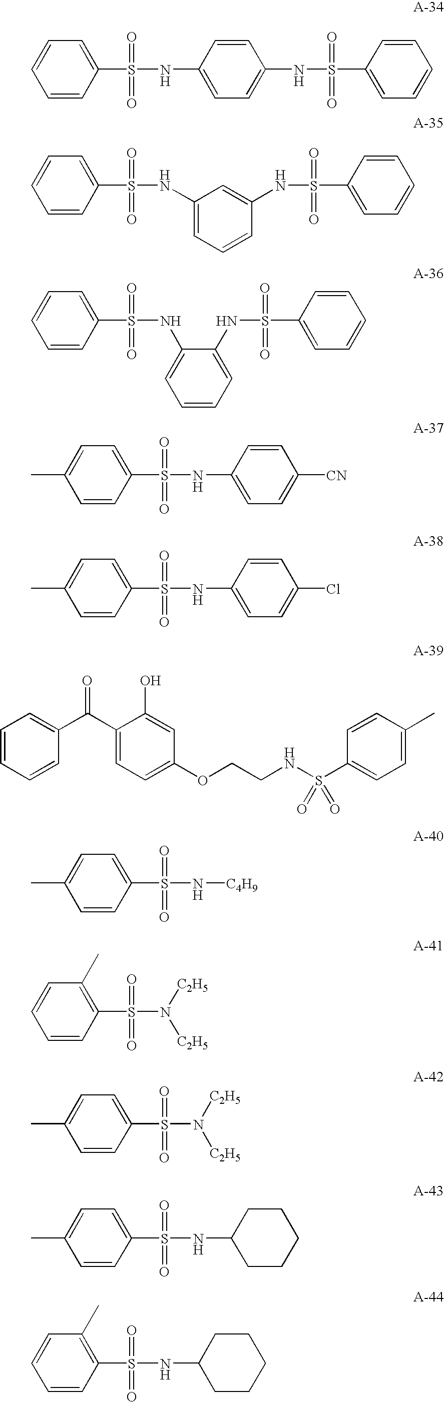

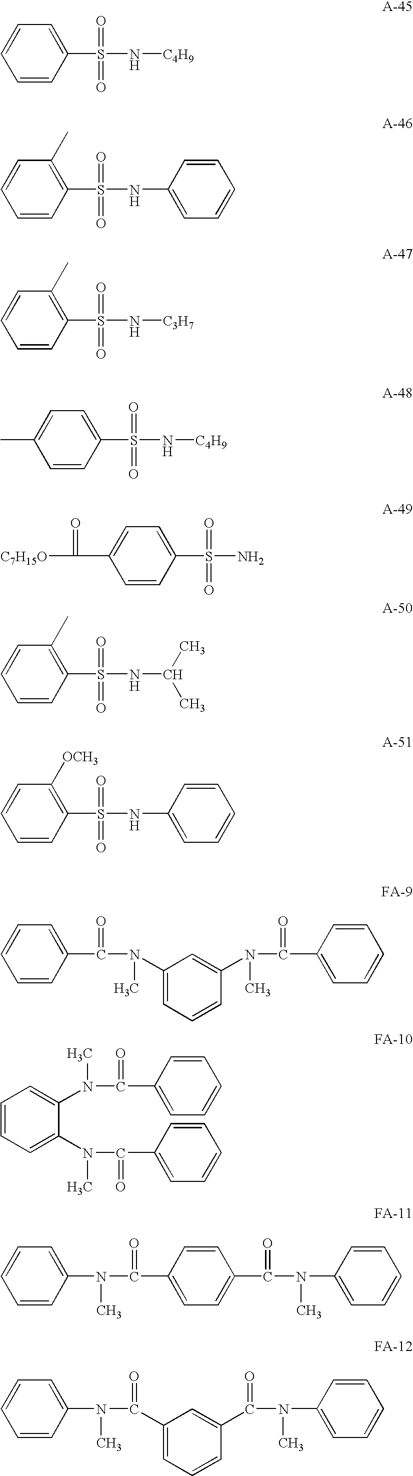

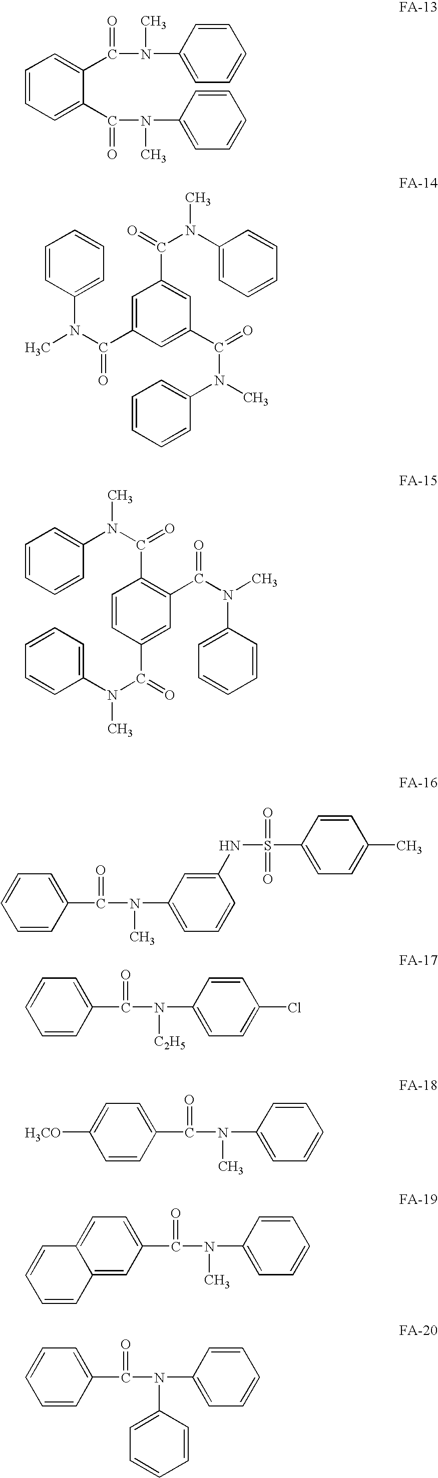

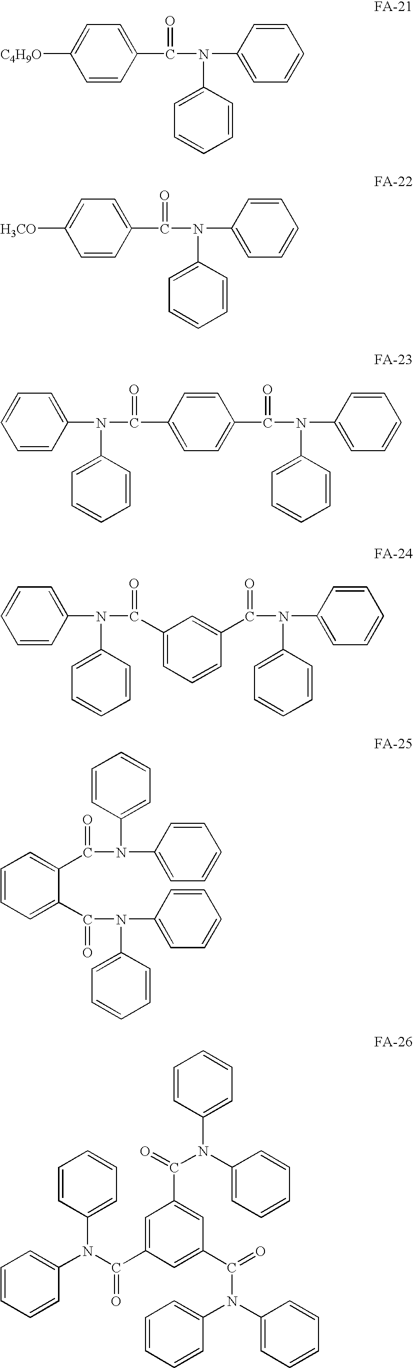

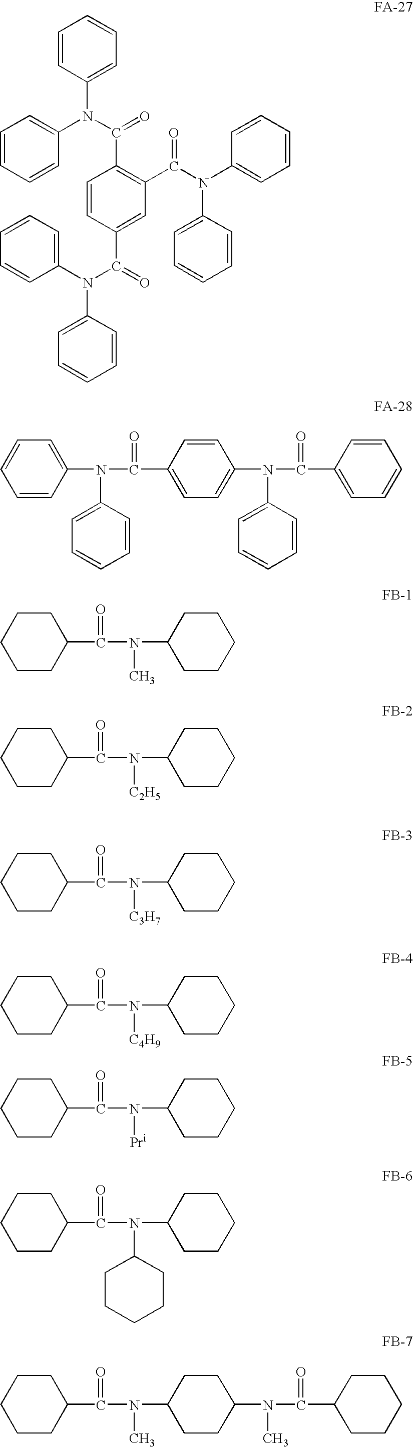

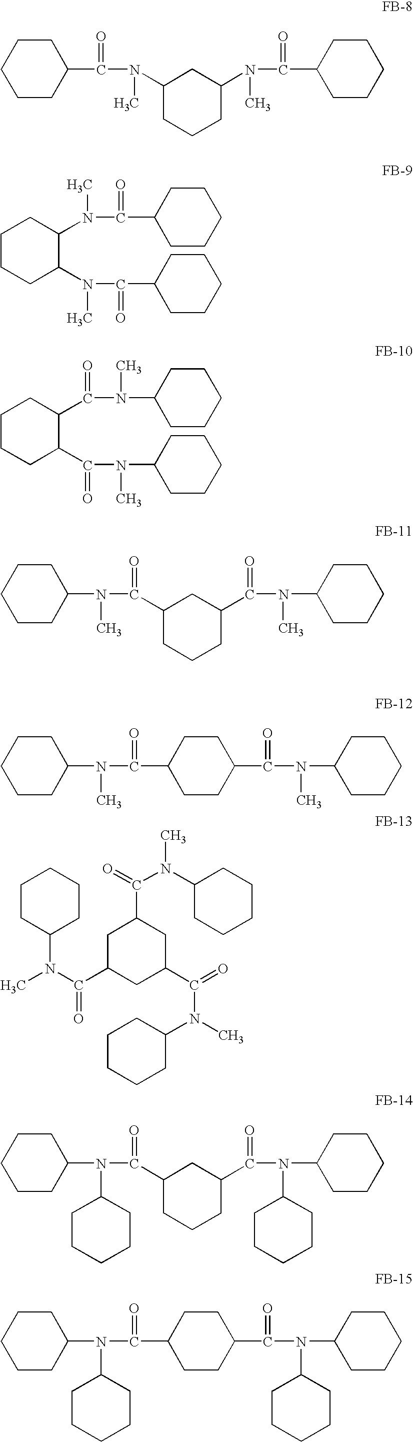

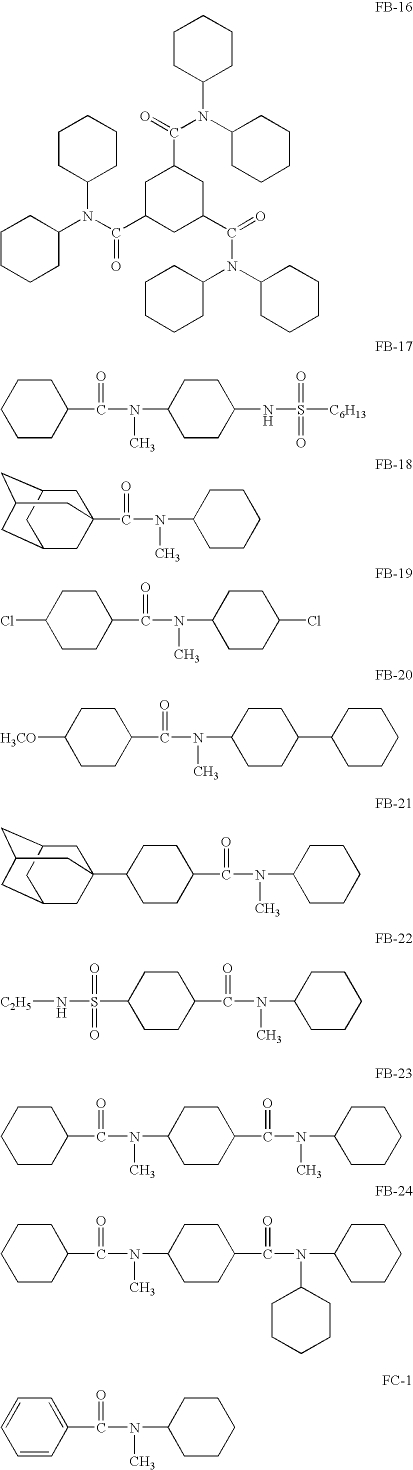

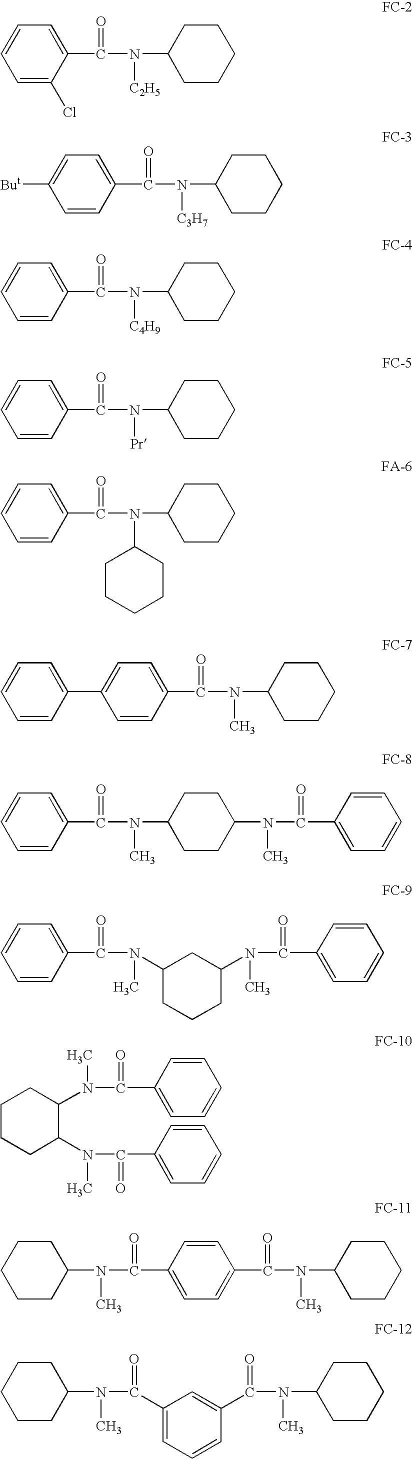

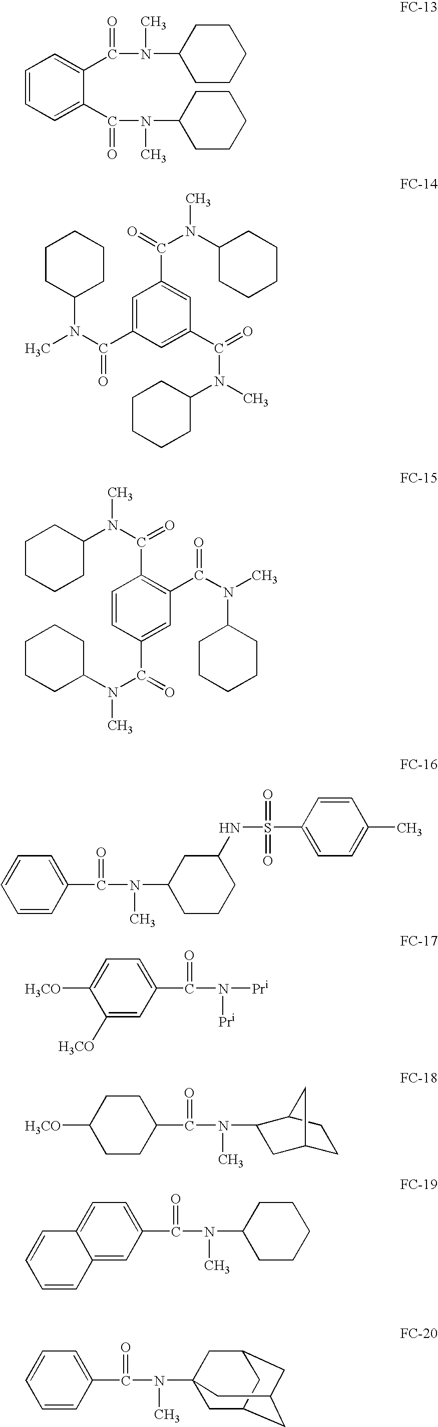

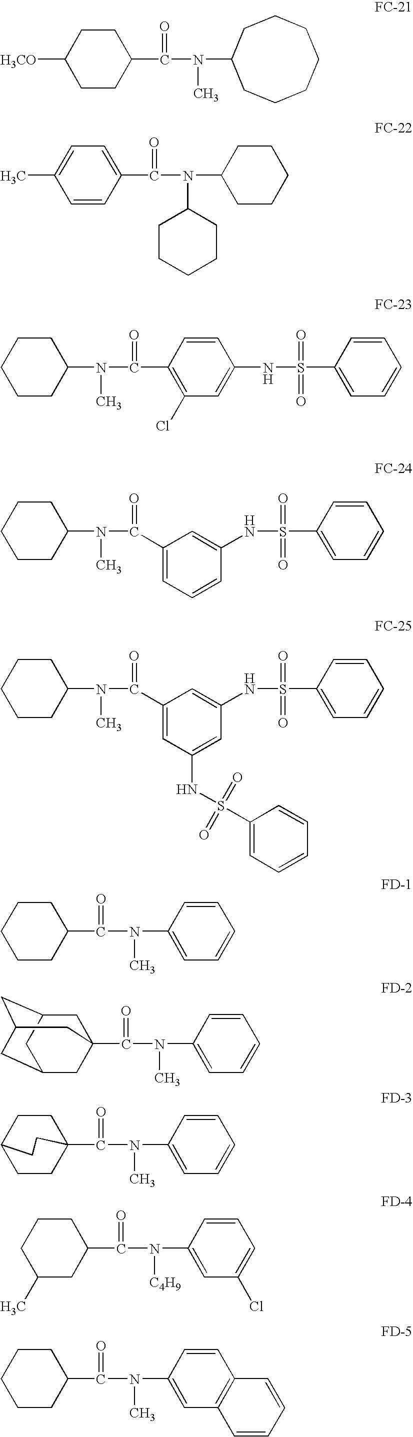

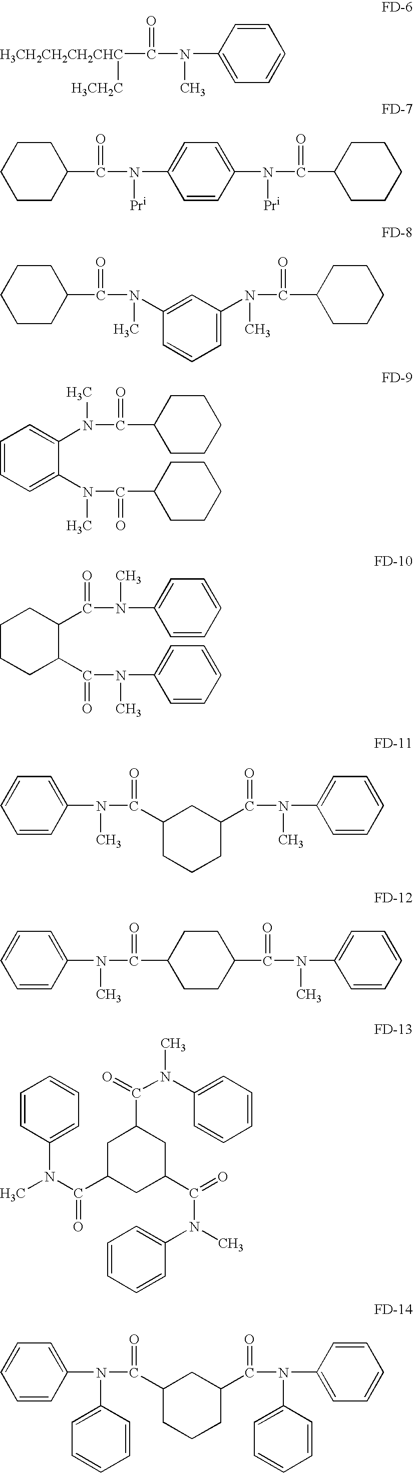

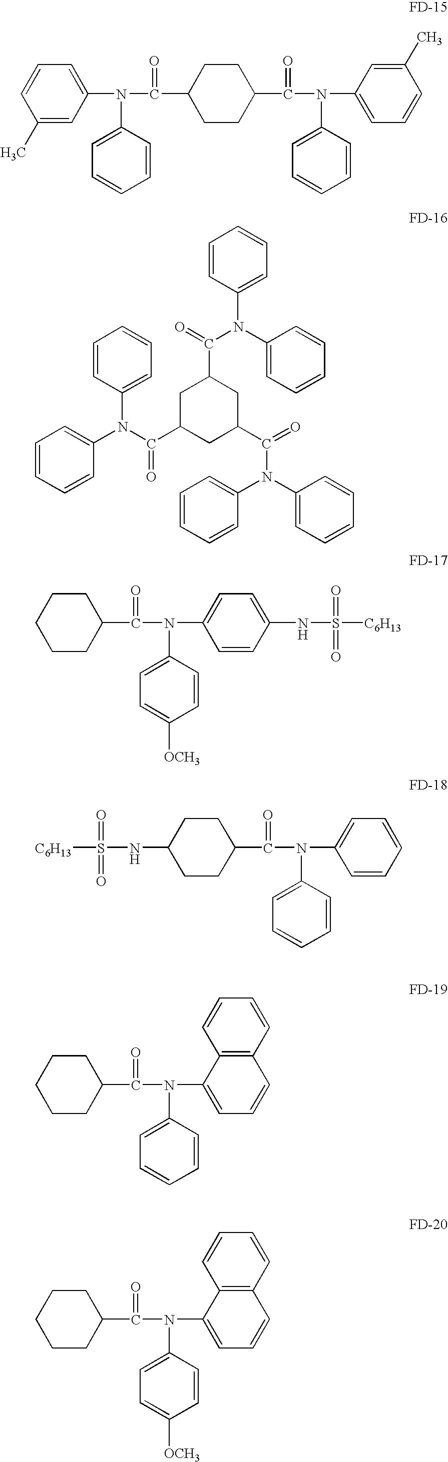

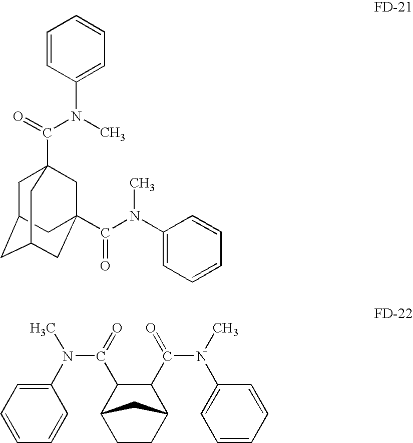

The compound represented by formula (2) is described below.

In the formula, R¹⁴ represents an alkyl group or an aryl group, and R¹⁵ and R¹⁶ each independently represents a hydrogen atom, an alkyl group or an aryl group. The alkyl group and the aryl group each may have a substituent.

More preferably, R¹⁴, R¹⁵ and R¹⁶ each independently represents an alkyl group or an aryl group. Here, the alkyl group may be linear, branched or cyclic and is preferably an alkyl group having a carbon number of 1 to 20, more preferably from 1 to 15, and most preferably from 1 to 12. The cyclic alkyl group is preferably a cyclohexyl group. The aryl group is preferably an aryl group having a carbon number of 6 to 36, more preferably from 6 to 24.

The alkyl group and the aryl group each may have a substituent. The substituent is preferably a halogen atom (e.g., chlorine, bromine, fluorine, iodine), an alkyl group, an aryl group, an alkoxy group, an aryloxy group, an acyl group, an alkoxycarbonyl group, an aryloxycarbonyl group, an acyloxy group, a sulfonylamino group, a hydroxy group, a cyano group, an amino group or an acylamino group, more preferably a halogen atom, an alkyl group, an aryl group, an alkoxy group, an aryloxy group, a sulfonylamino group or an acylamino group, still more preferably an alkyl group, an aryl group, a sulfonylamino group or an acylamino group.

Preferred examples of the compound represented by formula (2) are set forth below, but the present invention is not limited to these specific examples.

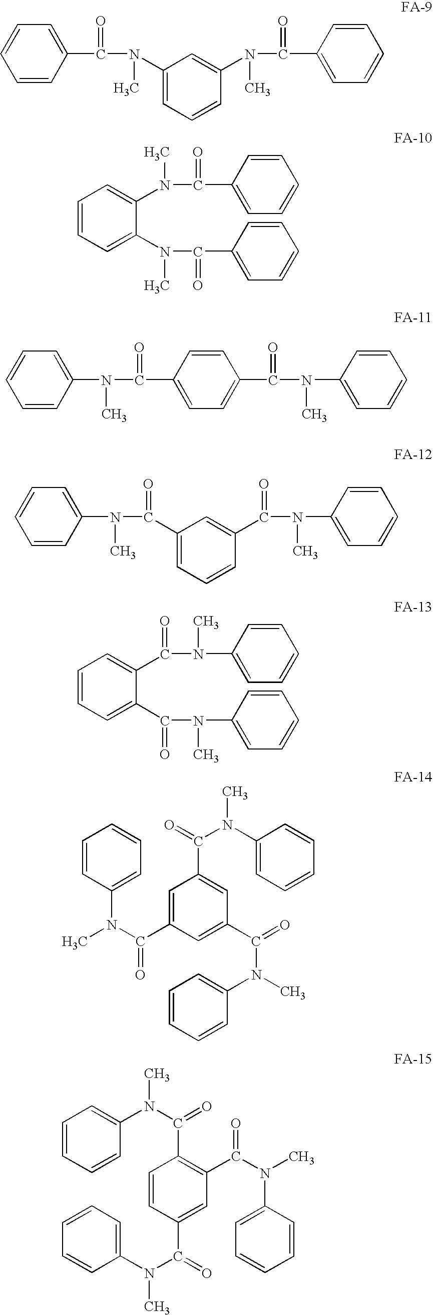

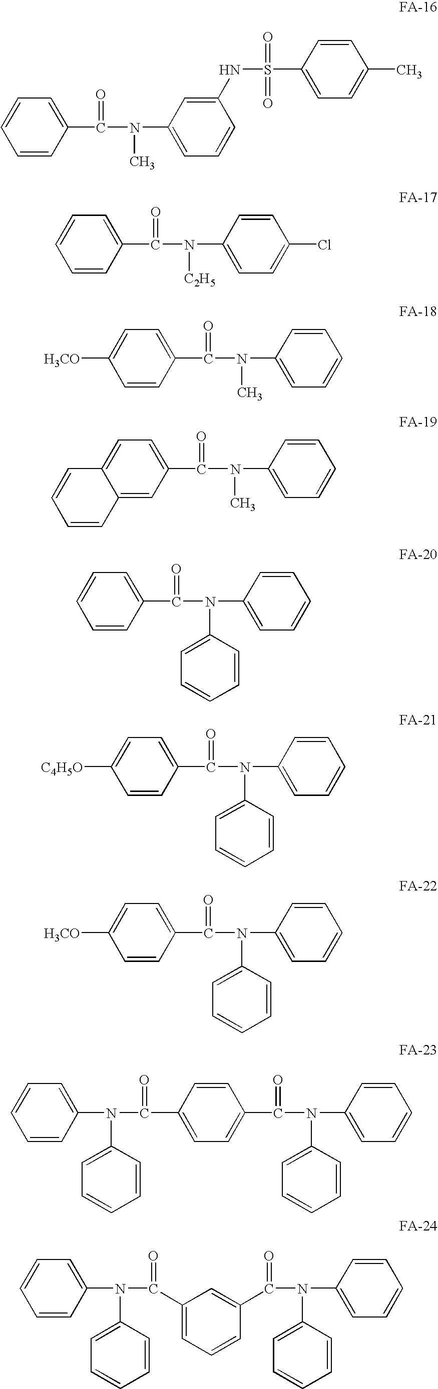

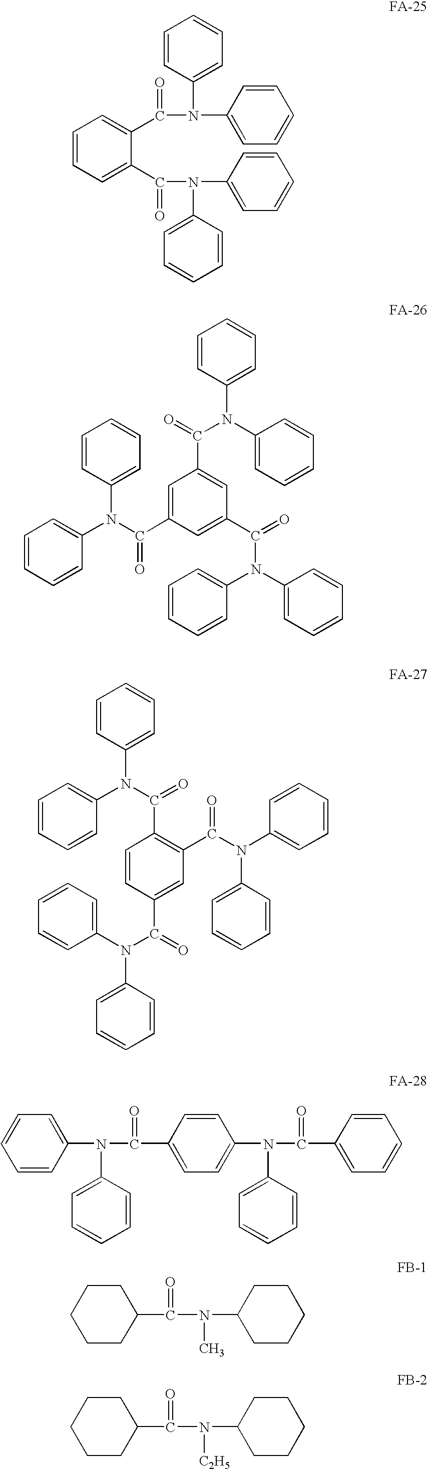

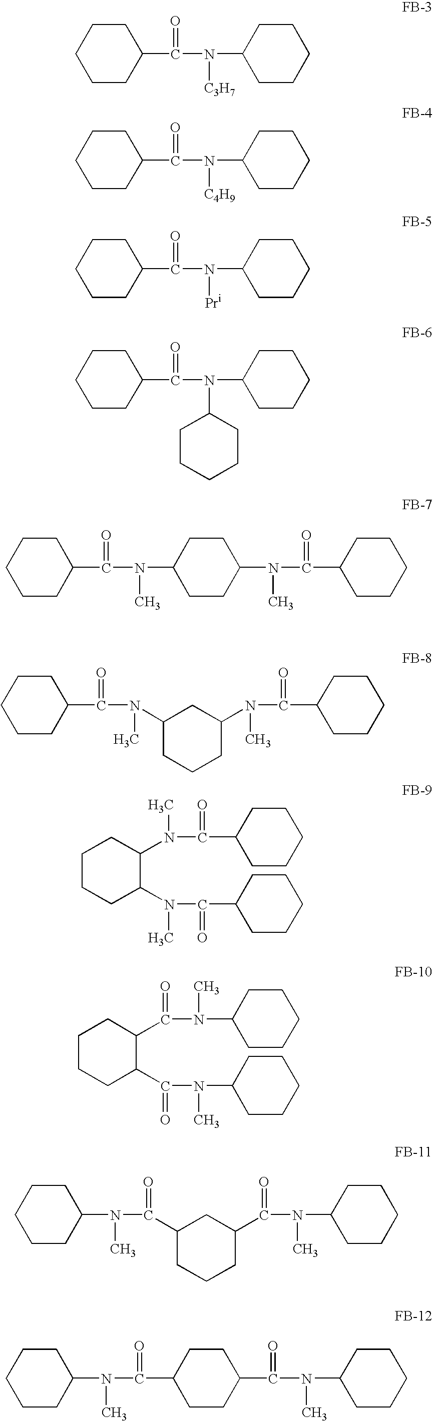

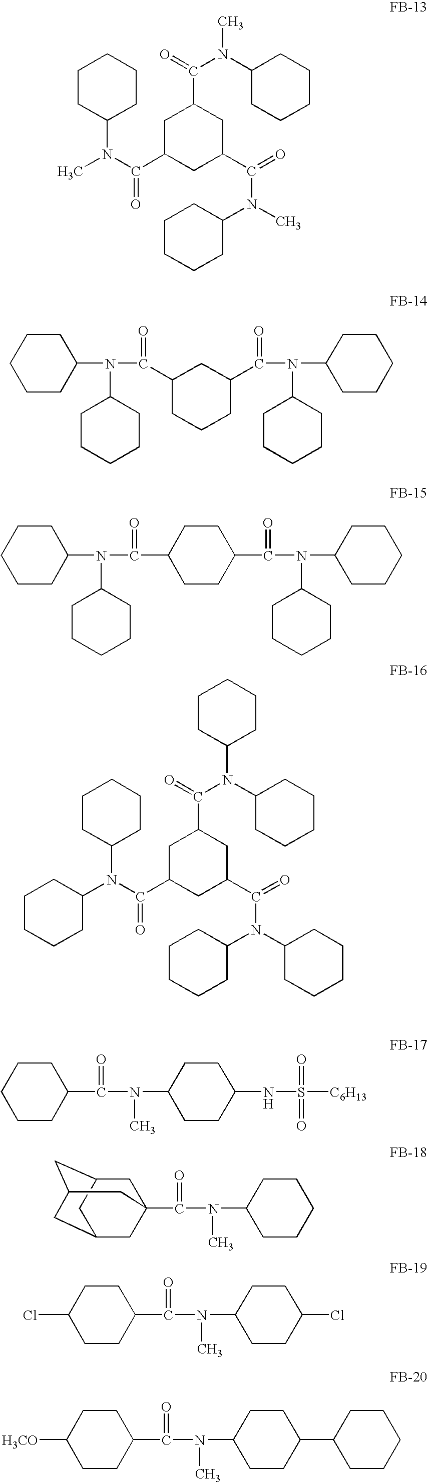

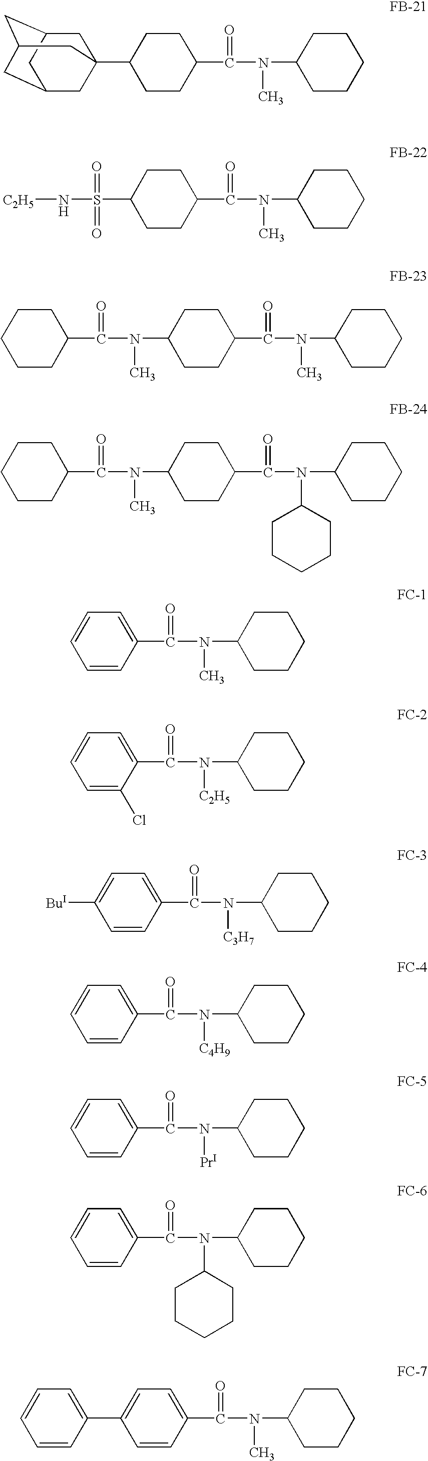

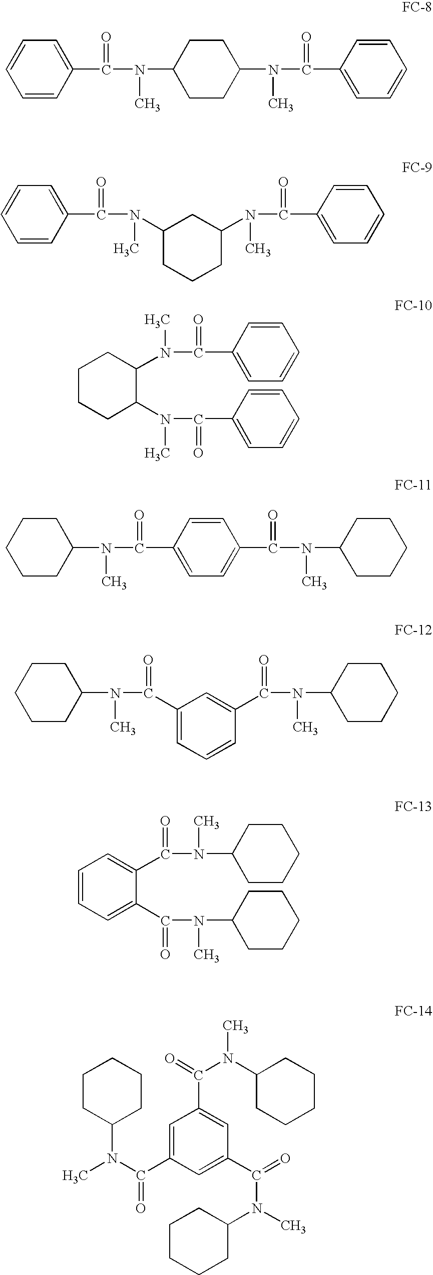

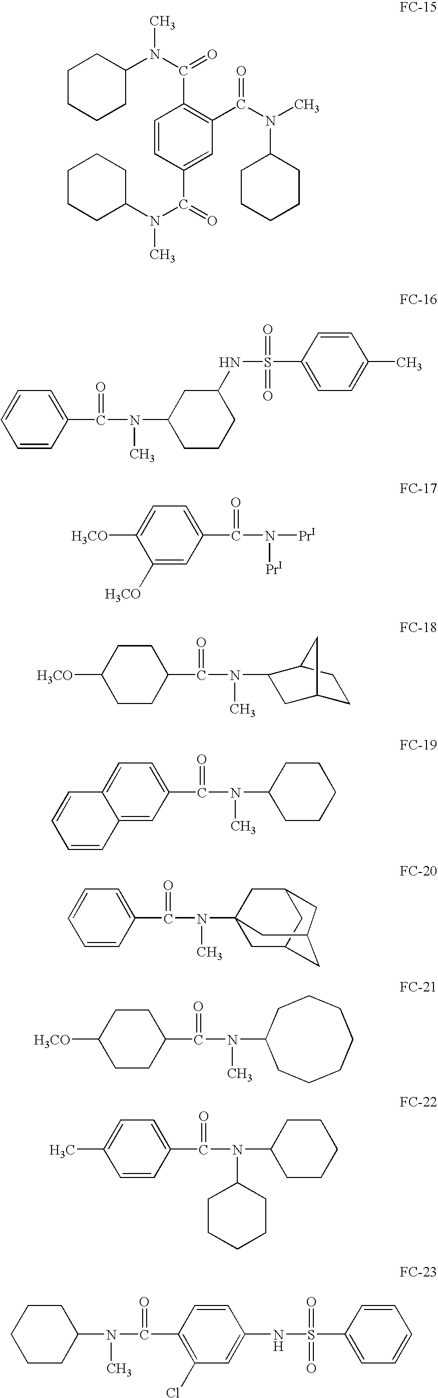

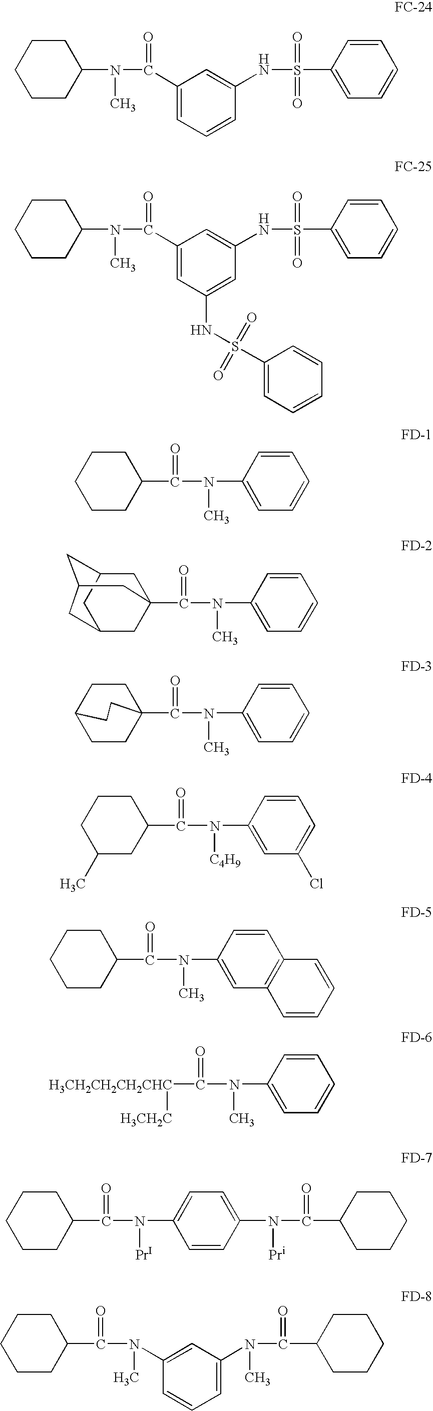

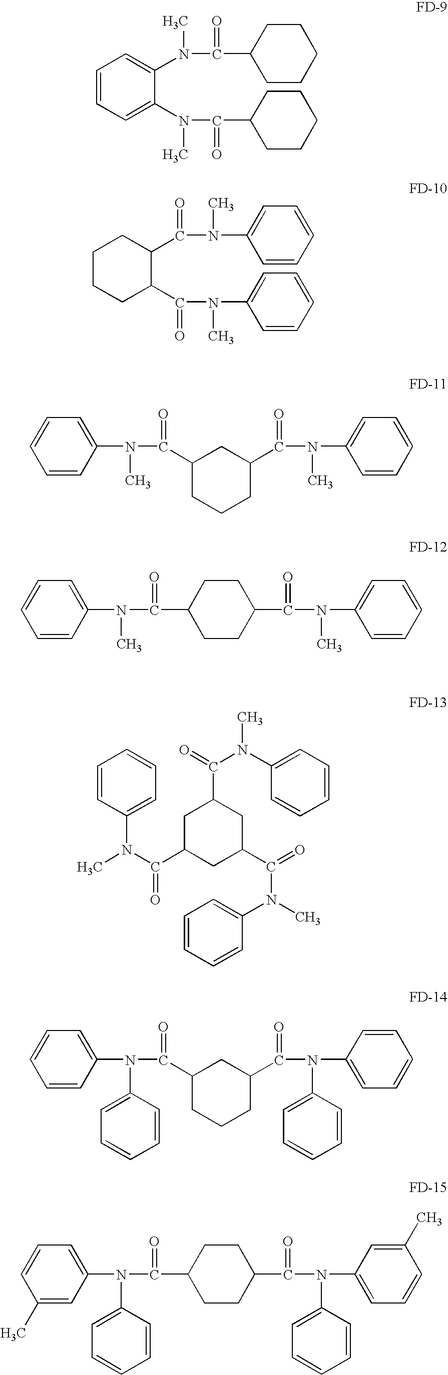

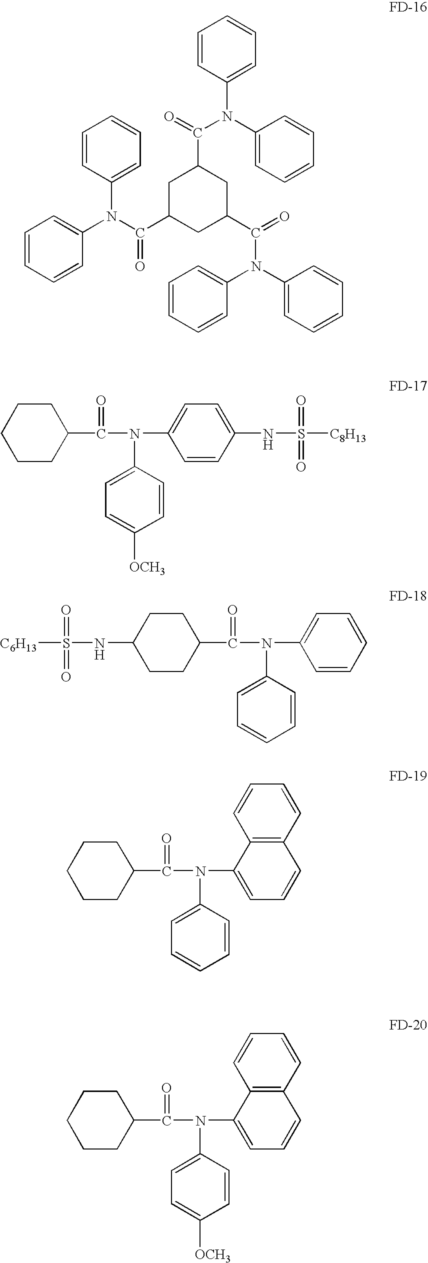

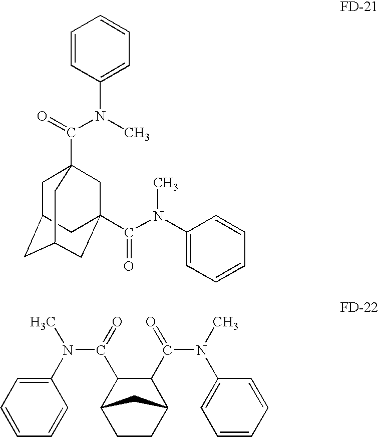

Such a retardation decreasing agent has a function of decreasing the optical anisotropy.

By virtue of containing this compound capable of decreasing the retardation, the optical anisotropy can be satisfactorily decreased using the compound which prevents the polymer in the cellulose acylate film from being oriented in the plane as well as in the thickness direction, so that Re can be made close to zero and Rth can be made negative. It is advantageous that the compound for decreasing the retardation is sufficiently compatibilized with the polymer and the compound itself does not have a rod-like structure or a planar structure. Specifically, when the compound has a plurality of planar functional groups such as aromatic group, a structure having these functional groups not in the same plane but in a nonplanar fashion is advantageous.

The moisture content of the retardation decreasing agent for use in the present invention is preferably 2% or less.

### (LogP Value)

In producing the cellulose acylate film of the present invention, out of the compounds capable of decreasing the retardation by preventing the cellulose acylate in the film from being oriented in the plane as well as in the thickness direction, a compound having an octanol-water partition coefficient (logP value) of 0 to 7 is preferred. A compound having a logP value of 7 or less is preferred in view of high compatibility with cellulose acylate and less production of a white cloudy or chalky film. Also, a compound having a logP value of 0 or more is preferred because the hydrophilicity is not too high and the water resistance of the cellulose acetate film is hardly deteriorated. The logP value is more preferably from 1 to 6, still more preferably from 1.5 to 5.

The octanol-water partition coefficient (logP value) can be measured by the flask-shaking method described in JIS (Japanese Industrial Standards) Z-7260-107 (2000). It is also possible to estimate the octanol-water partition coefficient (logP value) by a computational chemical technique or an empirical method in place of actual measurement. As regards the computation method, for example, the Crippen's fragmentation method (see, J. Chem. Inf. Comput. Sci., 27, 21 (1987)), the Viswanadhan's fragmentation method (see, J. Chem. Inf. Comput. Sci., 29, 163 (1989)), and the Broto's fragmentation method (see, Eur. J. Med. Chem. Chim. Theor., 19, 71 (1984)) are preferred, with the Crippen's fragmentation method (see, J. Chem. Inf. Comput. Sci., 27, 21 (1987)) being more preferred. In the case where the logP value of a certain compound differs depending on the measuring method or the computation method, whether or not the logP value of the compound is in the range of the present invention is preferably judged by the Crippen's fragmentation method.

The cellulose acylate film of the present invention preferably contains at least one compound capable of decreasing the optical anisotropy (retardation decreasing agent) within the range satisfying the following formulae (a) and (b).

(Rth(A)−Rth(0))/A≦−1.0 (a)

0.01≦A≦100 (b)

[wherein Rth(A) is Rth (nm) of a film containing A % of the compound capable of decreasing Rth, Rth(0) is Rth (nm) of a film not containing the compound capable of decreasing Rth, and A is the mass (%) of the compound assuming that the mass in terms of solid content of the polymer is 100].

Formulae (a) and (b) are preferably

(Rth(A)−Rth(0))/A≦−2.0 (a1)

0.05≦A≦50, (b1)

more preferably

(Rth(A)−Rth(0))/A≦−3.0 (a2)

0.1≦A≦20. (b2)

Rth is the value at 590 nm, 25° C. and 60% RH.

### <Wavelength-Dispersion Adjusting Agent>

In the cellulose acylate film of the present invention, the dependency of Re and Rth on the wavelength, that is, the wavelength dispersion, is preferably small. In the present invention, the effective means to decrease the wavelength dispersion is the addition of a compound capable of adjusting the wavelength dispersion (hereinafter sometimes referred to as a “wavelength-dispersion adjusting agent”) to the cellulose acylate film.

The wavelength-dispersion adjusting agent is preferably a compound capable of decreasing the wavelength dispersion ΔRth=|Rth₍₄₀₀₎−Rth₍₇₀₀₎| of Rth, represented by the following formula (c), and the cellulose acylate film of the present invention preferably contains at least one species of this compound within the range satisfying the following formulae (d) and (e).

ΔRth=|Rth₍₄₀₀₎−Rth₍₇₀₀₎| (c)

(ΔRth(B)−ΔRth(0))/B≦−2.0 (d)

0.01≦B≦30 (e)

[wherein ΔRth(B) is ΔRth (nm) of a film containing B % of the compound capable of adjusting the wavelength dispersion of Rth, ΔRth(0) is ΔRth (nm) of a film not containing the compound capable of adjusting the wavelength dispersion of Rth, and B is the mass (%) of the compound assuming that the mass in terms of solid content of the polymer is 100].

Formulae (d) and (e) are preferably

(ΔRth(B)−ΔRth(0))/B≦−3.0 (d1)

0.05≦B≦25, (e1)

more preferably

(ΔRth(B)−ΔRth(0))/B≦−4.0 (d2)

0.1≦B≦20. (e2)

The wavelength-dispersion adjusting agent is preferably a compound having absorption in the ultraviolet region of 200 to 400 nm and decreasing ΔRe=|Re₍₄₀₀₎−Re₍₇₀₀₎| and ΔRth=|Rth₍₄₀₀₎−Rth₍₇₀₀₎| of the film. By virtue of containing at least one species of such a compound, the wavelength dispersion of Re and Rth of the cellulose acylate film can be more effectively adjusted.

The cellulose acylate film generally has wavelength dispersion characteristics such that its Re and Rth values are larger on the long wavelength side than on the short wavelength side. Accordingly, the relatively small Re and Rth on the short wavelength side are required to be made large to thereby smooth the wavelength dispersion. On the other hand, the compound having absorption in the ultraviolet region of 200 to 400 nm has wavelength dispersion characteristics such that the absorbance is larger on the short wavelength side than on the long wavelength side. When this compound itself is isotropically present inside the cellulose acylate film, it is presumed that the birefringence of the compound itself and in turn the wavelength dispersion of Re and Rth are large on the short wavelength side, similarly to the wavelength dispersion of absorbance.

Accordingly, the wavelength dispersion of Re and Rth of the cellulose acylate film can be adjusted using the above-described compound which has absorption in the ultraviolet region of 200 to 400 nm and in which the wavelength dispersion of Re and Rth of the compound itself is presumed to be larger on the shorter wavelength side. For this purpose, the compound capable of adjusting the wavelength dispersion needs to be sufficiently and uniformly compatibilized with the polymer solid content. The absorption band in the ultraviolet region of such a compound is preferably from 200 to 400 nm, more preferably from 220 to 395 nm, still more preferably from 240 to 390 nm.

Recently, in a liquid display device of televisions, notebook-type personal computers, mobile terminals and the like, the optical member used for the liquid crystal display device is required to have excellent transmittance so as to enhance the brightness with a smaller electric power. From this reason, in the case of adding a wave dispersion-adjusting agent to the cellulose acylate film, a compound having excellent spectral transmittance is preferably used. As regards the spectral transmittance of the wavelength-dispersion adjusting agent, the spectral transmittance at a wavelength of 380 nm is preferably from 45 to 95%, and the spectral transmittance at a wavelength of 350 nm is preferably 10% or less.

The wavelength-dispersion adjusting agent is preferably not volatilized during the dope casting and drying in the production of the cellulose acylate film and for this purpose, the molecular weight thereof is preferably from 250 to 1,000, more preferably from 260 to 800, still more preferably from 270 to 800, yet still more preferably from 300 to 800. As long as the molecular weight is in this range, the compound may have a specific monomer structure or may have an oligomer or polymer structure in which a plurality of the monomer units are connected.

The amount of the wavelength-dispersion adjusting agent added is preferably from 0.01 to 30 mass %, more preferably from 0.1 to 20 mass %, still more preferably from 0.2 to 10 mass %, based on the solid content of the polymer.

One of these wavelength-dispersion adjusting agents may be used alone, or two or more compounds may be mixed at an arbitrary ratio and used.

In addition, the moisture content of the wavelength-dispersion adjusting agent is preferably 2% or less.

Specific examples of the wavelength-dispersion adjusting agent which is preferably used in the present invention include a benzotriazole-based compound, a benzophenone-based compound, a cyano group-containing compound, an oxybenzophenone-based compound, a salicylic acid acylate-based compound and a nickel complex salt-based compound, but the present invention is not limited to these compounds.

The benzotriazole-based compound is preferably a compound represented by the following formula (101):

Q¹⁰¹-Q¹⁰²-OH Formula (101):

(wherein Q¹⁰¹ represents a nitrogen-containing aromatic heterocyclic ring, and Q¹⁰² represents an aromatic ring).

Q¹⁰¹ represents a nitrogen-containing aromatic heterocyclic ring and is preferably a 5- to 7-membered nitrogen-containing aromatic heterocyclic ring, more preferably a 5- or 6-membered nitrogen-containing aromatic heterocyclic ring. Examples thereof include imidazole, pyrazole, triazole, tetrazole, thiazole, oxazole, selenazole, benzotriazole, benzothiazole, benzoxazole, benzoselenazole, thiadiazole, oxadiazole, naphthothiazole, naphthoxazole, azabenzimidazole, purine, pyridine, pyrazine, pyrimidine, pyridazine, triazine, triazaindene and tetraazaindene. Among these, still more preferred is a 5-membered nitrogen-containing aromatic heterocyclic ring, specifically, imidazole, pyrazole, triazole, tetrazole, thiazole, oxazole, benzotriazole, benzothiazole, benzoxazole, thiadiazole and oxadiazole, and yet still more preferred is benzotriazole.

The nitrogen-containing aromatic heterocyclic ring represented by Q¹⁰¹ may further has a substituent, and the substituent T described later can be applied as the substituent. Also, when a plurality of substituents are present, these substituents each may be annelated to further form a ring.

The aromatic ring represented by Q¹⁰² is not particularly limited and may be either an aromatic hydrocarbon ring or an aromatic heterocyclic ring but is preferably an aromatic hydrocarbon ring. Also, the aromatic ring may be a monocyclic ring or may further form a condensed ring with another ring.

The aromatic hydrocarbon ring is preferably a monocyclic or dicyclic aromatic hydrocarbon ring having a carbon number of 6 to 30 (e.g., benzene ring, naphthalene), more preferably an aromatic hydrocarbon ring having a carbon number of 6 to 20, still more preferably an aromatic hydrocarbon ring having a carbon number of 6 to 12, yet still more preferably a naphthalene ring or a benzene ring, and most preferably a benzene ring.

The aromatic heterocyclic ring is not particularly limited but is preferably an aromatic heterocyclic ring containing a nitrogen atom or a sulfur atom. Specific examples of the aromatic heterocyclic ring include thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthylidine, quinoxaline, quinazoline, cinnoline, pteridine, acridine, phenanthroline, phenazine, tetrazole, benzimidazole, benzoxazole, benzothiazole, benzotriazole and tetrazaindene. Among these, pyridine, triazine and quinoline are preferred.

Q¹⁰² may further have a substituent, and the following substituent T is preferred.

Examples of the substituent T include an alkyl group (preferably having a carbon number of 1 to 20, more preferably from 1 to 12, still more preferably from 1 to 8, e.g., methyl, ethyl, iso-propyl, tert-butyl, n-octyl, n-decyl, n-hexadecyl, cyclopropyl, cyclopentyl, cyclohexyl), an alkenyl group (preferably having a carbon number of 2 to 20, more preferably from 2 to 12, still more preferably from 2 to 8, e.g., vinyl, allyl, 2-butenyl, 3-pentenyl), an alkynyl group (preferably having a carbon number of 2 to 20, more preferably from 2 to 12, still more preferably from 2 to 8, e.g., propargyl, 3-pentynyl), an aryl group (preferably having a carbon number of 6 to 30, more preferably from 6 to 20, still more preferably from 6 to 12, e.g., phenyl, p-methylphenyl, naphthyl), a substituted or unsubstituted amino group (preferably having a carbon number of 0 to 20, more preferably from 0 to 10, still more preferably from 0 to 6, e.g., amino, methylamino, dimethylamino, diethylamino, dibenzylamino), an alkoxy group (preferably having a carbon number of 1 to 20, more preferably from 1 to 12, still more preferably from 1 to 8, e.g., methoxy, ethoxy, butoxy), an aryloxy group (preferably having a carbon number of 6 to 20, more preferably from 6 to 16, still more preferably from 6 to 12, e.g., phenyloxy, 2-naphthyloxy), an acyl group (preferably having a carbon number of 1 to 20, more preferably from 1 to 16, still more preferably from 1 to 12, e.g., acetyl, benzoyl, formyl, pivaloyl), an alkoxycarbonyl group (preferably having a carbon number of 2 to 20, more preferably from 2 to 16, still more preferably from 2 to 12, e.g., methoxycarbonyl, ethoxycarbonyl), an aryloxycarbonyl group (preferably having a carbon number of 7 to 20, more preferably from 7 to 16, still more preferably from 7 to 10, e.g., phenyloxycarbonyl), an acyloxy group (preferably having a carbon number of 2 to 20, more preferably from 2 to 16, still more preferably from 2 to 10, e.g., acetoxy, benzoyloxy), an acylamino group (preferably having a carbon number of 2 to 20, more preferably from 2 to 16, still more preferably from 2 to 10, e.g., acetylamino, benzoylamino), an alkoxycarbonylamino group (preferably having a carbon number of 2 to 20, more preferably from 2 to 16, still more preferably from 2 to 12, e.g., methoxycarbonylamino), an aryloxycarbonylamino group (preferably having a carbon number of 7 to 20, more preferably from 7 to 16, still more preferably from 7 to 12, e.g., phenyloxycarbonylamino), a sulfonylamino group (preferably having a carbon number of 1 to 20, more preferably from 1 to 16, still more preferably from 1 to 12, e.g., methanesulfonylamino, benzenesulfonylamino), a sulfamoyl group (preferably having a carbon number of 0 to 20, more preferably from 0 to 16, still more preferably from 0 to 12, e.g., sulfamoyl, methylsulfamoyl, dimethylsulfamoyl, phenylsulfamoyl), a carbamoyl group (preferably having a carbon number of 1 to 20, more preferably from 1 to 16, still more preferably from 1 to 12, e.g., carbamoyl, methylcarbamoyl, diethylcarbamoyl, phenylcarbamoyl), an alkylthio group (preferably having a carbon number of 1 to 20, more preferably from 1 to 16, still more preferably from 1 to 12, e.g., methylthio, ethylthio), an arylthio group (preferably having a carbon number of 6 to 20, more preferably from 6 to 16, still more preferably from 6 to 12, e.g., phenylthio), a sulfonyl group (preferably having a carbon number of 1 to 20, more preferably from 1 to 16, still more preferably from 1 to 12, e.g., mesyl, tosyl), a sulfinyl group (preferably having a carbon number of 1 to 20, more preferably from 1 to 16, still more preferably from 1 to 12, e.g., methanesulfinyl, benzenesulfinyl), a ureido group (preferably having a carbon number of 1 to 20, more preferably from 1 to 16, still more preferably from 1 to 12, e.g., ureido, methylureido, phenylureido), a phosphoric acid amide group (preferably having a carbon number of 1 to 20, more preferably from 1 to 16, still more preferably from 1 to 12, e.g., diethylphosphoric acid amide, phenylphosphoric acid amide), a hydroxy group, a mercapto group, a halogen atom (e.g., fluorine, chlorine, bromine, iodine), a cyano group, a sulfo group, a carboxyl group, a nitro group, a hydroxamic acid group, a sulfino group, a hydrazino group, an imino group, a heterocyclic group (preferably having a carbon number of 1 to 30, more preferably from 1 to 12; examples of the heteroatom include a nitrogen atom, an oxygen atom and a sulfur atom; specific examples of the heterocyclic group include imidazolyl, pyridyl, quinolyl, furyl, piperidyl, morpholino, benzoxazolyl, benzimidazolyl and benzothiazolyl), and a silyl group (preferably having a carbon number of 3 to 40, more preferably from 3 to 30, still more preferably from 3 to 24, e.g., trimethylsilyl, triphenylsilyl).

These substituents each may be further substituted. When two or more substituents are present, the substituents may be the same or different and, if possible, may combine with each other to form a ring.

The compound of formula (101) is preferably a compound represented by the following formulae (101-A):

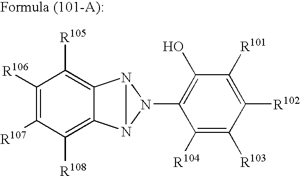

(wherein R¹⁰¹, R¹⁰², R¹⁰³, R¹⁰⁴, R¹⁰⁵, R¹⁰⁶, R¹⁰⁷ and R¹⁰⁸ each independently represents a hydrogen atom or a substituent).

R¹⁰¹, R¹⁰², R¹⁰³, R¹⁰⁴, R¹⁰⁵, R¹⁰⁶, R¹⁰⁷ and R¹⁰⁸ each independently represents a hydrogen atom or a substituent and as regards the substituent, the substituent T described above can be applied as the substituent. The substituents each may be further substituted by another substituent, and the substituents may be annelated with each other to form a ring structure.

R¹⁰¹ and R¹⁰³ each is preferably a hydrogen atom, an alkyl group, an alkenyl group, an alkynyl group, an aryl group, a substituted or unsubstituted amino group, an alkoxy group, an aryloxy group, a hydroxy group or a halogen atom, more preferably a hydrogen atom, an alkyl group, an aryl group, an alkyloxy group, an aryloxy group or a halogen atom, still more preferably a hydrogen atom or an alkyl group having a carbon number of 1 to 12, yet still more preferably an alkyl group having a carbon number of 1 to 12 (preferably a carbon number of 4 to 12).

R¹⁰² and R¹⁰⁴ each is preferably a hydrogen atom, an alkyl group, an alkenyl group, an alkynyl group, an aryl group, a substituted or unsubstituted amino group, an alkoxy group, an aryloxy group, a hydroxy group or a halogen atom, more preferably a hydrogen atom, an alkyl group, an aryl group, an alkyloxy group, an aryloxy group or a halogen atom, still more preferably a hydrogen atom or an alkyl group having a carbon number of 1 to 12, yet still more preferably a hydrogen atom or a methyl group, and most preferably a hydrogen atom.

R¹⁰⁵ and R¹⁰⁸ each is preferably a hydrogen atom, an alkyl group, an alkenyl group, an alkynyl group, an aryl group, a substituted or unsubstituted amino group, an alkoxy group, an aryloxy group, a hydroxy group or a halogen atom, more preferably a hydrogen atom, an alkyl group, an aryl group, an alkyloxy group, an aryloxy group or a halogen atom, still more preferably a hydrogen atom or an alkyl group having a carbon number of 1 to 12, yet still more preferably a hydrogen atom or a methyl group, and most preferably a hydrogen atom.

R¹⁰⁶ and R¹⁰⁷ each is preferably a hydrogen atom, an alkyl group, an alkenyl group, an alkynyl group, an aryl group, a substituted or unsubstituted amino group, an alkoxy group, an aryloxy group, a hydroxy group or a halogen atom, more preferably a hydrogen atom, an alkyl group, an aryl group, an alkyloxy group, an aryloxy group or a halogen atom, still more preferably a hydrogen atom or a halogen atom, yet still more preferably a hydrogen atom or a chlorine atom.

The compound of formula (101) is more preferably a compound represented by the following formula (101-B):

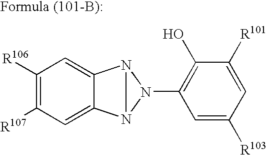

(wherein R¹⁰¹, R¹⁰³, R¹⁰⁶ and R¹⁰⁷ have the same meanings as those in formula (101-A) and preferred ranges are also the same).

Specific examples of the compound represented by formula (101) are set forth below, but the present invention is not limited to these specific examples.

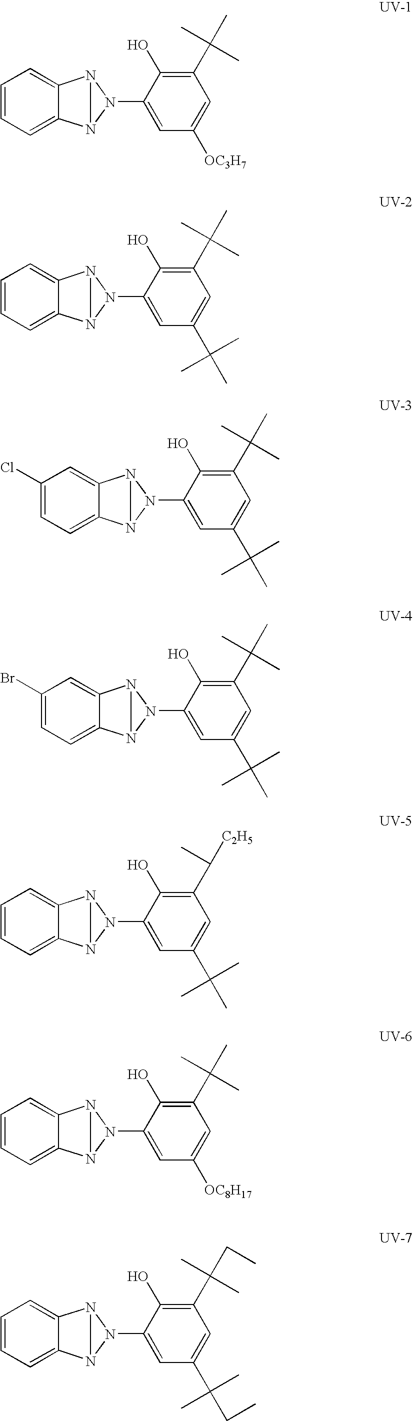

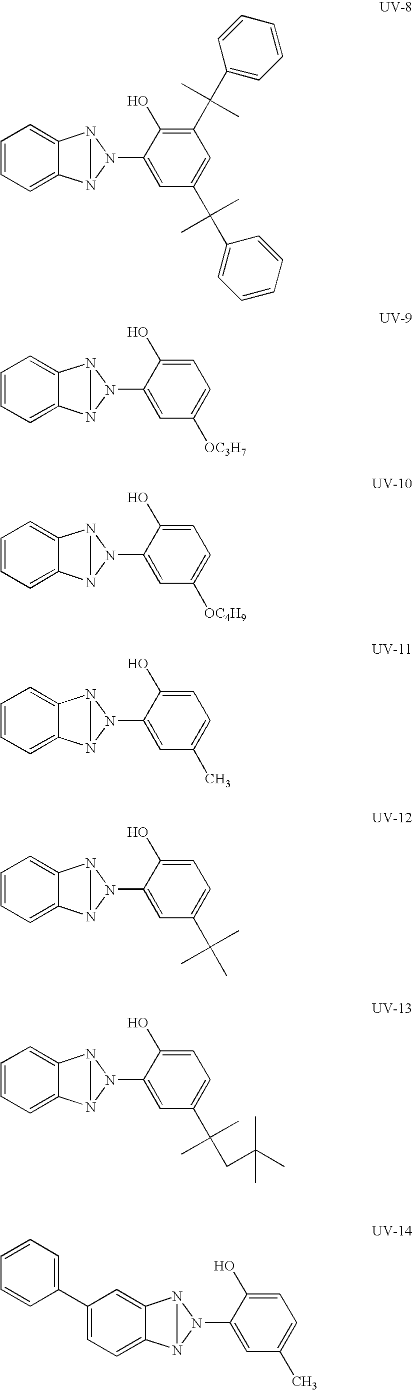

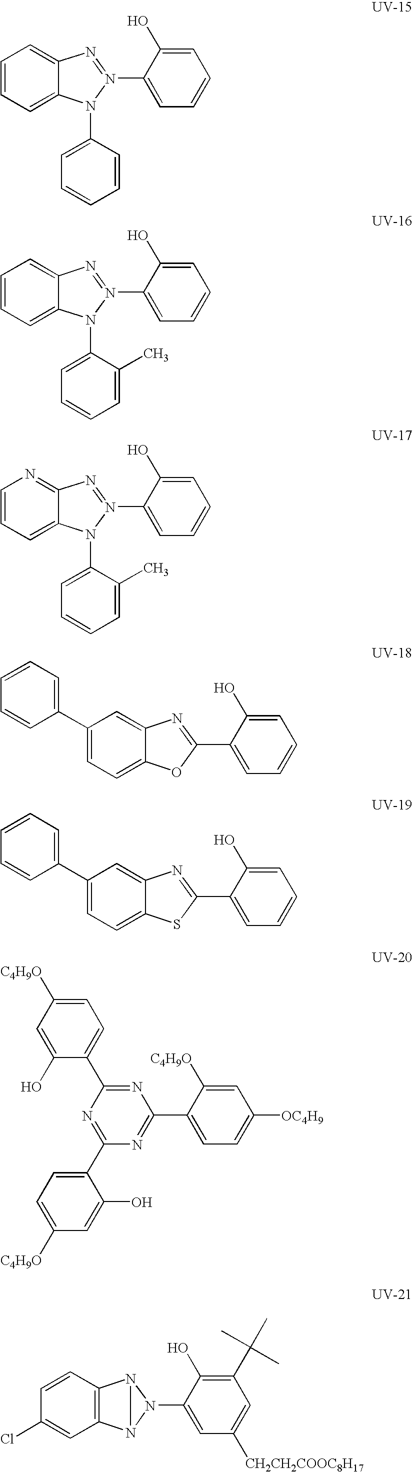

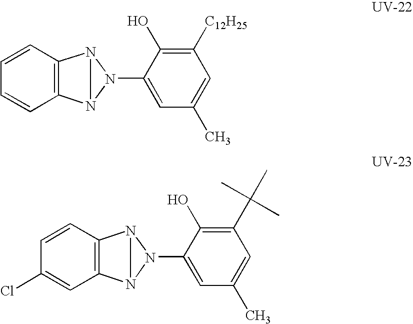

Among these benzotriazole-based compounds, when the cellulose acylate film is produced without containing a compound having a molecular weight of 320 or less, this is advantageous in view of retentivity.

The benzophenone-based compound used as the wavelength-dispersion adjusting agent is preferably a compound represented by the following formula (102):

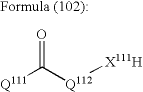

(wherein Q¹¹¹ and Q¹¹² each independently represents an aromatic ring, and X¹¹¹ represents NR¹¹⁰ (R¹¹⁰ represents a hydrogen atom or a substituent), an oxygen atom or a sulfur atom).

The aromatic ring represented by Q¹¹¹ and Q¹¹² may be either an aromatic hydrocarbon ring or an aromatic heterocyclic ring. Also, the aromatic ring may be a monocyclic ring or may form a condensed ring with another ring.

The aromatic hydrocarbon ring represented by Q¹¹¹ and Q¹¹² is preferably a monocyclic or dicyclic aromatic hydrocarbon ring (preferably having a carbon number of 6 to 30) (e.g., benzene rig, naphthalene ring), more preferably an aromatic hydrocarbon ring having a carbon number of 6 to 20, still more preferably an aromatic hydrocarbon ring having a carbon number of 6 to 12, yet still more preferably a benzene ring.

The aromatic heterocyclic ring represented by Q¹¹¹ and Q¹¹² is preferably an aromatic heterocyclic ring containing at least one of an oxygen atom, a nitrogen atom and a sulfur atom. Specific examples of the heterocyclic ring include furan, pyrrole, thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthylidine, quinoxaline, quinazoline, cinnoline, pteridine, acridine, phenanthroline, phenazine, tetrazole, benzimidazole, benzoxazole, benzothiazole, benzotriazole and tetrazaindene. The aromatic heterocyclic ring is preferably pyridine, triazine or quinoline.

The aromatic ring represented by Q¹¹¹ and Q¹¹² is preferably an aromatic hydrocarbon ring, more preferably an aromatic hydrocarbon ring having a carbon number of 6 to 10, still more preferably a substituted or unsubstituted benzene ring.

Q¹¹¹ and Q¹¹² each may further have a substituent and the substituent is preferably the substituent T described above, but a carboxylic acid, a sulfonic acid and a quaternary ammonium salt are not included in the substituent. If possible, the substituents may combine with each other to form a ring structure.

X¹¹¹ represents NR¹¹⁰ (R¹¹⁰ represents a hydrogen atom or a substituent; as for the substituent, the substituent T can be applied), an oxygen atom or a sulfur atom. When X¹¹¹ is NR¹¹⁰, R¹¹⁰ is preferably an acyl group or a sulfonyl group, and these substituents each may be further substituted. X¹¹¹ is preferably NR¹¹⁰ or an oxygen atom, more preferably an oxygen atom.

As regards the substituent T, the same as those in formula (101) can be used.

The compound of formula (102) is preferably a compound represented by the following formula (102-A):

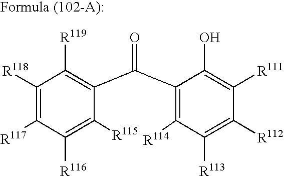

(wherein R¹¹¹, R¹¹², R¹¹³, R¹¹⁴, R¹¹⁵, R¹¹⁶, R¹¹⁷, R¹¹⁸ and R¹¹⁹ each independently represents a hydrogen atom or a substituent).

R¹¹¹, R¹¹², R¹¹³, R¹¹⁴, R¹¹⁵, R¹¹⁶, R¹¹⁷, R¹¹⁸ and R¹¹⁹ each independently represents a hydrogen atom or a substituent and as for the substituent, the substituent T described above can be applied. The substituent may be further substituted by another substituent, and the substituents may be annelated with each other to form a ring structure.

R¹¹¹, R¹¹², R¹¹³, R¹¹⁴, R¹¹⁵, R¹¹⁶, R¹¹⁷, R¹¹⁸ and R¹¹⁹ each is preferably a hydrogen atom, an alkyl group, an alkenyl group, an alkynyl group, an aryl group, a substituted or unsubstituted amino group, an alkoxy group, an aryloxy group, a hydroxy group or a halogen atom, more preferably a hydrogen atom, an alkyl group, an aryl group, an alkyloxy group, an aryloxy group or a halogen atom, still more preferably a hydrogen atom or an alkyl group having a carbon number of 1 to 12, yet still more preferably a hydrogen atom or a methyl group, and most preferably a hydrogen atom.

R¹¹² is preferably a hydrogen atom, an alkyl group, an alkenyl group, an alkynyl group, an aryl group, a substituted or unsubstituted amino group, an alkoxy group, an aryloxy group, a hydroxy group or a halogen atom, more preferably a hydrogen atom, an alkyl group having a carbon number of 1 to 20, an amino group having a carbon number of 0 to 20, an alkoxy group having a carbon number of 1 to 12, an aryloxy group having a carbon number of 6 to 12 or a hydroxy group, still more preferably an alkoxy group having a carbon number of 1 to 20, yet still more preferably an alkoxy group having a carbon number of 1 to 12.

R¹¹⁷ is preferably a hydrogen atom, an alkyl group, an alkenyl group, an alkynyl group, an aryl group, a substituted or unsubstituted amino group, an alkoxy group, an aryloxy group, a hydroxy group or a halogen atom, more preferably a hydrogen atom, an alkyl group having a carbon number of 1 to 20, an amino group having a carbon number of 0 to 20, an alkoxy group having a carbon number of 1 to 12, an aryloxy group having a carbon number of 6 to 12 or a hydroxy group, still more preferably a hydrogen atom or an alkyl group having a carbon number of 1 to 20 (preferably an alkyl group having a carbon number of 1 to 12, more preferably an alkyl group having a carbon number of 1 to 8, still more preferably a methyl group), yet still more preferably a methyl group or a hydrogen atom.

The compound of formula (102) is more preferably a compound represented by the following formula (102-B):

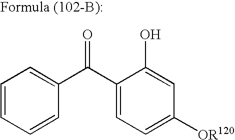

(wherein R¹²⁰ represents a hydrogen atom, a substituted or unsubstituted alkyl group, a substituted or unsubstituted alkenyl group, a substituted or unsubstituted alkynyl group or a substituted or unsubstituted aryl group).

R¹²⁰ represents a hydrogen atom, a substituted or unsubstituted alkyl group, a substituted or unsubstituted alkenyl group, a substituted or unsubstituted alkynyl group or a substituted or unsubstituted aryl group, and as for the substituent, the substituent T described above can be applied.

R¹²⁰ is preferably a substituted or unsubstituted alkyl group, more preferably a substituted or unsubstituted alkyl group having a carbon number of 5 to 20, still more preferably a substituted or unsubstituted alkyl group having a carbon number of 5 to 12 (e.g., n-hexyl, 2-ethylhexyl, n-octyl, n-decyl, n-dodecyl, benzyl), yet still more preferably a substituted or unsubstituted alkyl group having a carbon number of 6 to 12 (e.g., 2-ethylhexyl, n-octyl, n-decyl, n-dodecyl, benzyl).

The compound represented by formula (102) can be synthesized by the method described in JP-A-11-12219.

Specific examples of the compound represented by formula (102) are set forth below, but the present invention is not limited to these specific examples.

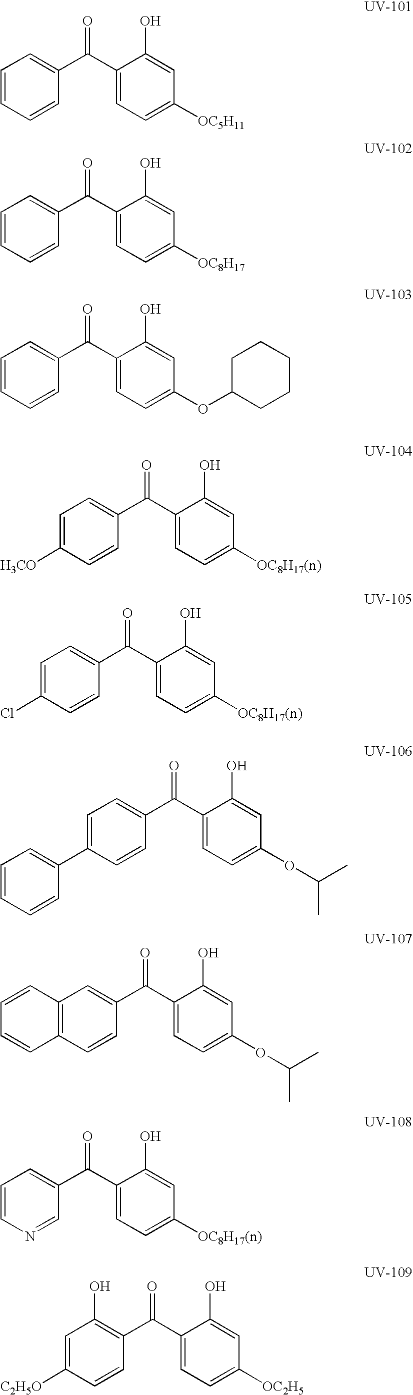

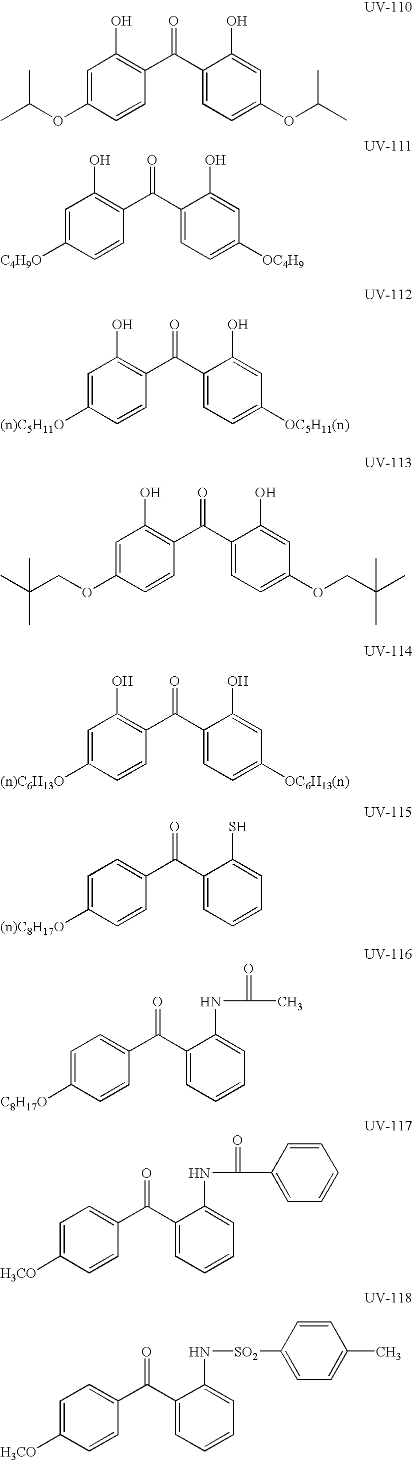

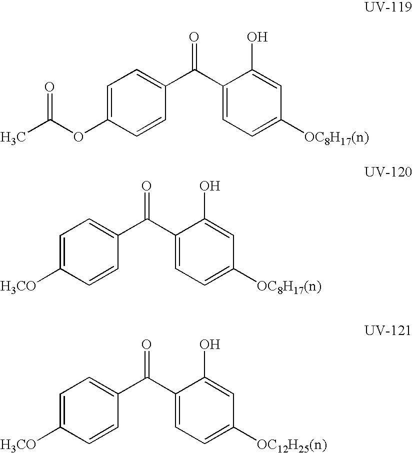

The cyano group-containing compound used as the wavelength-dispersion adjusting agent is preferably a compound represented by the following formula (103):

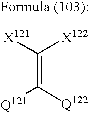

(wherein Q¹²¹ and Q¹²² each independently represents an aromatic ring, X¹²¹ and X¹²² each represents a hydrogen atom or a substituent, and at least either one of X¹²¹ and X¹²² represents a cyano group).

The aromatic ring represented by Q¹²¹ and Q¹²² may be either an aromatic hydrocarbon ring or an aromatic heterocyclic ring. Also, the aromatic ring may be a monocyclic ring or may form a condensed ring with another ring.

The aromatic hydrocarbon ring is preferably a monocyclic or dicyclic aromatic hydrocarbon ring (preferably having a carbon number of 6 to 30) (e.g., benzene rig, naphthalene ring), more preferably an aromatic hydrocarbon ring having a carbon number of 6 to 20, still more preferably an aromatic hydrocarbon ring having a carbon number of 6 to 12, yet still more preferably a benzene ring.

The aromatic heterocyclic ring is preferably an aromatic heterocyclic ring containing a nitrogen atom or a sulfur atom. Specific examples of the heterocyclic ring include thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthylidine, quinoxaline, quinazoline, cinnoline, pteridine, acridine, phenanthroline, phenazine, tetrazole, benzimidazole, benzoxazole, benzothiazole, benzotriazole and tetrazaindene. The aromatic heterocyclic ring is preferably pyridine, triazine or quinoline.

The aromatic ring represented by Q¹²¹ and Q¹²² is preferably an aromatic hydrocarbon ring, more preferably a benzene ring.

Q¹²¹ and Q¹²² each may further have a substituent and the substituent is preferably the substituent T. The substituent T is the same as those in formula (101).

X¹²¹ and X¹²² each represents a hydrogen atom or a substituent, and at least either one of X¹²¹ and X¹²² represents a cyano group. As for the substituent represented by X¹²¹ and X¹²², the substituent T described above can be applied. Also, the substituent represented by X¹²¹ and X¹²² may be further substituted by another substituent, and X¹²¹ and X¹²² each may be annelated to form a ring structure.

X¹²¹ and X¹²² each is preferably a hydrogen atom, an alkyl group, an aryl group, a cyano group, a nitro group, a carbonyl group, a sulfonyl group or an aromatic heterocyclic ring, more preferably a cyano group, a carbonyl group, a sulfonyl group or an aromatic heterocyclic ring, still more preferably a cyano group or a carbonyl group, yet still more preferably a cyano group or an alkoxycarbonyl group (—C(═O)OR′ (R′ is an alkyl group having a carbon number of 1 to 20, an aryl group having a carbon number of 6 to 12 or a combination thereof)).

The compound of formula (103) is preferably a compound represented by the following formula (103-A):

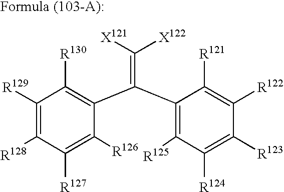

(wherein R¹²¹, R¹²², R¹²³, R¹²⁴, R¹²⁵, R¹²⁶, R¹²⁷, R¹²⁸, R¹²⁹ and R¹³⁰ each independently represents a hydrogen atom or a substituent; and X¹²¹ and X¹²² have the same meanings as those in formula (103) and preferred ranges are also the same).

R¹²¹, R¹²², R¹²³, R¹²⁴, R¹²⁵, R¹²⁶, R¹²⁷, R¹²⁸, R¹²⁹ and R¹³⁰ each independently represents a hydrogen atom or a substituent and as for the substituent, the substituent T described above can be applied. The substituent may be further substituted by another substituent, and the substituents may be annelated with each other to form a ring structure.

R¹²¹, R¹²², R¹²³, R¹²⁴, R¹²⁵, R¹²⁶, R¹²⁷, R¹²⁸, R¹²⁹ and R¹³⁰ each is preferably a hydrogen atom, an alkyl group, an alkenyl group, an alkynyl group, an aryl group, a substituted or unsubstituted amino group, an alkoxy group, an aryloxy group, a hydroxy group or a halogen atom, more preferably a hydrogen atom, an alkyl group, an aryl group, an alkyloxy group, an aryloxy group or a halogen atom, still more preferably a hydrogen atom or an alkyl group having a carbon number of 1 to 12, yet still more preferably a hydrogen atom or a methyl group, and most preferably a hydrogen atom.

R¹²³ and R¹²⁸ each is preferably a hydrogen atom, an alkyl group, an alkenyl group, an alkynyl group, an aryl group, a substituted or unsubstituted amino group, an alkoxy group, an aryloxy group, a hydroxy group or a halogen atom, more preferably a hydrogen atom, an alkyl group having a carbon number of 1 to 20, an amino group having a carbon number of 0 to 20, an alkoxy group having a carbon number of 1 to 12, an aryloxy group having a carbon number of 6 to 12 or a hydroxy group, still more preferably a hydrogen atom, an alkyl group having a carbon number of 1 to 12 or an alkoxy group having a carbon number of 1 to 12, yet still more preferably a hydrogen atom.

The compound of formula (103) is more preferably a compound represented by the following formula (103-B):

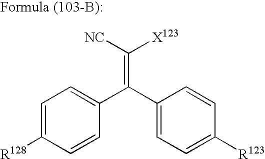

(wherein R¹²³ and R¹²⁸ have the same meaning as those in formula (103-A) and preferred ranges are also the same; and X¹²³ represents a hydrogen atom or a substituent).

X¹²³ represents a hydrogen atom or a substituent and as for the substituent, the substituent T described above can be applied. Also, if possible, the substituent may be substituted by another substituent. X¹²³ is preferably a hydrogen atom, an alkyl group, an aryl group, a cyano group, a nitro group, a carbonyl group, a sulfonyl group or an aromatic heterocyclic ring, more preferably a cyano group, a carbonyl group, a sulfonyl group or an aromatic heterocyclic ring, still more preferably a cyano group or a carbonyl group, yet still more preferably a cyano group or an alkoxycarbonyl group (—C(═O)OR″ (R″ is an alkyl group having a carbon number of 1 to 20, an aryl group having a carbon number of 6 to 12 or a combination thereof)).

The compound of formula (103) is still more preferably a compound represented by formula (103-C):

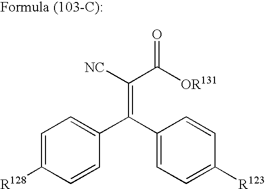

(wherein R¹²³ and R¹²⁸ have the same meanings as those in formula (103-A) and preferred ranges are also the same; and R¹³ represents an alkyl group having a carbon number of 1 to 20).

When R¹²³ and R¹²⁸ both are a hydrogen atom, R¹³ is preferably an alkyl group having a carbon number of 2 to 12, more preferably an alkyl group having a carbon number of 4 to 12, still more preferably an alkyl group having a carbon number of 6 to 12, yet still more preferably an n-octyl group, a tert-octyl group, a 2-ethylhexyl group, an n-decyl group or an n-dodecyl group, and most preferably a 2-ethylhexyl group.

When R¹²³ and R¹²⁸ are not hydrogen, R¹³¹ is preferably an alkyl group having a carbon number 20 or less and causing the compound represented by formula (103-C) to have a molecular weight of 300 or more.

The compound represented by formula (103) can be synthesized by the method described in Journal of American Chemical Society, Vol. 63, page 3452 (1941).

Specific examples of the compound represented by formula (103) are set forth below, but the present invention is not limited to these specific examples.

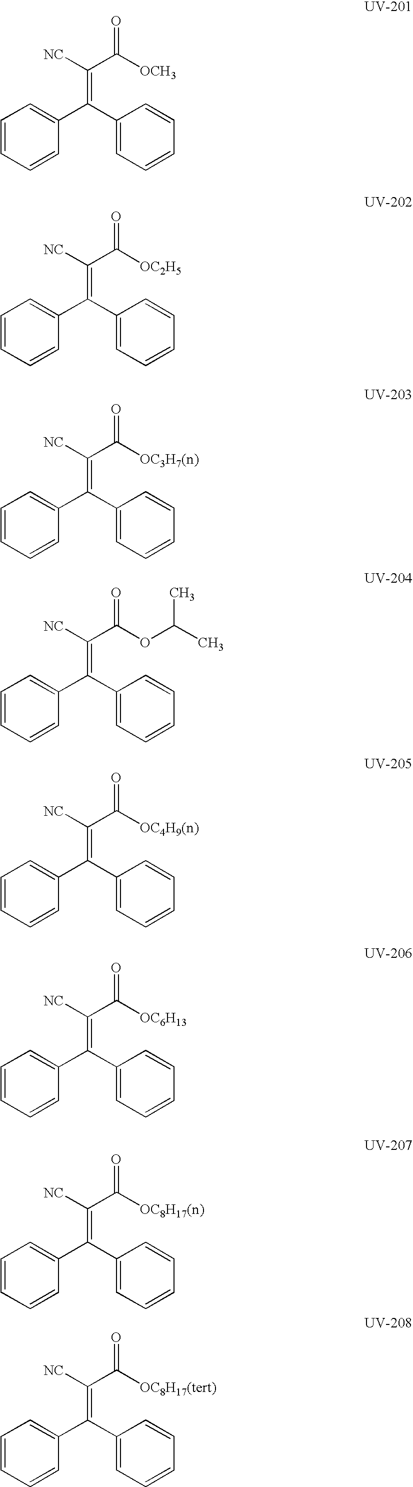

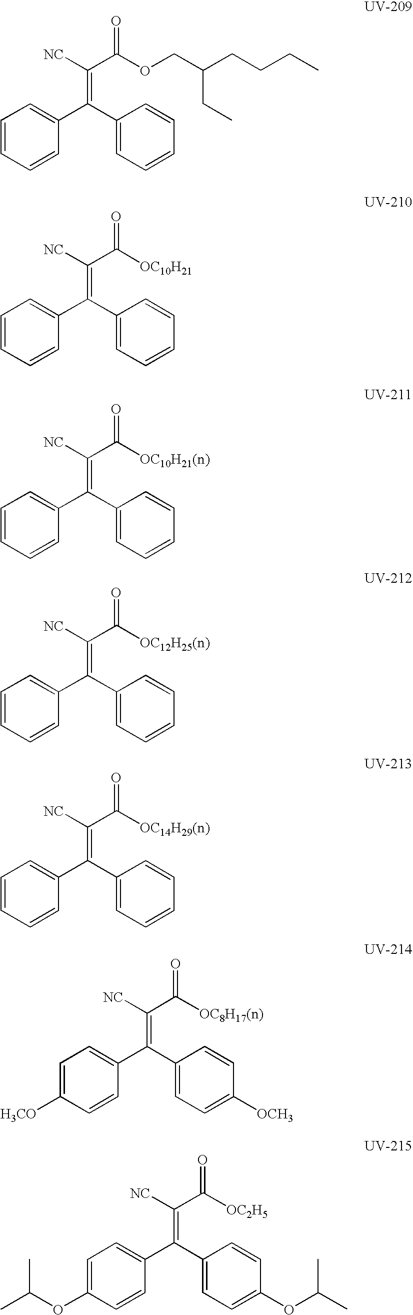

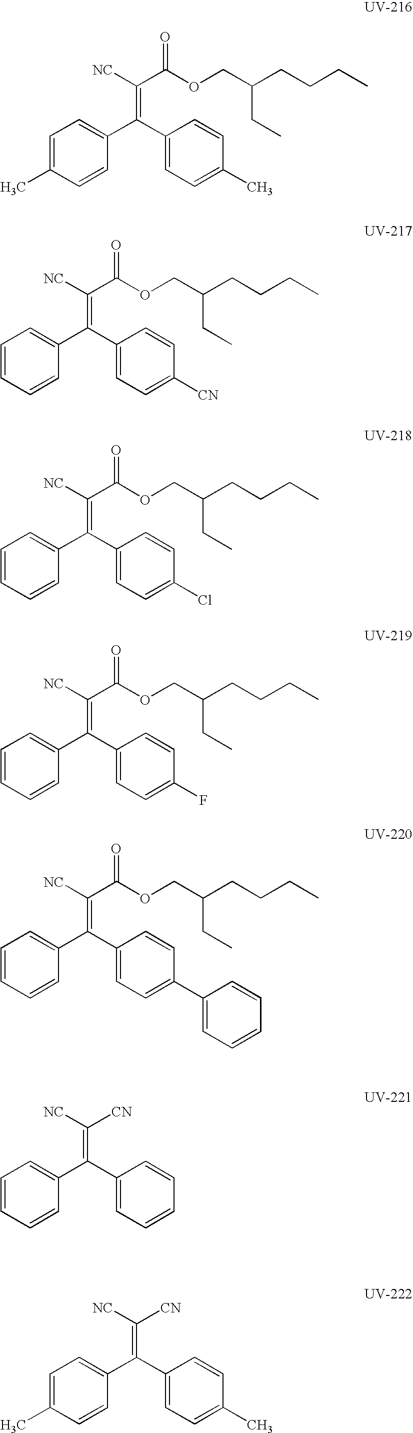

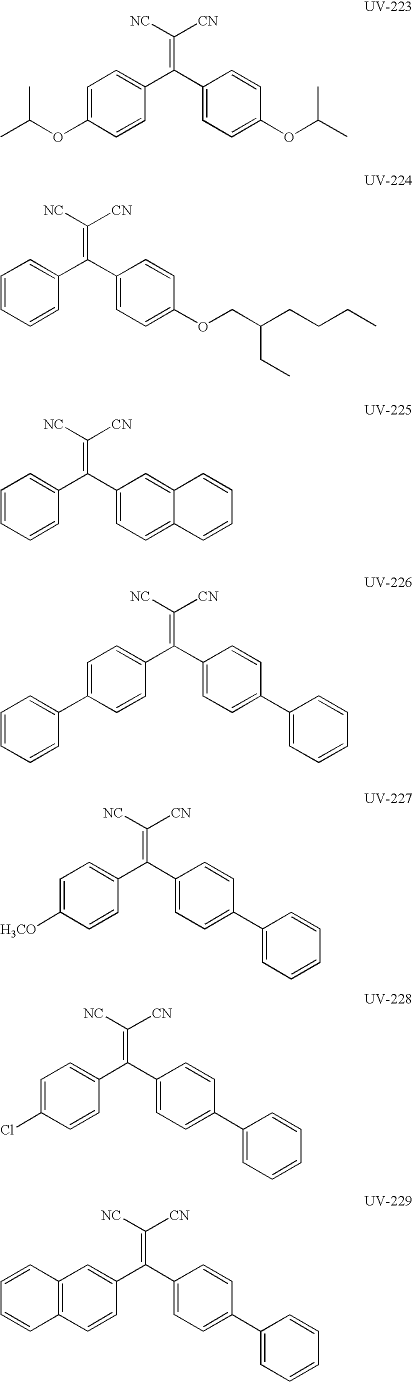

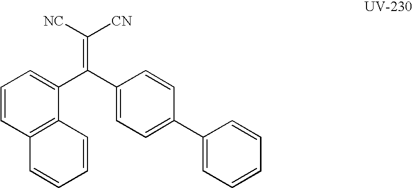

### <Film Properties>

### [Thickness of Film]

The thickness of the cellulose acylate film of the present invention is preferably from 30 to 120 μm and in usage as an optically-compensatory film or a polarizing plate protective film, the thickness is preferably from 40 to 100 μm, more preferably from 60 to 80 μm, still more preferably from 65 to 75 μm.

### [Haze of Film]

The haze of the cellulose acylate film of the present invention is preferably from 0.01 to 2.0%, more preferably from 0.05 to 1.5%, still more preferably from 0.1 to 1.0%. The film transparency as the cellulose acylate film is important. The haze is determined by measuring the cellulose acylate film sample (40 mm×80 mm) of the present invention according to JIS K-6714 by means of a haze meter (HGM-2DP, manufactured by Suga Test Instruments Co., Ltd.) at 25° C. and 60% RH.

### [Curling Property of Film]

The curl value of the cellulose acylate film of the present invention is preferably from −21 to +21/m, more preferably from −15 to +15/m, still more preferably from −10 to +10/m, yet still more preferably from −5 to +5/m, in both the MD direction (casting direction) and the TD direction (width direction) over the entire temperature-humidity condition range from 25° C.-10% RH to 25° C.-80% RH.

The curl of the cellulose acylate film of the present invention is preferably free from change due to temperature or humidity, and it is preferred that the difference (C_{MD,80}−C_{MD,10}) between the curl value C_{MD,80} in the MD direction under 25°-80% RH and the curl value C_{MD,10} in the MD direction under 25°-10% RH is from −14 to +14/m and at the same time, the difference (C_{TD,80}−C_{TD,10}) between the curl value C_{TD,80} in the TD direction under 25°-80% RH and the curl value C_{TD,10} in the TD direction under 25°-10% RH is from −14 to +14/m. The differences (C_{MD,80}−C_{MD,10}) and (C_{TD,80}−C_{TD,10}) both are more preferably from −11 to +11/m, still more preferably from −7 to +7/m, yet still more preferably from −5 to +5/m.

The difference between the curl value at 25° C.-10% RH and the curl value at 45° C.-10% RH is, in both the MD direction and the TD direction, preferably from −19 to +19/m, more preferably from −14 to +14/m, still more preferably from −9 to +9/m. Furthermore, the difference between the curl value at 25° C.-60% RH and the curl value at 45° C.-60% RH and the difference between the curl value at 25° C.-80% RH and the curl value at 45° C.-80% RH are, in both the MD direction and the TD direction, preferably from −19 to +19/m, more preferably from −14 to +14/m, still more preferably from −9 to +9/m.

In the case of laminating the cellulose acylate film of the present invention as a polarizing plate protective film to a polarizing film, particularly, when a lengthy polarizing film and a lengthy cellulose acylate film are effectively laminated or when, for example, the rubbing treatment or the coating of an optically anisotropic layer or various functional layers is performed using a length film at the surface treatment of cellulose acylate film or the coating of an optically anisotropic layer, if the curl value of the cellulose acylate film of the present invention is out of the above-described range, the film comes to have a problem in the handling, and a film breakage trouble may occur. Also, the film strongly contacts with a transportation roll at the edge or center part of the film to readily cause dusting and attachment of foreign matters on the film is increased, as a result, the frequency of frictional scratches, point defects or coating streaks may exceed the tolerance as an optical film such as optically-compensatory film. By setting the curl value in the above-described range, an air bubble can be prevented from entering at the lamination to a polarizing film and the spotted color failure which is liable to occur when an optically anisotropic layer is provided can be decreased.

The curl value can be measured according to the measuring method (ANSI/ASCPH1.29-1985) prescribed by American National Standard Institute.

### [Equilibrium Moisture Content of Film]

As for the equilibrium moisture content of the cellulose acylate film of the present invention, at the time of using the film as the protective film of a polarizing plate, the equilibrium moisture content at 25° C. and 80% RH is preferably 3.0% or less irrespective of the film thickness so as not to impair the adhesive property with a water-soluble polymer such as polyvinyl alcohol. At the time of using the film as the support of an optically-compensatory film, in view of dependency of retardation on the humidity change, the equilibrium moisture content is preferably from 0.1 to 2.5%, more preferably from 1 to 2%.

As for the measuring method of the water content, a cellulose acylate film sample (7 mm×35 mm) of the present invention is measured by the Karl Fischer's method using a water content measuring meter and a sample drying apparatus (CA-03 and VA-05, both manufactured by Mitsubishi Chemical Corp.). The moisture content can be calculated by dividing the water content (g) by the sample mass (g).

### [Moisture Permeability of Film]

The moisture permeability of the cellulose acylate film of the present invention measured under the conditions of a temperature of 60° C. and a humidity of 95% RH according to Japanese Industrial Standards JIS Z0208 is, in terms of moisture permeability with a film thickness of 80 μm, preferably from 100 to 2,000 g/m²-24 hr, more preferably from 200 to 1,200 g/m² 24 hr, still more preferably from 300 to 1,000 g/m²·24 hr. If the moisture permeability exceeds 2,000 g/m² 24 hr, the humidity dependency of Re value and Rth value of the film tends to exceed 0.3 nm/% RH in terms of the absolute value. Also, when an optically anisotropic layer is stacked on the cellulose acylate film of the present invention to produce an optically-compensatory film, the humidity dependency of Re value and Rth value strongly tends to exceed 0.3 nm/% RH in terms of the absolute value and this is not preferred. When such an optically-compensatory film or polarizing plate is incorporated into a liquid crystal display device, change in the tint or decrease of the viewing angle may be caused. On the other hand, if the moisture permeability of the cellulose acylate film is less than 100 g/m²·24 hr, when producing a polarizing plate by laminating the film to both surfaces or the like of a polarizing film, the cellulose acylate film may prevent drying of the adhesive to cause an adhesion failure.

The moisture permeability becomes smaller as the thickness of the cellulose acylate film is larger, and the moisture permeability becomes larger as the film thickness is smaller. Therefore, whatever the sample thickness, the measured moisture permeability needs to be converted by setting the basis to 80 μm. The conversion by thickness can be determined as (80 μm-reduced moisture permeability=measured moisture permeability×measured film thickness (μm)/80 μm).

As for the measuring method of moisture permeability, the methods described in “Measurement of Amount of Water Vapor Permeated (weighing method, thermometer method, water vapor pressure method, adsorption amount method)” of Kobunshi Jikken Koza 4, Kobunshi no Bussei II (Polymer Experiment Lecture 4, Physical Properties II of Polymers), pp. 285-294, Kyoritsu Shuppan, can be applied. Cellulose acylate film samples (70 mmφ) of the present invention are moisture-conditioned for 24 hours at 25° C.-90% RH and at 60° C.-95% RH, respectively, the water content per unit area is calculated (g/m²) according to JIS Z-0208 by a moisture permeability tester (KK-709007, manufactured by Toyo Seiki Seisaku-Sho, Ltd.), and the moisture permeability is determined by (moisture permeability=mass after moisture conditioning−mass before moisture conditioning).

### <Additive of Film>

The cellulose acylate film of the present invention may contain various additives. The additive is not particularly limited as long as the additive is in the range ensuring the desired retardation in a thickness direction. Examples of the additive include, in addition to the above-described retardation decreasing agent (compound capable of decreasing the optical anisotropy) and wavelength-dispersion adjusting agent, other optical property adjusting agents, an ultraviolet inhibitor, a plasticizer, a deterioration inhibitor and a fine particle.

Various additives may be added in respective steps of the production. The timing of adding the additives is not particularly limited. The additives can be added in the step of preparing a polymer solution (hereinafter sometimes referred to as a “dope”). In this case, a step of adding the additives and preparing the dope may be provided as a final step in the dope preparation step.

### [Content of Additive]

The cellulose acylate film of the present invention preferably contains an additive in an amount of 0.3 mass % or more, for example, from 0.3 to 45 mass %, based on the cellulose acylate. By virtue of the additive, various properties of the film, such as optical or physical properties of the resin material, can be adjusted over a wider range than that of a film comprising only the resin material. The content of the additive is more preferably from 5 to 40 mass %, still more preferably from 10 to 30 mass %. As described above, this compound is, for example, an optical anisotropy-decreasing compound, a crosslinked structure-forming compound, a wavelength-dispersion adjusting agent, an ultraviolet inhibitor, a plasticizer, a deterioration inhibitor, a fine particle, a separating agent or an infrared absorbent. The molecular weight thereof is preferably 3,000 or less, more preferably 2,000 or less, still more preferably 1,000 or less. If the total amount of these compounds is less than 0.3 mass %, the properties of the base resin as a single material are liable to predominate and there arises such a problem as that the optical performance or physical strength readily fluctuates due to change in the temperature or humidity. On the other hand, if the total amount of these compounds exceeds 45 mass %, the limit allowing the compound to be compatibilized in the cellulose acylate film is exceeded and a problem such as precipitation on the film surface to cause white clouding of the film (bleeding from the film) is readily brought about.

### [Distribution of Additive in Thickness Direction]

The cellulose acylate film of the present invention preferably contains, as an additive, at least one compound having a molecular weight of 3,000 or less in an amount of 0.3% or more based on the mass of the resin material constituting the cellulose acylate film, and out of the regions formed by dividing the cellulose acylate film into 10 equal parts in the thickness direction, the additive abundance in each of 8 regions except for the outermost layer is preferably from 80 to 120% of the average additive abundance in the entire cellulose acylate film (the value obtained by dividing the entire additive amount in the film by 10). When the additive distribution is uniform in this way, it is considered that the curl value of the cellulose acylate film can be made close to 0 not only under normal temperature-normal humidity, low humidity or high humidity but also under low temperature or high temperature and the fluctuation of curling due to change in humidity or the fluctuation of curling due to change in temperature can be reduced. The additive abundance in each region is more preferably from 85 to 115%, still more preferably from 90 to 110%, based on the average abundance in the film.

The distribution of the additive in the thickness direction can be evaluated using TOF-SIMS IV (Au₁⁺ as primary ion, 25 keV) manufactured by ION-TOF. The additive strength in each of the layers formed by dividing the region from support surface to air surface (surface opposite support surface) at the film casting into 10 equal parts in the thickness direction is calculated, and the distribution is evaluated from the calculated values. In the case of having a plurality of additives, the additive strength is calculated every each additive, the amount of additives contained in the entire film is calculated, and the additive amount in each layer can be evaluated according to its proportion.

### [Separating Agent]

In the resin material, for example, cellulose acylate film for use in the present invention, a separating agent is preferably added so as to reduce the load at the separation.

As for the separating agent, it is effective to use a known surfactant. The surfactant is not particularly limited, and a surfactant such as phosphoric acid type, sulfonic acid type, carboxylic acid type, nonionic type or cationic type may be used. Examples of the surfactant which can be used here include those described in JP-A-61-243837.

As regards the separating agent, JP-A-2003-055501 describes a cellulose acylate solution prepared by dissolving a cellulose acylate in a chlorine-free solvent, where the cellulose acylate solution contains an additive selected from a partially acylated polybasic acid having an acid dissociation index pKA of 1.93 to 4.5, an alkali metal salt and an alkaline earth metal salt and where white clouding of the cellulose acylate solution is prevented and the releasability at the film production and the film surface state are improved.

Incidentally, as regards the additive, JP-A-2003-128838 describes a cellulose acylate dope solution where a crosslinking agent having two or more groups capable of reacting with at least one kind of active hydrogen is contained in an amount of 0.1 to 10 mass % based on the cellulose acylate and where the strippability, surface state and film strength are enhanced.

Furthermore, in JP-A-2003-165868, a film assured of good moisture permeability and excellent dimensional stability by adding an additive is proposed.

In the present invention, the separating agents described in these patent publications can be used.

### [Fine Matting Agent Particle]

In the cellulose acylate film of the present invention, a fine particle is preferably added as a matting agent. Examples of the fine particle for use in the present invention include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. Among these, a fine particle containing silicon is preferred in view of giving low turbidity, and silicon dioxide is more preferred. The fine silicon dioxide particle is preferably a fine particle having an average primary particle diameter of 20 nm or less and an apparent specific gravity of 70 g/liter ore more. The primary particle preferably has an average diameter as small as 5 to 16 nm because the haze of the film can be decreased. The apparent specific gravity is preferably from 90 to 200 g/liter or more, more preferably from 100 to 200 g/liter or more. As the apparent specific gravity is larger, a liquid dispersion having a higher concentration can be prepared and this is preferred in view of haze and aggregate.

Such a fine particle usually forms a secondary particle having an average particle diameter of 0.1 to 3.0 μm and in the film, this particle is present as an aggregate of primary particles to form irregularities of 0.1 to 3.0 μm on the film surface. The average secondary particle diameter is preferably from 0.2 to 1.5 μm, more preferably from 0.4 to 1.2 μm, and most preferably from 0.6 to 1.1 μm. With respect to the primary and secondary particle diameters, particles in the film are observed through a scanning electron microscope, and the diameter of a circle circumscribing a particle is defined as the particle diameter. Also, 200 particles are observed by changing the site and the average value thereof is defined as the average particle diameter.

The fine silicon dioxide particle used may be a commercially available product such as Aerosil R972, R972V, R974, R812, 200, 200V, 300, R202, OX50 and TT600 (all produced by Nihon Aerosil Co., Ltd.). The fine zirconium oxide particle is commercially available under the trade name of, for example, Aerosil R976 or R811 (both produced by Nihon Aerosil Co., Ltd.), and these may be used.

Among these, Aerosil 200V and Aerosil R972V are preferred because these are a fine silicon dioxide particle having an average primary particle diameter of 20 nm or less and an apparent specific gravity of 70 g/liter or more and provide a high effect of decreasing the coefficient of friction while maintaining low turbidity of the cellulose acylate film.

In the present invention, in order to obtain a cellulose acylate film containing a particle having a small average secondary particle diameter, several techniques may be employed at the preparation of a fine particle liquid dispersion. For example, in one method, a solvent and a fine particle are mixed with stirring to previously prepare a fine particle liquid dispersion, the obtained fine particle liquid dispersion is added to a small amount of a separately prepared cellulose acylate solution and then dissolved with stirring, and the resulting solution is further mixed with a main cellulose acylate dope solution. This preparation method is preferred in that good dispersibility of the fine silicone dioxide particle is ensured and re-aggregation of the fine silicon dioxide particle scarcely occurs. In another method, a small amount of a cellulose acylate is added to a solvent and then dissolved with stirring, a fine particle is added thereto and dispersed by a disperser to obtain a fine particle-added solution, and the fine particle-added solution is thoroughly mixed with a dope solution by an in-line mixer. The present invention is not limited to these methods, but at the time of mixing and dispersing the fine silicon dioxide particle with a solvent or the like, the concentration of silicon dioxide is preferably from 5 to 30 mass %, more preferably from 10 to 25 mass %, and most preferably from 15 to 20 mass %. A higher dispersion concentration is preferred because the liquid turbidity for the amount added becomes low and the haze and aggregate are improved. In the final dope solution of cellulose acylate, the amount of the matting agent added is preferably from 0.01 to 1.0 g/m², more preferably from 0.03 to 0.3 g/m², and most preferably from 0.08 to 0.16 g/m².

As for the solvent used here, preferred examples of the lower alcohols include methyl alcohol, ethyl alcohol, propyl alcohol, isopropyl alcohol and butyl alcohol. The solvent other than the lower alcohol is not particularly limited, but the solvent used at the film formation of cellulose acylate is preferably used.

### [Plasticizer, Deterioration Inhibitor]

In addition to the retardation decreasing compound, wavelength-dispersion adjusting agent and the like, various additives (for example, a plasticizer, an ultraviolet inhibitor, a deterioration inhibitor and an infrared absorbent) according to usage may be added to the cellulose acylate film of the present invention in respective preparation steps. This additive may be either a solid matter or an oily product. That is, the melting point or boiling point is not particularly limited. For example, mixing of ultraviolet absorbing materials having a melting point of 20° C. or less and a melting point of 20° C. or more, or similar mixing of plasticizers may be employed and these are described in JP-A-2001-151901 and the like. Also, the infrared absorbing dye is described, for example, in JP-A-2001-194522. The additive can be added at any timing in the dope preparation step, or a step of adding the additive and preparing the dope may be provided as a final preparation step in the dope preparation step. The amount of each material added is not particularly limited as long as its function can be brought out. In the case where the cellulose acylate film is formed from multiple layers, the kind or amount added of the additive may differ among the layers. This is a conventionally well-known technique described, for example, in JP-A-2001-151902. The materials described in detail in JIII Journal of Technical Disclosure, No. 2001-1745, pp. 16-22, Japan Institute of Invention and Innovation (Mar. 15, 2001) are preferably used.

### [Production Method of Cellulose Acylate Film]

### (Production of Cellulose Acylate Solution)

The production method of the cellulose acylate film of the present invention is described below. According to the production method of the present invention, the cellulose acylate film of the present invention can be suitably obtained, but the cellulose acylate film of the present invention is not limited thereto.

The method for producing the cellulose acylate film of the present invention is performed by a solution casting method, and solution casting film-forming methods and apparatuses conventionally employed for the production of a cellulose acetate film can be used.

The cellulose acylate solution (dope) for use in the production of the cellulose acylate film of the present invention is a cellulose acylate solution prepared through a step of mixing and dissolving a cellulose acylate and an organic solvent at 25 to 95° C., a step of cooling the solution to −55 to 20° C., and a step of again dissolving the cooled material under heating at 40 to 115° C. The dope prepared by dissolving a cellulose acylate in a dissolving machine (kettle) is once stored in a storing kettle to remove the bubbles contained in the dope, whereby the dope can be finally prepared.

The dissolved state of cellulose acylate is presumed to be as follows.

After swelling and dissolution at 25 to 95° C., fine crystals are formed by the cooling to facilitate the permeation of the organic solvent, for example, into a site having a small acyl substitution reaction rate and are readily dissolved by the subsequent heating, whereby the dissolved state of cellulose acylate becomes a molecular dispersion state.

By virtue of using the thus-dissolved cellulose acylate solution, the number of foreign matters in the film can be made to fall in the desired range, and the number of casting unevennesses can also be made to fall in the desired range.

As for the preferred dissolution temperature, the temperature at the first heating is more preferably from 30 to 90° C., still more preferably from 40 to 85° C., the cooling temperature is more preferably from −50 to 10° C., still more preferably from −50 to 0° C., and the temperature at the re-heating is more preferably from 40 to 105° C., still more preferably from 45 to 95° C.

In the cellulose acylate for use in the present invention, the raw material cellulose of the cellulose acylate may be derived from either cotton linter or wood pulp. Furthermore, a mixture of cotton linter-derived cellulose and wood pulp-derived cellulose, or a cellulose comprising kenaf or the like other than cotton linter or wool pulp may also be used.

In the dissolving machine, other than the cellulose acylate, a UV absorbent solution, a retardation adjusting agent solution, a wavelength-dispersion adjusting agent, a separating agent solution, a plasticizer solution and the like may be previously mixed.

The thus-prepared dope is delivered from the dope discharge port through a pressure-type quantitative gear pump capable of feeding a liquid in a constant amount with high accuracy, for example, by the rotation number, insoluble matters are removed by filtration, if desired, and the previously prepared matting agent solution, UV absorbent solution, retardation adjusting agent solution, wavelength-dispersion adjusting agent, separating agent solution, plasticizer solution and the like are in-line mixed before the casting die, if desired. The mixing of these additive solutions may be performed in a successive manner.

Each solution prepared, such as cellulose acylate main solution and matting agent solution, is preferably filtered to remove insoluble matters or an aggregate, and the filtration may be performed before the casting die or before the in-line mixing of each additive solution such as matting agent solution. As long as the number of foreign matters can be controlled, one or both of filtration before the casting die and filtration before the in-line mixing are preferably performed.

### [Organic Solvent of Cellulose Acylate Solution]

The organic solvent which is preferably used as a main solvent in the present invention is preferably a solvent selected from an ester, ketone or ether having a carbon number of 3 to 12 and a halogenated hydrocarbon having a carbon number of 1 to 7. The ester, ketone or ether may have a cyclic structure. A compound having two or more functional groups which are any one of ester, ketone and ether functional groups (that is, —O—, —CO— and —COO—), may also be used as a main solvent, and the compound may contain other functional groups such as alcoholic hydroxyl group. In the case of a main solvent having two or more kinds of functional groups, the number of carbon atoms of the solvent may be sufficient if it is in the range prescribed for a compound having any one of those functional groups.

For the cellulose acylate film of the present invention, a chlorine-containing halogenated hydrocarbon may be used as a main solvent or, as described in JIII Journal of Technical Disclosure, No. 2001-1745 (pp. 12-16), a chlorine-free solvent may be used as a main solvent. In this respect, the cellulose acylate film of the present invention is not particularly limited.

Other solvents for the cellulose acylate solution or film of the present invention, including the dissolution method, are described in the following patent publications, and these are preferred embodiments. The solvents are described, for example, in JP-A-2000-95876, JP-A-12-95877, JP-A-10-324774, JP-A-8-152514, JP-A-10-330538, JP-A-9-95538, JP-A-9-95557, JP-A-10-235664, JP-A-12-63534, JP-A-11-21379, JP-A-10-182853, JP-A-10-278056, JP-A-10-279702, JP-A-10-323853, JP-A-10-237186, JP-A-11-60807, JP-A-11-152342, JP-A-11-292988, JP-A-11-60752 and JP-A-11-60752. In these patent publications, not only the solvents preferred for the cellulose acylate of the present invention but also their physical properties and co-existing substances to be present together are described, and these are applicable also in the present invention.

### (Transparency of Dope Solution)

The dope transparency of the cellulose acylate solution of the present invention is preferably 85% or more, more preferably 88% or more, still more preferably 90%, or more. In the present invention, it is confirmed that various additives are sufficiently dissolved in the cellulose acylate dope solution. As regards the specific method for calculating the dope transparency, the dope solution is poured in a 1 cm-square glass cell, and the absorbance at 550 nm is measured using a spectrophotometer (UV-3150, manufactured by Shimadzu Corp.). The absorbance of the solvent alone is previously measured as a blank, and the transparency of the cellulose acylate solution is calculated from the ratio to the absorbance of the blank.

### (Casting)

The method for casting the solution includes, for example, a method of uniformly extruding the prepared dope onto an endless metal support from a pressure die; a method using a doctor blade, where the film thickness of the dope once cast on a metal support is adjusted by means of a blade; and a method using reverse roll coater, where the film thickness is adjusted by means of inversely rotating rolls. Among these, a method using a pressure die method is preferred. The pressure die includes, for example, a coat hunger type die and a T-die type die, and these all can be preferably used. In addition to the above-described methods, various known methods of casting and film-forming a cellulose triacetate solution can be employed, and the same effects as described in respective publications can be obtained by setting the conditions in consideration of difference in the boiling point or the like of the solvent used. As regards the endlessly running metal support for use in the production of the cellulose acylate film of the present invention, an endless band or drum formed of a stainless steel sheet, of which surface is mirror-finished by chromium plating or finished by polishing to a surface roughness of 0.05 μm or less, is used. The surface temperature of the metal support is generally from 0 to 35° C. In the cooling-gelling casting method, the surface temperature is from −50 to 0° C., preferably from −35 to −3° C., more preferably from −25 to −5° C. As for the pressure die used in the production of the cellulose acylate film of the present invention, one unit or two or more units may be provided above the metal support. Use of one or two unit(s) is preferred.

In the case of providing two or more units, the amount of the dope cast may be divided into various proportions among respective dies, or the dope may be fed to dies at respective proportions through a plurality of precision quantitative gear pumps. The temperature of the cellulose acylate solution used for casting is preferably from −10 to 55° C., more preferably from 25 to 50° C. A temperature from 5 to 15° C. lower than the boiling point of the solvent used is preferred. The temperature of the cellulose acylate solution may be the same in all sites of the step or may be different among the sites in the step. In the case where the temperature is different, it may suffice if the temperature is in the above-described range immediately before casting.

An endless metal support having a width of 0.8 to 2.5 m, a length of 5 to 120 m and a thickness of 0.8 to 3.5 mm can be preferably used. The casting width is from 40 cm to 2.3 m, and the moving rate (that is, the casting rate) of the metal support may be from 0.5 to 300 m/min, though this may vary depending on the solid content concentration of dope, the thickness of finished film, the length of endless metal support, the support temperature or the like.

Furthermore, the techniques described in JP-A-2001-129838, JP-A-2000-317960, JP-A-2000-301555, JP-A-2000-301558, JP-A-11-221833, JP-A-07-032391, JP-A-05-185445, JP-A-05-086212, JP-A-03-193316, JP-A-02-276607, JP-A-02-111511, JP-A-02-208650, JP-A-62-037113, JP-A-62-115035, JP-A-55-014201 and JP-A-52-10362 can be applied in the present invention.

### (Multilayer Casting)

The cellulose acylate solution in the form of a single-layer solution may be cast on a smooth band or drum as the metal support, or a plurality of cellulose acylate solutions in two or more layers may be cast. In the case of casting a plurality of cellulose acylate solutions, respective cellulose acylate-containing solutions may be cast from multiple casting ports provided with spacing in the traveling direction of the metal support to produce a film while stacking one on another and, for example, the methods described in JP-A-61-158414, JP-A-1-122419 and JP-A-11-198285 may be applied. Also, cellulose acylate solutions may be cast from two casting ports and film-formed, and this can be practiced by the methods described, for example, in JP-B-60-27562 (the term “JP-B” as used herein means an “examined Japanese patent publication”), JP-A-61-94724, JP-A-61-947245, JP-A-61-104813, JP-A-61-158413 and JP-A-6-134933. In addition, a cellulose acylate film casting method described in JP-A-56-162617, where the flow of a high-viscosity cellulose acylate solution is embraced with a low-viscosity cellulose acylate solution and the high-viscosity and low-viscosity cellulose acylate solutions are simultaneously extruded, may also be used. This casting method is preferred particularly in the cooling-gelling casting method using a high-viscosity solution. A method of incorporating a large amount of an alcohol component as a poor solvent into the solution on the outer side than into the solution on the inner side described in JP-A-61-94724 and JP-A-61-94725 is also a preferred embodiment. Furthermore, the film may also be produced using two casting ports by separating a film cast from a first casting port and formed on a metal support, and performing second casting on the side contacted with the metal support surface, and this method is described, for example, in JP-B-44-20235. The cellulose acylate solutions cast may be the same or different and are not particularly limited. In order to impart a function to the multiple cellulose acylate layers, a cellulose acylate solution according to the function may be extruded from each casting port. The cellulose acylate solution may also be cast simultaneously with other functional layers (for example, an adhesive layer, a dye layer, an antistatic layer, an antihalation layer, a UV absorbing layer and a polarizing layer).

Conventional single-layer solutions have a problem that a high-concentration high-viscosity cellulose acylate solution must be extruded so as to obtain a required film thickness and due to bad stability of the cellulose acylate solution, a solid matter is formed to cause particle failure or defective planarity. For solving this problem, a plurality of cellulose acylate solutions are cast from casting ports, whereby high-viscosity solutions can be simultaneously extruded on the metal support and not only the planarity is enhanced to enable producing a film with excellent surface state but also the drying load can be reduced by virtue of using thick cellulose acylate solutions and the film production speed can be elevated. In the case of co-casting, the layers on the inner and outer sides are not particularly limited in the thickness, but the thickness on the outer side preferably occupies from 1 to 50%, more preferably from 2 to 30%, of the entire film thickness. Here, in the case of co-casting of three or more layers, the total thickness of the layer in contact with the metal support and the layer in contact with the air side is defined as the thickness on the outer side. In the case of co-casting, a cellulose acylate film having a laminate structure may also be produced by co-casting cellulose acylate solutions differing in the concentration of the above-described additive such as retardation adjusting agent, wavelength-dispersion adjusting agent, matting agent, separating agent, plasticizer and ultraviolet absorbent. For example, a cellulose acylate film having a constitution of skin layer/core layer/skin layer can be produced. In this case, for example, the matting agent may be incorporated in a larger amount into the skin layer or may be incorporated only into the skin layer. The plasticizer and ultraviolet absorbent can be incorporated in a larger amount into the core layer than in the skin layer or may be incorporated only into the core layer. The kind of the retardation adjusting agent, wavelength-dispersion adjusting agent, plasticizer or ultraviolet absorbent may be changed between the core layer and the skin layer. For example, a retardation adjusting agent, a wavelength-dispersion adjusting agent, a plasticizer and/or an ultraviolet absorbent each having low volatility may be incorporated into the skin layer, while a retardation adjusting agent, a wavelength-dispersion adjusting agent and a plasticizer each having excellent plasticity and an ultraviolet absorbent having excellent ultraviolet-absorbing property are added to the core layer. It is also a preferred embodiment to incorporate a separating agent only into the skin layer on the metal support side. In addition, an alcohol as a poor solvent may be added in a larger amount into the skin layer than in the core layer and this is preferred for cooling the metal support and thereby gelling the solution in the cooling-gelling casting method. The Tg may differ between the skin layer and the core layer, and the Tg of the core layer is preferably lower than the Tg of the skin layer.

Drying is preferably performed between casting and separation which is described later, such that when the residual solvent amount of the cast film is from 220 to 100 mass % based on the solid content, the average rate of decrease in the residual solvent amount becomes from 0.1 to 20 mass %/sec. Within this range, the surface roughness of the film can have an appropriate value. The average rate of decrease in the residual solvent amount is more preferably from 1 to 18 mass %/sec, still more preferably from 1.2 to 15 mass %/sec, yet still more preferably from 1.5 to 12 mass %/sec.

### (Separation)

The cellulose acylate solution cast on a smooth band or drum as an endless metal support is then gelled by drying or cooling and thereafter, separated from the support.

The time from casting to separation is preferably from 5 to 150 seconds, more preferably from 7 to 135 seconds, still more preferably from 8 to 120 seconds.

### (Cooling-Gelling)

As for the cooling-gelling performed in the present invention, use of the cooling-gelling casting method described in JP-A-62-115035 is preferred because of fast drying and excellent productivity. In this method, the metal support is cooled to 0° C. or less, and the drying is preferably performed by blowing a drying air for 2 seconds or more at a temperature and an air volume each in a level of not causing elevation in the support surface temperature. According to this method, the film is imparted with self-holding property resulting from elevation in the viscosity mainly by cooling or from cooling-gelling, so that even a film having a high residual solvent content can be separated. The residual solvent content at the separation is preferably from 80 to 300%, more preferably from 150 to 280%. The film temperature at the separation is preferably from −50 to 5° C., more preferably from −25 to 0° C. In this method, the time necessary for drying one surface of the support can be shortened and in turn, the total drying time can be greatly shortened, as a result, a large effect of reducing the cost and environmental load is achieved. In the cooling-gelling casting, a drum is used as the metal support in many cases. The liquid film cast can be effectively cooled and gelled by sealing a cooling liquid in the drum. The outer circumference length of the drum is preferably from 2 to 20 m, and the casting rate is preferably from 0.5 to 300 m/min. The casting rate per m of the outer circumference length of the drum is more preferably from 2 to 20 m/min, still more preferably from 5 to 15 m/min.

### (Tenter Drying)

At the time of separating the film from the support, the film is pulled at a speed of 1.01 to 1.4 times the support speed. As the pulling speed ratio is increased, the modulus in the casting direction of the film can be made larger. The separated film is dried with the both ends of the film being held by a width-regulating device (for example, a tenter device) while regulating the shrinkage of the film or stretching the film in the width direction as described, for example, in JP-A-62-115035. The ratio of the film width between the inlet and the outlet of the width-regulating device is preferably from 0.75 to 1.4. When the film is stretched in the width direction, the modulus in the width direction of the film can be made large and this is preferred. The drying is performed by blowing a hot air at 40 to 150° C. It is preferred to divide the inside of the width-regulating device into a plurality of parts and sequentially change the drying air temperature from lower to higher. The drying speed is preferably set such that the average residual solvent decreasing rate in the stretching region becomes from 0.01 to 3 mass %/sec, more preferably from 0.03 to 2 mass %/sec.

### (Drying, Reeling)

After the residual solvent content in the film becomes 20 mass % or less based on the film solid content, the film is preferably detached from the width-regulating device and further dried at a temperature of 100 to 150° C. The film is preferably reeled after cutting off both edge portions deformed through the width-regulating device and knurling both end parts. The knurling has a width of 3 to 50 mm, preferably from 5 to 30 mm, and a height of 0.5 to 500 μm, preferably from 1 to 200 μm. The knurling may be either single pressing or double pressing. The length of the film reeled per one roll is preferably from 100 to 10,000 m, more preferably from 500 to 6,000 m, still more preferably from 1,000 to 4,000 m.

The surface roughness (arithmetic mean roughness of surface concavities and convexities) Ra of a pass roll which the cellulose acylate film of the present invention after the edge portions are cut off contacts is set to be from 0.1 to 10 μm, whereby scratches of the film can be reduced.

### (Polarizing Plate)

The polarizing plate is composed of a polarizer and two transparent protective films disposed on both sides of the polarizer. The cellulose acylate film of the present invention can be used as the transparent protective film. The cellulose acylate film of the present invention may be used on both sides of the polarizer or may be used only on one side. The polarizer includes, for example, an iodine-based polarizer, a dye-based polarizer using a dichromatic dye, and a polyene-based polarizer. The iodine-based polarizer and dye-based polarizer are generally produced using a polyvinyl alcohol-based film. In the case of using the cellulose acylate film of the present invention as the polarizer-protective film, the cellulose acylate film is preferably used on the liquid crystal cell side. The polarizing plate is not particularly limited in its production method and can be produced by a general method. There is known a method where the obtained cellulose acylate film is alkali-treated and with use of an aqueous solution of completely saponified polyvinyl alcohol, the alkali-treated film is laminated to both surfaces of a polarizer obtained by dipping a polyvinyl alcohol film in an iodine solution and stretching it. Instead of the alkali treatment, a process for easy adhesion described in JP-A-6-94915 and JP-A-6-118232 may be applied. Examples of the adhesive used for laminating the treated surface of the protective film to the polarizer include a polyvinyl alcohol-based adhesive such as polyvinyl alcohol and polyvinyl butyral, and a vinyl-based latex such as butyl acrylate. The polarizing plate is composed of a polarizer and polarizer-protective films protecting both surfaces of the polarizer. A polarizing-plate-protective film is further laminated on one surface of the polarizing plate and a separate film on the opposite surface. The polarizing-plate-protective film and separate film are used for the purpose of protecting the polarizing plate, for example, at the shipment of polarizing plate or at the inspection of product. In this case, the protect film is laminated for the purpose of protecting the polarizing plate surface and used on the surface opposite to the surface through which the polarizing plate is laminated to a liquid crystal plate. The separate film is used for the purpose of covering the adhesive layer which adheres to a liquid crystal plate and used on the surface through which the polarizing plate is laminated to a liquid crystal plate.

The method for laminating the cellulose acylate film of the present invention to a polarizer is not particularly limited in the lamination angle with the optical axis of the polarizer. The slow axis of the cellulose acylate film and the transmission axis of the polarizer may be arranged to run in parallel or cross at right angles or may be arranged at an appropriate in-between angle.

In the polarizing plate of the present invention, the single plate transmittance TT, the parallel transmittance PT, the cross transmittance CT and the polarization degree P, at 25° C. and 60% RH, preferably satisfy at least one of the following formulae (A) to (D):

40.0≦TT≦45.0 (A)

30.0≦PT≦40.0 (B)

CT≦2.0 (C)

95.0≦P (D)

The single plate transmittance TT, the parallel transmittance PT and the cross transmittance CT are, in this order, more preferably 40.5≦TT≦45, 32≦PT≦39.5 and CT≦1.5, still more preferably 41.0≦TT≦44.5, 34≦PT≦39.0 and CT≦1.3. The polarizing degree P is preferably 95.0% or more, more preferably 96.0% or more, still more preferably 97.0% or more.

In the polarizing plate of the present invention, assuming that the cross transmittance at a wavelength of X is CT_{(λ)}, the CT₍₃₈₀₎, CT₍₄₁₀₎ and CT₍₇₀₀₎ preferably satisfy at least one of the following formulae (E) to (G):

CT₍₃₈₀₎≦2.0 (E)

CT₍₄₁₀₎≦1.0 (F)

CT₍₇₀₀₎≦0.5 (G)

These are more preferably CT₍₃₈₀₎≦1.95, CT₍₄₁₀₎≦0.9 and CT₍₇₀₀₎≦0.49, still more preferably CT₍₃₈₀₎≦1.90, CT₍₄₁₀₎≦0.8 and CT₍₇₀₀₎≦0.48.

When the polarizing plate of the present invention is left standing still for 500 hours under the conditions of 60° C. and 95% RH, the change amount ΔCT of the cross transmittance and the change amount ΔP of the polarization degree preferably satisfy at least one of the following formulae (J) and (K):

−6.0≦ΔCT≦6.0 (J)

−10.0≦ΔP≦0.0 (K)

(provided that the change amount indicates a value obtained by subtracting the measured value before test from the measured value after test).

These are more preferably −5.8≦ΔCT≦5.8 and −9.5≦ΔP≦0.0, still more preferably −5.6≦ΔCT≦5.6 and −9.0≦ΔP≦0.0.

When the polarizing plate of the present invention is left standing still for 500 hours under the conditions of 60° C. and 90% RH, the change amount ΔCT of the cross transmittance and the change amount ΔP of the polarization degree preferably satisfy at least one of the following formulae (H) and (i):

−3.0≦ΔCT≦3.0 (H)

−5.0≦ΔP≦0.0 (i)

When the polarizing plate of the present invention is left standing still for 500 hours under the condition of 80° C., the change amount ΔCT of the cross transmittance and the change amount ΔP of the polarization degree preferably satisfy at least one of the following formulae (L) and (M):

−3.0≦ΔCT≦3.0 (L)

−2.0≦ΔP≦0.0 (M)

The single plate transmittance TT, parallel transmittance PT and cross transmittance CT of the polarizing plate are measured in the range of 380 to 780 nm by using UV3100PC (manufactured by Shimadzu Corporation), and an average of 10 measurements (an average in the range of 400 to 700 nm) is used for all of TT, PT and CT. The polarizing degree P can be determined according to polarizing degree (%)=100×{(parallel transmittance−cross transmittance)/(parallel transmittance+cross transmittance)}^{1/2}. The endurance test of the polarizing plate is performed as follows in two modes, that is, (1) a polarizing plate alone and (2) a polarizing plate laminated to a glass through a pressure-sensitive adhesive. In the measurement of a polarizing plate alone, polarizing plates are combined such that the cellulose acylate film of the present invention is sandwiched between two polarizers, and two samples having the same crossing are prepared and measured. For the glass lamination mode, the polarizing plate is laminated on a glass such that the cellulose acylate film of the present invention comes to the glass side, and two samples (about 5 cm×5 cm) are prepared. The single plate transmittance is measured by directing the film side of this sample to face the light source. Two samples are measured, and the average of the obtained values is used as the single plate transmittance.

### [Usage (Optically-Compensatory Film)]

The cellulose acylate film of the present invention can be used for various applications and is particularly effective when used as an optically-compensatory film of a liquid crystal display device. Incidentally, the optically-compensatory film indicates an optical material generally used in a liquid crystal display device to compensate for the phase difference and has the same meaning as a retardation plate, an optically-compensatory sheet or the like. The optically-compensatory film has a birefringent property and is used for the purpose of removing the coloring of display screen of a liquid crystal display device or improving the viewing angle properties. The cellulose acylate film of the present invention has low retardation and causes no useless anisotropy and when an optically anisotropic layer having birefringence is used in combination, only the optical performance of the optically anisotropic layer can be expressed.

Accordingly, in the case of using the cellulose acylate film of the present invention as the optically-compensatory film of a liquid crystal display device, Re and Rth of the optically anisotropic layer used in combination are preferably Re₍₅₉₀₎=0 to 20 nm and |Rth₍₅₉₀₎|=0 to 400 nm. Within this range, any optically anisotropic layer may be used. The liquid crystal display device where the cellulose acylate film of the present invention is used is not limited in the optical performance of the liquid cell and the driving system, and any optically anisotropic layer required as an optically-compensatory film may be used in combination. The optically anisotropic layer used in combination may be formed of a composition containing a liquid crystalline compound or may be formed of a polymer film having birefringence.

The liquid crystalline compound is preferably a discotic liquid crystalline compound or a rod-like liquid crystalline compound.

### (Discotic Liquid Crystalline Compound)

Examples of the discotic liquid crystalline compound usable in the present invention include the compounds described in various publications (e.g., C. Destrade et al., Mol. Crysr. Lig. Cryst., Vol. 71, page 111 (1981); Kikan Kagaku Sosetsu (Quarterly Chemistry Survey), No. 22, “Ekisho no Kagaku (The Chemistry of Liquid Crystal)”, Chapter 5 and Chapter 10, Section 2, Nippon Kagaku Kai (compiler) (1994); B. Kohne et al., Angew. Chem. Soc. Chem. Comm., page 1794 (1985); J. Zhang et al., J. Am. Chem. Soc., Vol. 116, page 2655 (1994)).

In the optically anisotropic layer, the discotic liquid crystalline molecules are preferably fixed in an aligned state and most preferably fixed by a polymerization reaction. The polymerization of a discotic liquid crystalline molecule is described in JP-A-8-27284. In order to fix the discotic liquid crystalline molecule by polymerization, a polymerizable group needs to be bonded as a substituent to a discotic core of the discotic liquid crystalline molecule. However, if the polymerizable group is bonded directly to the discotic core, the aligned state can be hardly maintained in the polymerization reaction. Therefore, a linking group is introduced between the discotic core and the polymerizable group. The discotic liquid crystalline molecule having a polymerizable group is disclosed in JP-A-2001-4387.

### (Rod-Like Liquid Crystalline Compound)

Examples of the rod-like liquid crystalline compound usable in the present invention include azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, tolans and alkenylcyclohexylbenzonitriles. Other than these low-molecular liquid crystalline compounds, a polymer liquid crystalline compound may also be used.

In the optically anisotropic layer, the rod-like liquid crystalline molecules are preferably fixed in an aligned state and most preferably fixed by a polymerization reaction. Examples of the polymerizable rod-like liquid crystalline compound usable in the present invention include the compounds described in Makromol. Chem., Vol. 190, page 2255 (1989), Advanced Materials, Vol. 5, page 107 (1993), U.S. Pat. Nos. 4,683,327, 5,622,648 and 5,770,107, International Publication Nos. (WO)95/22586, 95/24455, 97/00600, 98/23580 and 98/52905, JP-A-1-272551, JP-A-6-16616, JP-A-7-110469, JP-A-11-80081 and JP-A-2001-328973.

### (Optically Anisotropic Layer Comprising Polymer Film)

As described above, the optically anisotropic layer may be formed of a polymer film. The polymer film is formed from a polymer capable of expressing optical anisotropy. Examples of such a polymer include a polyolefin (e.g., polyethylene, polypropylene, norbornene-based polymer), a polycarbonate, a polyarylate, a polysulfone, a polyvinyl alcohol, a polymethacrylic acid ester, a polyacrylic acid ester and a cellulose ester (e.g., cellulose triacetate, cellulose diacetate). Also, a copolymer of such a polymer or a mixture of these polymers may be used.

The optical anisotropy of the polymer film is preferably obtained by stretching. The stretching is preferably uniaxial stretching or biaxial stretching. More specifically, longitudinal uniaxial stretching utilizing the peripheral velocity difference of two or more rolls, tenter stretching of stretching the polymer film in the width direction by gripping both sides, or biaxial stretching using these in combination is preferred. It is also possible to use two or more sheets of the polymer film such that the optical property of the entire film comprising two or more sheets of the polymer film satisfies the above-described conditions. The polymer film is preferably produced by a solvent casting method so as to reduce unevenness of the birefringence. The thickness of the polymer film is preferably from 20 to 500 μm, and most preferably from 40 to 100 μm.

### (Constitution Example of Liquid Crystal Display Device)

In the case of using the cellulose acylate film as an optically-compensatory film, the transmission axis of the polarizing element and the slow axis of the optically-compensatory film comprising the cellulose acylate film may be arranged at any angle. The liquid crystal display device comprises a liquid crystal cell carrying a liquid crystal between two electrode substrates and is constituted such that two polarizing elements are disposed on both sides of the liquid crystal cell and at least one optically-compensatory film is disposed between the liquid crystal cell and the polarizing element.

The liquid crystal layer of the liquid crystal cell is usually formed by interposing a spacer between two substrates and enclosing a liquid crystal in the space formed. The transparent electrode layer is formed on the substrate, as a transparent film containing an electrically conducting substance. In the liquid crystal cell, a gas barrier layer, a hardcoat layer and an undercoat layer (used for adhesion of the transparent electrode layer) may be further provided. These layers are usually provided on the substrate. The substrate of the liquid crystal cell generally has a thickness of 50 μm to 2 mm.

### (Kind of Liquid Crystal Display Device)

The cellulose acylate film of the present invention can be used for liquid crystal cells in various display modes. Various display modes such as TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned), ECB (electrically controlled birefringence) and HAN (hybrid aligned nematic) are proposed. A display mode resulting from orientation-dividing the display mode above is also proposed. The cellulose acylate film of the present invention is effective for a liquid crystal display device in any display mode and also effective for any liquid crystal display device of transmission type, reflection type or transflection type.

### (TN-Type Liquid Crystal Display Device)

The cellulose acylate film of the present invention may be used as the support of an optically-compensatory sheet or the protective film of a polarizing plate in a TN-type liquid crystal display device having a TN-mode liquid crystal cell. The TN-mode liquid crystal cell and the TN-type liquid crystal display device are conventionally known. The optically-compensatory sheet for use in the TN-type liquid crystal display device is described in JP-A-3-9325, JP-A-6-148429, JP-A-8-50206, JP-A-9-26572, and the articles by Mori et al. (Jpn. J. Appl. Phys., Vol. 36, page 143 (1997), Jpn. J. Appl. Phys., Vol. 36, page 1068 (1997)).

### (STN-Type Liquid Crystal Display Device)

The cellulose acylate film of the present invention may be used as the support of an optically-compensatory sheet or the protective film of a polarizing plate in an STN-type liquid crystal display device having an STN-mode liquid crystal cell. In the STN-type liquid crystal display device, the rod-like liquid crystalline molecules in the liquid crystal cell are generally twisted in the range from 90 to 360°, and the product (Δnd) of the refractive index anisotropy (Δn) and the cell gap (d) of the rod-like liquid crystalline molecule is from 300 to 1,500 nm. The optically-compensatory sheet for use in the STN-type liquid crystal display device is described in JP-A-2000-105316.

### (VA-Type Liquid Crystal Display Device)

The cellulose acylate film of the present invention is advantageously used particularly as the support of an optically-compensatory sheet or the protective film of a polarizing plate in a VA-type liquid crystal display device having a VA-mode liquid crystal cell. The optically-compensatory sheet for use in the VA-type liquid crystal display device is preferably adjusted to an Re retardation value of 0 to 150 nm and an Rth retardation value of 70 to 400 nm. The Re retardation value is more preferably from 20 to 70 nm. In the case of using two sheets of the optically anisotropic polymer film for the VA-type liquid crystal display device, the Rth retardation value of the film is preferably from 70 to 250 nm. In the case of using one sheet of the optically anisotropic polymer film for the VA-type liquid crystal display device, the Rth retardation value of the film is preferably from 150 to 400 nm. The VA-type liquid crystal display device may employ an orientation-divided system described, for example, in JP-A-10-123576.

### (IPS-Type Liquid Crystal Display Device and ECB-Type Liquid Crystal Display Device)

The cellulose acylate film of the present invention is advantageously used particularly as the support of an optically-compensatory sheet or the protective film of a polarizing plate in an IPS-type liquid crystal display device having an IPS-mode liquid crystal cell and an ECB-type liquid crystal display device having an ECB-mode liquid crystal cell. These modes are a mode of causing the liquid crystal material to be aligned nearly in parallel at the black display time, where the liquid crystal molecules are aligned in parallel to the substrate plane in a voltage-unapplied state to provide black display. In these modes, the polarizing plate using the cellulose acylate film of the present invention contributes to enlargement of the viewing angle and elevation of the contrast. In these modes, the retardation value of the protective film of the polarizing plate and the optically anisotropic layer disposed between the protective layer and the liquid crystal cell is preferably set to 2 times or less the Δn·d value (refractive index difference×thickness) of the liquid crystal layer, and the absolute value |Rth| of the Rth value is preferably set to 25 nm or less, more preferably 20 nm or less, still more preferably 15 nm or less. Therefore, the cellulose acylate film of the present invention is advantageously used.

### (OCB-Type Liquid Crystal Display Device and HAN-type Liquid Crystal Display Device)

The cellulose acylate film of the present invention is also advantageously used as the support of an optically-compensatory sheet or the protective film of a polarizing plate in an OCB-type liquid crystal display device having an OCB-mode liquid crystal cell and an HAN-type liquid crystal display device having an HAN-mode liquid crystal cell. In the optically-compensatory sheet used for the OCB-type liquid crystal display device or HAN-type liquid crystal display device, the direction having a minimum absolute value of retardation is preferably present neither in the plane nor in the normal direction of the optically-compensatory sheet. The optical property of the optically-compensatory sheet used for the OCB-type liquid crystal display device or HAN-type liquid crystal display device is also determined by the optical property of the optically anisotropic layer, the optical property of the support, and the configuration of the optically anisotropic layer and the support. The optically-compensatory sheet for use in the OCB-type liquid crystal display device or HAN-type liquid crystal display device is described in JP-A-9-197397 and the article by Mori et al. (Jpn. J. Appl. Phys., Vol. 38, page 2837 (1999)).

### (Reflective Liquid Crystal Display Device)

The cellulose acylate film of the present invention is also advantageously used as the support of an optically-compensatory sheet or the protective film of a polarizing plate in a TN-type, STN-type, HAN-type or GH (guest-host)-type reflective liquid crystal display device. These display modes have long been well known. The TN-type reflective liquid crystal display device is described in JP-A-10-123478, WO9848320 and Japanese Patent No. 3022477, and the optically-compensatory sheet used for the reflective liquid crystal display device is described in WO00-65384.

### (Other Liquid Crystal Display Devices)

The cellulose acylate film of the present invention is also advantageously used as the support of an optically-compensatory sheet or the protective of a polarizing plate in an ASM-type liquid crystal display device having an ASM (axially symmetric aligned microcell)-mode liquid crystal cell. The ASM-mode liquid crystal cell is characterized in that the thickness of the cell is maintained by a position-adjustable resin spacer. Other properties are the same as those of the TN-mode liquid crystal cell. The ASM-mode liquid crystal cell and the ASM-type liquid crystal display device are described in the article by Kume et al. (Kume et al., SID 98 Digest, 1089 (1998)).

### (Hardcoat Film, Antiglare Film, Antireflection Film)

The cellulose acylate film of the present invention is also preferably applied to a hardcoat film, an antiglare film or an antireflection film. Any one or all of a hardcoat layer, an antiglare layer and an antireflection layer may be provided on one surface or both surfaces of the cellulose acylate film of the present invention so as to enhance the visibility of a flat panel display of LCD, PDP, CRT, EL and the like. Preferred embodiments of these antiglare film and antireflection film are described in detail in JIII Journal of Technical Disclosure, No. 2001-1745, pp. 54-57, Japan Institute of Invention and Innovation (Mar. 15, 2001), and the cellulose acylate film of the present invention can also be preferably used.

### EXAMPLES

The present invention is described in greater detail below by referring to Examples, but the present invention is not limited thereto.

In the present invention, the characteristic evaluation of the cellulose acylate film is performed as follows.

The in-plane retardation value Re and the retardation value Rth in a thickness direction are evaluated after moisture-conditioning the sample (30 mm×40 mm) at 25° C.-60% RH for 2 hours. The Re(590) is measured by making light at a wavelength of 590 nm to be incident in the film normal direction in an automatic birefringence meter KOBRA 21ADH (manufactured by Oji Test Instruments). Also, Rth(590) is calculated by inputting the average refractive index and the film thickness based on the above-described Re(590) and the retardation values measured by making light at a wavelength of 590 nm to be incident while inclining the sample in 100 steps up to 50° from 0° assigned to the film normal direction with the in-plane slow axis being the inclination axis.

The planarity is evaluated by measuring the maximum height (Ry) of surface concavities and convexities of the film based on JIS B0601-1994 and the average distance between surface concavities and convexities by a surface roughness meter.

### Example 1

### (Preparation of Cellulose Acylate Solution)

The composition shown below is charged into a mixing tank and stirred to mix respective components. The mixture is dissolved with stirring at 93° C. for 3 hours. The inside of the tank is cooled to 5° C. at 2° C./min and after 2 hours, heated to 70° C., and the solution is again stirred and then fed to a heat exchanger by a gear pump. This solution is kept at a temperature of 73° C. for 10 minutes, then cooled to 35° C. by the heat exchanger and further filtered through a filter paper having an average pore size of 47 μm. The clogging proceeds slowly. Furthermore, the solution is filtered through a metal mesh filter having a pore size of 10 μm to prepare Cellulose Acetate Solution (LA1), and the obtained solution is stored in a stock tank.

<Composition of Cellulose Acetate Solution (LA1)>

| | | |
|---|---|---|
| Cellulose acylate (derived from cotton | 100 | parts by mass |
| linter, acetyl substitution degree: 2.94 (acyl | | |
| substitution degree: 2.94), viscosity: 6%, | | |
| 343 mPa · s, moisture content: 2.8%) | | |
| Methylene chloride | 433 | parts by mass |
| Ethanol | 75 | parts by mass |
| Compound (A19) capable of decreasing | 12 | parts by mass |
| retardation (purity: 98.0%, moisture | | |
| content: 1.4%) | | |
| Ethyl citrate | 0.003 | parts by mass |

### (Preparation of Matting Agent Solution)

20 Parts by mass of silica particle having an average particle diameter of 16 nm (AEROSIL R972, produced by Nihon Aerosil Co., Ltd.) and 80 parts by mass of methanol are thoroughly mixed with stirring for 30 minutes to prepare a silica particle liquid dispersion. This liquid dispersion is charged into a disperser together with the composition shown below and further stirred for 30 minutes or more to dissolve respective components, and the obtained solution is filtered through a non-woven filter having an average pore size of 20 μm to prepare Matting Agent Solution (LC1).

<Composition of Matting Agent Solution (LC1)>

| | | |
|---|---|---|
| Silica particle liquid dispersion having an | 12.0 | parts by mass |
| average particle diameter of 16 nm | | |
| Methylene chloride | 68.5 | parts by mass |
| Ethanol | 11.8 | parts by mass |
| Cellulose Acylate Solution (LA1) | 11.3 | parts by mass |

### (Preparation of Additive Solution)

A liquid having the following composition is prepared and filtered through a filter paper having an average pore size of 47 μm to prepare Additive Solution (LD1).

<Composition of Additive Solution (LD1)>

| | |
|---|---|
| Wavelength-Dispersion Adjusting Agent | 7.3 parts by mass |
| (UV-102) | |
| Methylene chloride | 55.3 parts by mass |
| Ethanol | 9.5 parts by mass |
| Cellulose Acylate Solution (LA1) | 12.8 parts by mass |

### (Production of Cellulose Acylate Film (F1) of the Present Invention)

76.2 Parts by mass of Cellulose Acylate Solution (LA1), 1.8 parts by mass of Matting Agent Solution (LC1) and 2.6 parts by mass of Additive Solution (LD1) are mixed in a static mixer and uniformly cast on a stainless steel band at a surface temperature of 20° C. At this time, the LA1 solution is stored in a stock tank for 36 hours. The film cast is dried by setting the drying time necessary for reducing the residual solvent amount from 220 mass % to 100 mass % to be 40 seconds until the residual solvent content becomes between 40% and 50%, and the film is then separated from the stainless steel band at a rate of 60 m/min and fixed in a tenter device. The time from casting to separation is 60 seconds. The drying temperature in the tenter device is stepwise changed from 70° C. to 130° C. The drying speed is 0.2 mass %/sec. The film width at the outlet of the tenter device is made 1.01 times the film width at the inlet. The film left from the tenter device is further dried at 130 to 140° C. and reeled at a rate of 62 m/min. In this way, Cellulose Acylate Film (F1) having a thickness of 80 μm is obtained. The surface roughness of the pass roll after edge slitting is 0.3 μm.

The residual solvent amount at the taking up is 0.07%.

The beam transmittance of the film at a wavelength of 590 nm is 91.6%, the surface roughness Ry of the film is 0.6 μm, and the average distance between surface concavities and convexities is 217 μm. The Re(590) retardation in the center of the film is 1.2 nm, and the Rth(590) retardation is −2 nm. The number of foreign matters having a long axis of 50 to 200 μm in the film is 2 when evaluated by sampling 1 m in the casting direction, and the number of foreign matters per m² is 1.4 pieces/m².

### Example 2

### (Preparation of Cellulose Acylate Solution)

The composition shown below is charged into a mixing tank and stirred to mix respective components. The mixture is dissolved with stirring at 33° C. for 6 hours. The inside of the tank is cooled to 5° C. at 2° C./min and after 2 hours, heated to 90° C., and the solution is again stirred and then fed to a heat exchanger by a gear pump. This solution is kept at a temperature of 93° C. for 10 minutes, then cooled to 35° C. by the heat exchanger and further filtered through a filter paper having an average pore size of 47 μm. The clogging proceeds slowly. Furthermore, the solution is filtered through a metal mesh filter having a pore size of 10 μm to prepare Cellulose Acetate Solution (LA2), and the obtained solution is stored in a stock tank.

<Composition of Cellulose Acetate Solution (LA2)>

| | |
|---|---|
| Cellulose acylate (derived from wood pulp, | 100 parts by mass |
| acetyl substitution degree: 2.92 (acyl | |
| substitution degree: 2.92), viscosity: 6%, | |
| 313 mPa · s, moisture content: 2.2%) | |
| Methylene chloride | 438 parts by mass |
| Methanol | 70 parts by mass |
| 1-Butanol | 4 parts by mass |
| Compound (A-19) capable of decreasing | 12 parts by mass |
| retardation (purity: 98.0%, moisture | |
| content: 1.4%) | |
| Ethyl citrate | 0.003 parts by mass |

### (Preparation of Matting Agent Solution)

Matting Agent Solution (LC2) is prepared in the same manner as in Example 1 except for changing the liquid dispersion composition as follows.

<Composition of Matting Agent Solution (LC2)>

| | |
|---|---|
| Silica particle liquid dispersion having an | 12.0 parts by mass |
| average particle diameter of 16 nm | |
| Methylene chloride | 76.6 parts by mass |
| Methanol | 3.7 parts by mass |
| 1-Butanol | 0.8 parts by mass |
| Cellulose Acylate Solution (LA2) | 11.3 parts by mass |

### (Preparation of Additive Solution)

A liquid having the following composition is prepared and filtered through a filter paper having an average pore size of 47 μm to prepare Additive Solution (LD2).

<Composition of Additive Solution (LD2)>

| | |
|---|---|
| Wavelength-Dispersion Adjusting Agent | 7.3 parts by mass |
| (UV-102) | |
| Methylene chloride | 55.2 parts by mass |
| Methanol | 9.6 parts by mass |
| 1-Butanol | 0.6 parts by mass |
| Cellulose Acylate Solution (LA2) | 12.8 parts by mass |

### (Production of Cellulose Acylate Film (F2) of the Present Invention)

76.2 Parts by mass of Cellulose Acylate Solution (LA2), 1.8 parts by mass of Matting Agent Solution (LC2) and 2.6 parts by mass of Additive Solution (LD2) are mixed in a static mixer and uniformly cast on a stainless steel band at a surface temperature of 20° C. At this time, the LA2 solution is stored in a stock tank for 36 hours. The film cast is dried by setting the drying time necessary for reducing the residual solvent amount from 220 mass % to 100 mass % to be 40 seconds until the residual solvent content becomes between 40% and 50%, and the film is then separated from the stainless steel band at a rate of 60 m/min and fixed in a tenter device. The time from casting to separation is 60 seconds. The drying temperature in the tenter device is stepwise changed from 70° C. to 130° C. The drying speed is 0.2 mass %/sec. The film width at the outlet of the tenter device is made 1.01 times the film width at the inlet. The film left from the tenter device is further dried at 130 to 140° C. and reeled at a rate of 62 m/min. In this way, Cellulose Acylate Film (F2) having a thickness of 70 μm is obtained. The surface roughness of the pass roll after edge slitting is 0.3 μm.

The beam transmittance of the film at a wavelength of 590 nm is 92.8%, the surface roughness Ry of the film is 2.6 μm, and the average distance between surface concavities and convexities is 91 μm. The Re retardation in the center of the film is 1.2 nm, and the Rth retardation is −5 nm. The number of film scratches in the film is 1 when evaluated by sampling 1 m in the casting direction, and the number of film scratches per m is 1.0 piece/m.

### Example 3

### (Preparation of Cellulose Acylate Solution)

The composition shown below is charged into a mixing tank and stirred to mix respective components. The mixture is dissolved with stirring at 83° C. for 3 hours. The inside of the tank is cooled to 5° C. at 2° C./min and after 2 hours, heated to 80° C., and the solution is again stirred and then fed to a heat exchanger by a gear pump. This solution is kept at a temperature of 83° C. for 10 minutes, then cooled to 35° C. by the heat exchanger and further filtered through a filter paper having an average pore size of 47 μm. The clogging proceeds slowly. Furthermore, the solution is filtered through a metal mesh filter having a pore size of 10 μm to prepare Cellulose Acetate Solution (LA3), and the obtained solution is stored in a stock tank.

<Composition of Cellulose Acetate Solution (LA3)>

| | |
|---|---|
| Cellulose acylate (derived from cotton | 60 parts by mass |
| linter, acetyl substitution degree: 2.94 (acyl | |
| substitution degree: 2.94), viscosity: 6%, | |
| 343 mPa · s, moisture content: 2.3%) | |
| Cellulose acylate (derived from wood pulp, | 40 parts by mass |
| acetyl substitution degree: 2.91 (acyl | |
| substitution degree: 2.91), viscosity: 6%, | |
| 243 mPa · s, moisture content: 2.5%) | |
| Methylene chloride | 391 parts by mass |
| Methanol | 70 parts by mass |
| 1-Butanol | 15 parts by mass |
| Compound (A-19) capable of decreasing | 12 parts by mass |
| retardation (purity: 98.0%, moisture | |
| content: 1.3%) | |
| Ethyl citrate | 0.003 parts by mass |

### (Preparation of Matting Agent Solution)

Matting Agent Solution (LC3) is prepared in the same manner as in Example 1 except for changing the liquid dispersion composition as follows.

<Composition of Matting Agent Solution (LC3)>

| | |
|---|---|
| Silica particle liquid dispersion having an | 12.0 parts by mass |
| average particle diameter of 16 nm | |
| Methylene chloride | 67.3 parts by mass |
| Methanol | 12.0 parts by mass |
| 1-Butanol | 2.4 parts by mass |
| Cellulose Acylate Solution (LA3) | 11.3 parts by mass |

### (Preparation of Additive Solution)

A liquid having the following composition is prepared and filtered through a filter paper having an average pore size of 47 μm to prepare Additive Solution (LD3).

<Composition of Additive Solution (LD3)>

| | |
|---|---|
| Wavelength-Dispersion Adjusting Agent | 7.3 parts by mass |
| (UV-102) | |
| Methylene chloride | 53.8 parts by mass |
| Methanol | 9.7 parts by mass |
| 1-Butanol | 2.0 parts by mass |
| Cellulose Acylate Solution (LA3) | 12.8 parts by mass |

### (Production of Cellulose Acylate Film (F3) of the Present Invention)

76.2 Parts by mass of Cellulose Acylate Solution (LA3), 1.8 parts by mass of Matting Agent Solution (LC3) and 2.6 parts by mass of Additive Solution (LD3) are mixed in a static mixer and uniformly cast on a stainless steel band at a surface temperature of 20° C. At this time, the LA3 solution is stored in a stock tank for 36 hours. The film cast is dried by setting the drying time necessary for reducing the residual solvent amount from 220 mass % to 100 mass % to be 40 seconds until the residual solvent content becomes between 40% and 50%, and the film is then separated from the stainless steel band at a rate of 60 m/min and fixed in a tenter device. The time from casting to separation is 60 seconds. The drying temperature in the tenter device is stepwise changed from 70° C. to 130° C. The drying speed is 0.2 mass %/sec. The film width at the outlet of the tenter device is made 1.01 times the film width at the inlet. The film left from the tenter device is further dried at 130 to 140° C. and reeled at a rate of 62 m/min. In this way, Cellulose Acylate Film (F3) having a thickness of 61 μm is obtained. The surface roughness of the pass roll after edge slitting is 0.3 μm.

The beam transmittance of the film at a wavelength of 590 nm is 92.2%, the surface roughness Ry of the film is 1.8 μm, and the average distance between surface concavities and convexities is 67 μm. The Re retardation in the center of the film is 1.1 nm, and the Rth retardation is +2 nm. The number of casting unevennesses in the film is 2 when evaluated by sampling 1 m in the casting direction, and the number of casting unevennesses per width of 1 m is 1.4 pieces/m.

### Example 4

### (Preparation of Cellulose Acylate Solution)

The composition shown below is charged into a mixing tank and stirred to mix respective components. The mixture is dissolved with stirring at 92° C. for 3 hours. The inside of the tank is cooled to −10° C. at 3° C./min and after 2 hours, heated to 45° C. for 12 hours, and the solution is again stirred and then fed to a heat exchanger by a gear pump. This solution is kept at a temperature of 48° C., then cooled to 35° C. by the heat exchanger and further filtered through a filter paper having an average pore size of 47 μm. The clogging proceeds slowly. Furthermore, the solution is filtered through a metal mesh filter having a pore size of 10 μm to prepare Cellulose Acetate Solution (LA4), and the obtained solution is stored in a stock tank.

<Composition of Cellulose Acetate Solution (LA4)>

| Cellulose acylate (derived from wood pulp, | 40 parts by mass |
|---|---|
| acetyl substitution degree: 2.88 (acyl | |
| substitution degree: 2.88), viscosity: 6%, | |
| 328 mPa · s, moisture content: 2.7%) | |
| Cellulose acylate (derived from wood pulp, | 60 parts by mass |
| acetyl substitution degree: 2.89 (acyl | |
| substitution degree: 2.89), viscosity: 6%, 95 mPa · | |
| s, moisture content: 2.8%) | |
| Methylene chloride | 391 parts by mass |
| Methanol | 70 parts by mass |
| 1-Butanol | 15 parts by mass |
| Compound (A-19) capable of decreasing | 12 parts by mass |
| retardation (purity: 98%, moisture content: | |
| 1.5%) | |

Matting Agent Solution (LC4) is prepared in the same manner as in Example 1 except for changing the liquid dispersion composition as follows.

<Composition of Matting Agent Solution (LC4)>

| | |
|---|---|
| Silica particle liquid dispersion having an | 12.0 parts by mass |
| average particle diameter of 16 nm | |
| Methylene chloride | 67.3 parts by mass |
| Methanol | 12.0 parts by mass |
| 1-Butanol | 2.4 parts by mass |
| Cellulose Acylate Solution (LA4) | 11.3 parts by mass |

### (Preparation of Additive Solution)

A liquid having the following composition is prepared and filtered through a filter paper having an average pore size of 47 μm to prepare Additive Solution (LD4).

<Composition of Additive Solution (LD4)>

| | |
|---|---|
| Wavelength-Dispersion Adjusting Agent | 7.3 parts by mass |
| (UV-102) | |
| Methylene chloride | 53.8 parts by mass |
| Methanol | 9.7 parts by mass |
| 1-Butanol | 2.0 parts by mass |
| Cellulose Acylate Solution (LA4) | 12.8 parts by mass |

### (Preparation of Mixed Solvent Solution for Dilution)

A liquid having the following composition is prepared and filtered through a filter paper having an average pore size of 44 μm to prepare Mixed Solvent Solution (LE4) for Dilution.

<Composition of Mixed Solvent Solution (LE4) for Dilution>

| | |
|---|---|
| Methylene chloride | 82 parts by mass |
| Methanol | 15 parts by mass |
| 1-Butanol | 3 parts by mass |

### (Production of Cellulose Acylate Film (F4) of the Present Invention)

80 Parts by mass of Cellulose Acylate Solution (LA4) and 2.6 parts by mass of Additive Solution (LD4) are fed and mixed in a static mixer. The resulting mixed solution is fed to a slit in the center part of a pressure die for three-layer stack casting such that the film thickness after drying becomes 49 μm. At the same time, 80 parts by mass of Cellulose Acylate Solution (LA4), 2.4 parts by mass of Matting Agent Solution (LC4), 2.6 parts by mass of Additive Solution (LD4) and 5 parts by mass of Mixed Solvent Solution (LE4) for Dilution are fed and mixed in a static mixer, and the resulting mixed solution is fed to respective slits at both end parts of the pressure die for three-layer stack casting such that the film thickness after drying becomes 3 μm. In this way, a three-layer stack is uniformly cast on a stainless steel band at a surface temperature of 20° C. At this time, the LA4 solutions each is stored in a stock tank for 36 hours. The film cast is dried by setting the drying time necessary for reducing the residual solvent amount from 220 mass % to 100 mass % to be 45 seconds until the residual solvent content becomes between 40% and 50%, and the film is then separated from the stainless steel band at a rate of 60 m/min and fixed in a tenter device. The time from casting to separation is 60 seconds.

The drying temperature in the tenter device is stepwise changed from 70° C. to 130° C. The drying speed is 0.2 mass %/sec. The film width at the outlet of the tenter device is made 1.02 times the film width at the inlet. The film left from the tenter device is further dried at 130 to 140° C. and reeled at a rate of 62 m/min. In this way, Cellulose Acylate Film (F4) having a thickness of 80 μm is obtained. The surface roughness of the pass roll after edge slitting is 0.3 μm.

The beam transmittance of the film at a wavelength of 590 nm is 91.6%, the surface roughness Ry of the film is 2.6 μm, and the average distance between surface concavities and convexities is 9 μm. The Re retardation in the center of the film is 0.3 nm, and the Rth retardation is 1 nm. The number of foreign matters in the film is 6 when evaluated by sampling 1 m in the casting direction, and the number of foreign matters per m² is 4.2 pieces/m². The number of film scratches in the film is 3 when evaluated by sampling 1 m in the casting direction, and the number of film scratches per m is 3 pieces/m.

### Example 5

### (Preparation of Cellulose Acylate Solution)

The composition shown below is charged into a mixing tank and stirred to mix respective components. The mixture is dissolved with stirring at 33° C. for 6 hours. The inside of the tank is cooled to −10° C. at 3° C./min and after 2 hours, heated to 90° C., and the solution is again stirred and then fed to a heat exchanger by a gear pump. This solution is kept at a temperature of 93° C., then cooled to 35° C. by the heat exchanger and further filtered through a filter paper having an average pore size of 47 μm. The clogging proceeds slowly. Furthermore, the solution is filtered through a metal mesh filter having a pore size of 10 μm to prepare Cellulose Acetate Solution (LA5), and the obtained solution is stored in a stock tank.

<Composition of Cellulose Acetate Solution (LA5)>

| | |
|---|---|
| Cellulose acylate (derived from wood pulp, | 70 parts by mass |
| acetyl substitution degree: 2.92 (acyl | |
| substitution degree: 2.92), viscosity: 6%, | |
| 322 mPa · s, moisture content: 3.1%) | |
| Cellulose acylate (derived from wood pulp, | 30 parts by mass |
| acetyl substitution degree: 2.89 (acyl | |
| substitution degree: 2.89), viscosity: 6%, 95 | |
| mPa · s, moisture content: 2.8%) | |
| Methylene chloride | 391 parts by mass |
| Methanol | 70 parts by mass |
| 1-Butanol | 15 parts by mass |
| Compound (A-19) capable of decreasing | 12 parts by mass |
| retardation (purity: 98%, moisture content: 1.5%) | |

### (Production of Cellulose Acylate Film (F5) of the Present Invention)

80 Parts by mass of Cellulose Acylate Solution (LA5) and 2.6 parts by mass of Additive Solution (LD4) are fed and mixed in a static mixer. The resulting mixed solution is fed to a slit in the center part of a pressure die for three-layer stack casting such that the film thickness after drying becomes 79 μm. At the same time, 80 parts by mass of Cellulose Acylate Solution (LA4), 2.4 parts by mass of Matting Agent Solution (LC4), 2.6 parts by mass of Additive Solution (LD4) and 5 parts by mass of Mixed Solvent Solution (LE4) for Dilution are fed and mixed in a static mixer, and the resulting mixed solution is fed to respective slits at both end parts of the pressure die for three-layer stack casting such that the film thickness after drying becomes 3 μm. In this way, a three-layer stack is uniformly cast on a stainless steel band at a surface temperature of 20° C. At this time, the LA5 solutions each is stored in a stock tank for 36 hours. The film cast is dried by setting the drying time necessary for reducing the residual solvent amount from 220 mass % to 100 mass % to be 45 seconds until the residual solvent content becomes between 40% and 50%, and the film is then separated from the stainless steel band at a rate of 60 m/min and fixed in a tenter device. The time from casting to separation is 60 seconds.

The drying temperature in the tenter device is stepwise changed from 70° C. to 130° C. The drying speed is 0.2 mass %/sec. The film width at the outlet of the tenter device is made 1.02 times the film width at the inlet. The film left from the tenter device is further dried at 130 to 140° C. and reeled at a rate of 62 m/min. In this way, Cellulose Acylate Film (F5) having a thickness of 78 μm is obtained. The surface roughness of the pass roll after edge slitting is 0.3 μm.

The beam transmittance of the film at a wavelength of 590 mm is 91.2%, the surface roughness Ry of the film is 2.5 μm, and the average distance between surface concavities and convexities is 8 μm. The Re retardation in the center of the film is 8.5 nm, and the Rth retardation is 22 nm. The number of foreign matters in the film is 1 when evaluated by sampling 1 m in the casting direction, and the number of foreign matters per m² is 0.7 pieces/m². The number of casting unevennesses in the film is 1 when evaluated by sampling 1 m in the casting direction, and the number of casting unevennesses per width of 1 m is 0.7 pieces/m.

### Example 6

The composition shown below is charged into a mixing tank and stirred to mix respective components. The mixture is dissolved with stirring at 80° C. for 6 hours. The inside of the tank is cooled to −50° C. at 5° C./min and after 2 hours, heated to 80° C., and the solution is again stirred and then fed to a heat exchanger by a gear pump. This solution is kept at a temperature of 83° C., then cooled to 35° C. by the heat exchanger and further filtered through a filter paper having an average pore size of 47 μm. The clogging proceeds slowly. Furthermore, the solution is filtered through a metal mesh filter having a pore size of 10 μm to prepare Cellulose Acetate Solution (LA6), and the obtained solution is stored in a stock tank.

<Composition of Cellulose Acetate Solution (LA6)>

| | |
|---|---|
| Cellulose acylate (derived from wood pulp, | 70 parts by mass |
| acetyl substitution degree: 1.96, propionyl | |
| substitution degree: 0.88 (acyl substitution | |
| degree: 2.84), viscosity: 6%, 322 mPa · s, | |
| moisture content: 3.1%) | |
| Cellulose acylate (derived from wood pulp, | 30 parts by mass |
| acetyl substitution degree: 2.89 (acyl | |
| substitution degree: 2.89), viscosity: 6%, 95 | |
| mPa · s, moisture content: 2.8%) | |
| Methylene chloride | 391 parts by mass |
| Methanol | 70 parts by mass |
| 1-Butanol | 15 parts by mass |
| Compound (A19) capable of decreasing | 12 parts by mass |
| retardation (purity: 98%, moisture content: 1.5%) | |

### (Production of Cellulose Acylate Film (F6) of the Present Invention)

80 Parts by mass of Cellulose Acylate Solution (LA6) and 2.6 parts by mass of Additive Solution (LD4) are fed and mixed in a static mixer. The resulting mixed solution is fed to a slit in the center part of a pressure die for three-layer stack casting such that the film thickness after drying becomes 59 μm. At the same time, 80 parts by mass of Cellulose Acylate Solution (LA4), 2.4 parts by mass of Matting Agent Solution (LC4), 2.6 parts by mass of Additive Solution (LD4) and 5 parts by mass of Mixed Solvent Solution (LE4) for Dilution are fed and mixed in a static mixer, and the resulting mixed solution is fed to respective slits at both end parts of the pressure die for three-layer stack casting such that the film thickness after drying becomes 3 μm. In this way, a three-layer stack is uniformly cast on a stainless steel band at a surface temperature of 20° C. At this time, the LA6 solutions each is stored in a stock tank for 36 hours. The film cast is dried by setting the drying time necessary for reducing the residual solvent amount from 220 mass % to 100 mass % to be 45 seconds until the residual solvent content becomes between 40% and 50%, and the film is then separated from the stainless steel band at a rate of 60 m/min and fixed in a tenter device. The time from casting to separation is 60 seconds.

The drying temperature in the tenter device is stepwise changed from 70° C. to 130° C. The drying speed is 0.2 mass %/sec. The film width at the outlet of the tenter device is made 1.02 times the film width at the inlet. The film left from the tenter device is further dried at 130 to 140° C. and reeled at a rate of 62 m/min. In this way, Cellulose Acylate Film (F6) having a thickness of 61 μm is obtained. The surface roughness of the pass roll after edge slitting is 0.3 μm.

The beam transmittance of the film at a wavelength of 590 nm is 91.4%, the surface roughness Ry of the film is 2.7 μm, and the average distance between surface concavities and convexities is 12 μm. The Re retardation in the center of the film is 6.6 nm, and the Rth retardation is 20 nm. The number of foreign matters in the film is 7 when evaluated by sampling 1 m in the casting direction, and the number of foreign matters per m is 5.0 pieces/m². The number of casting unevennesses in the film is 5 when evaluated by sampling 1 m in the casting direction, and the number of casting unevennesses per width of 1 m is 3.5 pieces/m. The number of film scratches in the film is 6 when evaluated by sampling 1 m in the casting direction, and the number of film scratches per m is 6.0 pieces/m.

### Example 7

### (Production of Cellulose Acylate Film (F7) of the Present Invention)

76.2 Parts by mass of Cellulose Acylate Solution (LA1), 1.6 parts by mass of Matting Agent Solution (LC1) and 2.3 parts by mass of Additive Solution (LD1), each prepared in Example 1, are mixed in a static mixer and uniformly cast on a stainless steel drum cooled to −15° C. At this time, the LA1 solution is stored in a stock tank for 36 hours. The film cast is cooled until the liquid temperature reaches about −10° C., and the film is then separated from the drum at 75 m/min and fixed in a tenter device. The drying temperature in the tenter device is stepwise changed from 70° C. to 130° C. The film width at the outlet of the tenter device is made 1.02 times the film width at the inlet. The film left from the tenter device is further dried at 130 to 140° C. and reeled at a rate of 78 m/min. In this way, Cellulose Acylate Film (F7) of the present invention having a thickness of 82 μm is obtained. The residual solvent amount at the taking up is 0.05%.

The beam transmittance of the film at a wavelength of 590 nm is 91.8%, the surface roughness Ry of the film is 0.5 μm, and the average distance between surface concavities and convexities is 111 μm. The Re retardation in the center of the film is 1.3 nm, and the Rth retardation is −3 nm. The number of foreign matters in the film is 3 when evaluated by sampling 1 m in the casting direction, and the number of foreign matters per m² is 2.1 pieces/m². The number of casting unevennesses in the film is 4 when evaluated by sampling 1 m in the casting direction, and the number of casting unevennesses per width of 1 m is 2.8 pieces/m. The number of film scratches in the film is 2 when evaluated by sampling 1 m in the casting direction, and the number of film scratches per m is 1.4 pieces/m.

### Comparative Example 1

### (Preparation of Cellulose Acylate Solution)

The composition shown in Example 1 is charged into a mixing tank and stirred to mix respective components. The mixture is dissolved with stirring at 83° C. for 3 hours. The inside of the tank is cooled to 15° C. at 2° C./min and after 2 hours, heated to 30° C., and the solution is again stirred and then fed to a heat exchanger by a gear pump. This solution is kept at a temperature of 33° C. for 10 minutes, then adjusted to 35° C. by the heat exchanger and further filtered through a filter paper having an average pore size of 47 μm. The clogging proceeds slightly fast. Furthermore, the solution is filtered through a metal mesh filter having a pore size of 10 μm to prepare Cellulose Acetate Solution (LH1), and the obtained solution is stored in a stock tank.

### (Production of Comparative Cellulose Acylate Film (H1))

76.2 Parts by mass of Cellulose Acylate Solution (LH1), 1.8 parts by mass of Matting Agent Solution (LC1) and 2.6 parts by mass of Additive Solution (LD1) are mixed in a static mixer and uniformly cast on a stainless steel band at a surface temperature of 20° C. At this time, the LH1 solution is stored in a stock tank for 36 hours. The film cast is dried by setting the drying time necessary for reducing the residual solvent amount from 220 mass % to 100 mass % to be 5 seconds until the residual solvent content becomes between 40% and 50%, and the film is then separated from the stainless steel band at a rate of 40 m/min and fixed in a tenter device. The time from casting to separation is 20 seconds. The drying temperature in the tenter device is stepwise changed from 70° C. to 130° C. The drying speed is 0.2 mass %/sec. The film width at the outlet of the tenter device is made 1.01 times the film width at the inlet. The film left from the tenter device is further dried at 130 to 140° C. and reeled at a rate of 42 m/min. In this way, Cellulose Acylate Film (H1) having a thickness of 60 μm is obtained. The surface roughness of the pass roll after edge slitting is 0.07 μm.

The beam transmittance of the film at a wavelength of 590 nm is 87.6%, the surface roughness Ry of the film is 3.7 μm, and the average distance between surface concavities and convexities is 0.8 μm. The Re retardation in the center of the film is 3.3 nm, and the Rth retardation is 4.9 nm. The number of foreign matters in the film is 32 when evaluated by sampling 1 m in the casting direction, and the number of foreign matters per m² is 23 pieces/m². The number of casting unevennesses in the film is 16 when evaluated by sampling 1 m in the casting direction, and the number of casting unevennesses per width of 1 m is 11.4 pieces/m. The number of film scratches in the film is 232 when evaluated by sampling 1 m in the casting direction, and the number of film scratches per m is 166 pieces/m.

### Comparative Example 2

The composition shown in Example 1 is charged into a mixing tank and stirred to mix respective components. The mixture is dissolved with stirring at 83° C. for 3 hours. The inside of the tank is cooled to 30° C. at 2° C./min and after 2 hours, the solution is again stirred and then fed to a heat exchanger by a gear pump. This solution is kept at a temperature of 33° C. for 10 minutes, then adjusted to 35° C. by the heat exchanger and further filtered through a filter paper having an average pore size of 47 μm. The clogging proceeds slightly fast. Furthermore, the solution is filtered through a metal mesh filter having a pore size of 10 μm to prepare Cellulose Acetate Solution (LH2), and the obtained solution is stored in a stock tank.

### (Production of Comparative Cellulose Acylate Film (H2))

76.2 Parts by mass of Cellulose Acylate Solution (LH2), 1.8 parts by mass of Matting Agent Solution (LC1) and 2.6 parts by mass of Additive Solution (LD1) are mixed in a static mixer and uniformly cast on a stainless steel band at a surface temperature of 20° C. At this time, the LH1 solution is stored in a stock tank for 36 hours. The film cast is dried by setting the drying time necessary for reducing the residual solvent amount from 220 mass % to 100 mass % to be 5 seconds until the residual solvent content becomes between 40% and 50%, and the film is then separated from the stainless steel band at a rate of 58 m/min and fixed in a tenter device. The time from casting to separation is 40 seconds. The drying temperature in the tenter device is stepwise changed from 70° C. to 130° C. The drying speed is 0.2 mass %/sec. The film width at the outlet of the tenter device is made 1.01 times the film width at the inlet. The film left from the tenter device is further dried at 130 to 140° C. and reeled at a rate of 62 m/min. In this way, Cellulose Acylate Film (H2) having a thickness of 60 μm is obtained. The surface roughness of the pass roll after edge slitting is 30 μm.

The beam transmittance of the film at a wavelength of 590 nm is 86.9%, the surface roughness Ry of the film is 3.8 μm, and the average distance between surface concavities and convexities is 0.9 μm. The Re retardation in the center of the film is 2.6 nm, and the Rth retardation is 4.2 nm. The number of foreign matters in the film is 35 when evaluated by sampling 1 m in the casting direction, and the number of foreign matters per m² is 25 pieces/m². The number of casting unevennesses in the film is 18 when evaluated by sampling 1 m in the casting direction, and the number of casting unevennesses per width of 1 m is 12.9 pieces/m. The number of film scratches in the film is 51 when evaluated by sampling 1 m in the casting direction, and the number of film scratches per m is 36 pieces/m.

### Example 8

### (Production of Optically-Compensatory Film)

### (Production of Undercoat Layer)

A coating solution having the following composition is coated on the cellulose acylate film support of Example 1 to a coverage of 28 cm³/m² and dried to provide a 0.1 μm-thick gelatin layer (first undercoat layer).

Composition of Coating Solution for First Undercoat Layer

| | |
|---|---|
| Gelatin | 0.542 parts by mass |
| Formaldehyde | 0.136 parts by mass |
| Salicylic acid | 0.160 parts by mass |
| Acetone | 39.1 parts by mass |
| Methanol | 15.8 parts by mass |
| Methylene chloride | 40.6 parts by mass |
| Water | 1.2 parts by mass |

Subsequently, a coating composition having the following composition is further coated thereon to a coverage of 7 cm³/m² and dried to provide a second undercoat layer.

Composition of Coating Solution for Second Undercoat Layer

| | | |
|---|---|---|
| Anionic copolymer shown below | 0.079 | part by mass |
| Monoethyl citrate | 1.01 | parts by mass |
| Acetone | 20 | parts by mass |
| Methanol | 87.7 | parts by mass |
| Water | 4.05 | parts by mass |

### Anionic Copolymer:

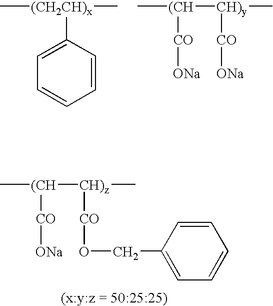

### (Production of Orientation Film Layer)

On this gelatin layer of the cellulose acetate film, a coating solution having the following composition is coated by a #16 wire bar coater to a coverage of 28 ml/m², dried at 25° C. for 60 seconds and then dried with hot air at 60° C. for 60 seconds and further with hot air at 90° C. for 150 seconds.

The thickness of the orientation film after drying is 1.1 μm.

Subsequently, a rubbing treatment is applied to the formed film in the slow axis (measured at a wavelength of 632.8 nm) direction of the cellulose acetate film.

Composition of Coating Solution for Orientation Film

| | | |
|---|---|---|
| Modified polyvinyl alcohol shown below | 20 | parts by mass |
| Water | 361 | parts by mass |
| Methanol | 119 | parts by mass |
| Glutaraldehyde (crosslinking agent) | 0.5 | parts by mass |

### Modified Polyvinyl Alcohol:

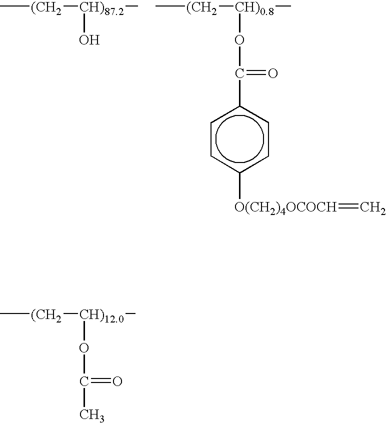

### (Formation of Optically Anisotropic Layer)

On the orientation film, a solution obtained by dissolving 41.01 g of the discotic (liquid crystalline) compound shown below, 4.06 g of an ethylene oxide-modified trimethylolpropane triacrylate (V#360, produced by Osaka Organic Chemical Industry Ltd.), 0.90 g of a cellulose acetate butyrate (CAB551-0.2, produced by Eastman Chemical), 0.23 g of a cellulose acetate butyrate (CAB531-1, produced by Eastman Chemical), 1.35 g of a photopolymerization initiator (Irgacure 907, produced by Ciba Geigy) and 0.45 g of a sensitizer (Kayacure DETX, produced by Nippon Kayaku Co., Ltd.) in 102 g of methyl ethyl ketone is coated by a #4 wire bar. This coating is laminated on a metal frame, heated in a constant-temperature bath at 130° C. for 2 minutes to align the discotic liquid compound, irradiated with UV for 1 minute by using a high-pressure mercury lamp of 120 W/cm at 130° C. to polymerize the discotic compound, and then allowed to cool to room temperature, thereby forming an optically anisotropic layer. In this way, Optically-Compensatory Film (KHF1) is produced.

The Re retardation value of the optically anisotropic layer measured at a wavelength of 633 nm is 48 nm, and the angle (tilt angle) between the discotic plane and the first transparent support plane is 42° on average.

### Discotic Liquid Crystalline Compound:

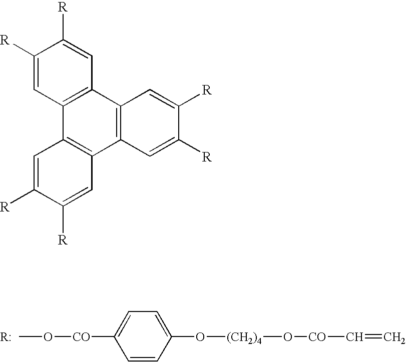

When the number of orientation defects is observed using a loupe at a magnification of 100, the number of defects of 50 μm or more is 1.3 pieces/m². By virtue of Cellulose Acylate Film (F1) used in this Example having a surface roughness Ry of 0.6 μm and an average distance between surface concavities and convexities of 217 μm, an optically-compensatory film with a small number of orientation defects can be obtained.

Optically-Compensatory Films (KHF2) to (KHF7) are produced in the same manner using Cellulose Acylate Films (F2) to (F7), respectively, produced in Examples 2 to 7. The optically-compensatory film using the cellulose acylate film of the present invention has a desired surface roughness and a desired average distance between surface concavities and convexities and therefore, an optically-compensatory film with a small number of orientation defects can be obtained.

### Comparative Example 3

Optically-Compensatory Films (KHFH1) and (KHFH2) are produced according to the method described in Example 8, where the optically anisotropic layer is formed using Cellulose Acylate Films (H1) and (H2) produced in Comparative Examples 1 and 2 in place of the cellulose acylate film of the present invention used in Example 8. The Re retardation value of the optically anisotropic layer is 48 nm, and the angle (tilt angle) between the discotic plane and the first transparent support plane is 42° on average, which are the same as those in Example 8.

However, when the number of orientation defects is observed by the same method as in Example 8, the number of defects of 50 μm or more is as large as 20.3 pieces/m² or 24.7 pieces/m². It is seen that a good optically-compensatory film with a small number of orientation defects cannot be obtained from a cellulose acylate film having large surface roughness and narrow average distance between surface concavities and convexities.

### Example 9

### (Production of Polarizing Plate)

Cellulose Acylate Film (F1) of the present invention obtained in Example 1 is dipped in an aqueous 1.5 N sodium hydroxide solution at 55° C. for 2 minutes, then washed in a water-washing bath at room temperature, and neutralized using 0.1 N sulfuric acid at 30° C. The film is again washed in a water-washing bath at room temperature and then dried with hot air at 100° C. In this way, Surface-Saponified Cellulose Acylate Film (F11) is obtained. A surface saponification treatment is applied in the same manner to a commercially available cellulose acetate film TD80UF (produced by Fuji Photo Film Co., Ltd.) to prepare Film (F100).

Subsequently, a 80 μm-thick polyvinyl alcohol film in a roll form is continuously stretched to 5 times in an aqueous iodine solution and dried to obtain a polarizing film. Film (F11) and Film (F100) are laminated as a protective film on one surface of the polarizing film and on the opposite surface, respectively, by using an aqueous 3% polyvinyl alcohol (PVA-117H, produced by Kuraray Co., Ltd.) solution as the adhesive, whereby Polarizing Plate (P1) is obtained. At this time, Film (F11) and Film (F100) are laminated such that their slow axis runs in parallel to the transmission axis of the polarizing film.

Also, Polarizing Plates (P2) to (P7) and Polarizing Plates (PH1) and (PH2) are produced in the same manner by using, respectively, Cellulose Acylate Films (F2) to (F7) produced in Examples 2 to 7 of the present invention and Cellulose Acylate Films (H1) and (H2) produced in Comparative Examples 1 and 2. Both the cellulose acylate film of the present invention and the cellulose acylate film of Comparative Examples have good lamination property to the stretched polyvinyl alcohol and exhibit excellent suitability for processing into a polarizing plate.

### Example 10

### (Incorporation into Liquid Crystal Display Device)

### <Production of Opposed Polarizing Plate>

Polarizing Plate (P0) is produced in the same manner as in Example 9 except that a commercially available cellulose acetate film (FUJITAC TD80UF (produced by Fuji Photo Film Co., Ltd.)) (F0) subjected to saponification is used for both films laminated to both surfaces of the polarizing film.

### <Production of IPS-Mode Liquid Crystal Cell>

Electrodes are provided on one glass substrate such that the distance between adjacent electrodes becomes 20 μm, and a polyimide film is provided thereon as an orientation film and subjected to a rubbing treatment. Separately, one glass substrate is prepared, and a polyimide film is provided on one surface thereof and subjected to a rubbing treatment to serve as an orientation film. These two glass substrates are laid one on another and laminated such that the orientation films face each other, a gap (d) of 3.9 μm is created between substrates, and the rubbing directions of two glass substrates run in parallel. Subsequently, a nematic liquid crystal composition having a refractive index anisotropy (Δn) of 0.0769 and a positive dielectric constant anisotropy (Δε) of 4.5 is enclosed in the gap. The d·Δn value of the liquid crystal layer is 300 nm.

On the backlight side of the produced IPS-mode liquid crystal cell, Polarizing Plate P1 of the present invention prepared in Example 9 is laminated by allowing its absorption axis to run in parallel with the rubbing direction of the liquid crystal cell and at the same time, arranging Cellulose Acylate Film (F1) of the present invention to come on the liquid crystal cell side. Subsequently, Polarizing Plate P0 is laminated to another side of the IPS-mode liquid crystal cell in the cross-Nicol arrangement.

The black tint of the thus-produced liquid crystal display is observed in all azimuthal angle directions at a polar angle of 600, but a tint change is scarcely perceived. In addition, the film is assured of excellent viewing angle in right/left and up/down directions. Also, a pictorial quality failure due to film foreign matters, film scratches and casting unevennesses is not recognized. In this way, the cellulose acylate film of the present invention is proved to be an excellent film for optical usage.

Liquid crystal display devices are produced in the same manner by using Polarizing Plates (P2) to (P7) and Polarizing Plates (PH1) and (PH2) and evaluated. Good results are obtained in all of the liquid crystal display devices using Polarizing Plates (P2) to (P7).

### Comparative Example 4

IPS-Mode liquid crystal display devices are produced in the same manner as in Example 10 by using Polarizing Plates PH1 and PH2 where Cellulose Acylate Films (H1) and (H2) produced in Comparative Examples 1 and 2 are used. The black tint of the thus-produced liquid crystal display is observed in all azimuthal angle directions at a polar angle of 600, but a tint change is scarcely perceived. In addition, the film is assured of excellent viewing angle in right/left and up/down directions. However, an abnormal bright point considered ascribable to the film foreign matter is generated in 8 units out of 100 units of the liquid crystal display device using PH1 and in 4 units out of 100 units of the liquid crystal display device using PH2. Also, screen unevenness ascribable to the casting unevenness is generated in 2 units out of 100 units of the liquid crystal display device using PH1 and in 3 units out of 100 units of the liquid crystal display device using PH2. In addition, a screen failure considered ascribable to the film scratch is generated in 7 units out of 100 units of the liquid crystal display device using PHI and in 3 units out of 100 units of the liquid crystal display device using PH2.

As demonstrated above, by controlling the dissolution method of the cellulose acylate solution used for the solution casting method, the drying conditions at the casting as well as in the stretching region, and the surface profile of the pass roll with which the film after edge slitting comes into contact, the foreign matter, casting unevenness and scratch in the cellulose acylate film can be reduced and a good film with improved planarity can be obtained. Furthermore, it is confirmed that the liquid crystal display device using such a film less suffers from abnormal bright point or reduction in the display quality due to casting unevenness.

According to the present invention, an inexpensive cellulose acylate film assured of high transparency and excellent optical isotropy (Re, Rth) and reduced in the foreign matter defect, unevenness and scratches can be obtained, and an optically-compensatory film, a polarizing plate and a liquid crystal display device, which are inexpensive and excellent, can be obtained.

The entire disclosure of each and every foreign patent application from which the benefit of foreign priority has been claimed in the present application is incorporated herein by reference, as if fully set forth.

What is claimed is:

1. A cellulose acylate film having:
Re₍₅₉₀₎ and Rth₍₅₉₀₎ satisfying formulae (I) and (II); and
a beam transmittance of 88% or more at a wavelength of 590 nm,
wherein the number of foreign matters that have a long axis of 50 to 200 μm is 20 pieces/m² or less:
0≦Re₍₅₉₀₎≦10 Formula (I):
−25≦Rth₍₅₉₀₎≦25 Formula (II):
wherein Re₍₅₉₀₎ represents an in-plane retardation value (unit: nm) at a wavelength of 590 nm at 25° C. under 60% RH; and
Rth₍₅₉₀₎ represents a retardation value (unit: nm) in a thickness direction at a wavelength of 590 nm at 25° C. under 60% RH.

2. A cellulose acylate film having:
Re₍₅₉₀₎ and Rth₍₅₉₀₎ satisfying formulae (1) and (II); and
a beam transmittance of 88% or more at a wavelength of 590 nm,
wherein the number of casting unevennesses that have a width of 10 to 100 μm is 10 pieces/m or less in a width direction:
0≦Re₍₅₉₀₎≦10 Formula (I):
−25≦Rth₍₅₉₀₎≦25 Formula (II):
wherein Re₍₅₉₀₎ represents an in-plane retardation value (unit: nm) at a wavelength of 590 nm at 25° C. under 60% RH; and
Rth₍₅₉₀₎ represents a retardation value (unit: nm) in a thickness direction at a wavelength of 590 nm at 25° C. under 60% RH.

3. The cellulose acylate film according to claim 1,
wherein the number of casting unevennesses that have a width of 10 to 100 μm is 10 pieces/m or less in a width direction.

4. A cellulose acylate film having:
Re₍₅₉₀₎ and Rth₍₅₉₀₎ satisfying formulae (I) and (II); and
a beam transmittance of 88% or more at a wavelength of 590 nm,
wherein Ry, which represents a maximum height of surface concavities and convexities, is 3.0 μm or less; and
Sm, which represents an average distance between surface concavities and convexities, is from 1 μm to 1 mm:
0≦Re₍₅₉₀₎≦10 Formula (I):
−25≦Rth₍₅₉₀₎≦25 Formula (II):
wherein Re₍₅₉₀₎ represents an in-plane retardation value (unit: nm) at a wavelength of 590 nm at 25° C. under 60% RH; and
Rth₍₅₉₀₎ represents a retardation value (unit: nm) in a thickness direction at a wavelength of 590 nm at 25° C. under 60% RH.

5. A cellulose acylate film according to claim 1,
wherein Ry, which represents a maximum height of surface concavities and convexities, is 3.0 μm or less; and
Sm, which represents an average distance between surface concavities and convexities, is from 1 μm to 1 mm.

6. A cellulose acylate film having:
Re₍₅₉₀₎ and Rth₍₅₉₀₎ satisfying formulae (I) and (II); and
a beam transmittance of 88% or more at a wavelength of 590 nm,
wherein the number of film scratches that have a width of 10 to 100 μm is from 0 to 10 pieces/m in a casting direction:
0≦Re₍₅₉₀₎≦10 Formula (I):
−25≦Rth₍₅₉₀₎≦25 Formula (II):
wherein Re₍₅₉₀₎ represents an in-plane retardation value (unit: nm) at a wavelength of 590 nm at 25° C. under 60% RH; and
Rth₍₅₉₀₎ represents a retardation value (unit: nm) in a thickness direction at a wavelength of 590 nm at 25° C. under 60% RH.

7. The cellulose acylate film according to claim 1,
wherein the number of film scratches that have a width of 10 to 100 μm is from 0 to 10 pieces/m in a casting direction.

8. A production method of a cellulose acylate film, which is a method for producing a cellulose acylate film by a solution casting method comprising:
(I) a process of preparing a cellulose acylate solution;
(II) a process of casting the cellulose acylate solution to form a cast;
(III) a process of drying the cast film before separation;
(IV) a process of separating the cast film;
(V) a process of tenter-drying the cast film; and
(VI) a process of cutting off an edge portion of the cast film and reeling the cast film,
wherein (I) the process of preparing the cellulose acylate solution comprises:
(i) a process of mixing and dissolving a cellulose acylate in an organic solvent at 25 to 95° C.;
(ii) a process of cooling the solution prepared at the process (i) down to −55 to 20° C.; and
(iii) a process of heating the solution prepared at the process (ii) up to 40 to 115° C.

9. The production method of the cellulose acylate film according to claim 8,
wherein (III) the process of drying the cast film before separation is performed such that, while the residual solvent amount of the cast film is from 220 to 100 mass % based on the solid content, an average decrease rate of the residual solvent amount is from 1 to 18 mass %/sec.

10. The production method of a cellulose acylate film according to claim 8,
wherein (V) the process of tenter-drying the cast film is performed such that, while the cast film is tenter-stretched, the cast film is dried by drying air at a temperature of from 40 to 150° C. and an average decrease rate of the residual solvent amount is from 0.01 to 3 mass %/sec.

11. The production method of a cellulose acylate film according to claim 8,
wherein a pass roll contacting the film at the reeling has a surface roughness of 0.5 μm or less.

12. A cellulose acylate film, which is produced by the production method according to claim 8.

13. The cellulose acylate film according to claim 1, which is produced by a solution casting method comprising:
(I) a process of preparing a cellulose acylate solution;
(II) a process of casting the cellulose acylate solution to form a cast film;
(III) a process of drying the cast film before separation;
(IV) a process of separating the cast film;
(V) a process of tenter-drying the cast film; and
(VI) a process of cutting off an edge portion of the cast film and reeling the cast film,
wherein (I) the process of preparing the cellulose acylate solution comprises:
(i) a process of mixing and dissolving a cellulose acylate in an organic solvent at 25 to 95° C.;
(ii) a process of cooling the solution prepared at the process (i) down to −55 to 20° C.; and
(iii) a process of heating the solution prepared at the process (ii) up to 40 to 115° C.

14. The cellulose acylate film according to claim 1, which has an acyl substitution degree (X+Y) satisfying formula (10):
2.6<X+Y≦3.0 Formula (10):
wherein X represents an acetyl substitution degree and Y represents an acyl substitution degree except for acetyl.

15. The cellulose acylate film according to claim 1, which has a thickness of from 30 to 120 μm.

16. An optically-compensatory film comprising:
the cellulose acylate film according to claim 1; and
an optically anisotropic layer having Re₍₅₉₀₎ of from 0 to 200 nm and |Rth₍₅₉₀₎| of from 0 to 400 nm.

17. A polarizing plate comprising:
a polarizer-protective film on a liquid crystal cell side of the polarizing plate,
wherein the polarizer-protective film is the cellulose acylate film according to claim 15.

18. A polarizing plate comprising:
a polarizer; and
a pair of polarizer-protective films sandwiching the polarizer,
wherein at lease one of the polarizer-protective films is the cellulose acylate film according to claim 15.

19. A liquid crystal display device comprising:
the cellulose acylate film according to claim 15.
